(19) United States
(12) Patent Application Publication
(10) Pub. No.: US 2026/0299189 A1
(43) Pub. Date: Oct. 1, 2026

(54) MULTICORE OPTICAL FIBER FOR HIGH DENSITY CABLE

(71) Applicant: CORNING INCORPORATED, CORNING, NY (US)

(72) Inventors: Pushkar Tandon, Painted Post, NY (US); Wendell Porter Weeks, Corning, NY (US)

(21) Appl. No.: 19/629,299

(22) Filed: Mar. 26, 2026

Related U.S. Application Data
(60) Provisional application No. 63/780,904, filed on Mar. 31, 2025.

(51) Int. Cl. G02B 6/02; G02B 6/028; G02B 6/44

(52) U.S. Cl. CPC G02B 6/02042; G02B 6/02004; G02B 6/02395; G02B 6/0286; G02B 6/4403

(57) ABSTRACT

The disclosure provides multicore optical fibers with low sensitivity to microbending, low crosstalk, and low coated diameter. Low microbending sensitivity is achieved by (1) configuring the relative refractive index profile of the optical fiber to have a mode field diameter less than or equal to 8.2 μm at 1310 nm and (2) reducing the in situ modulus of the primary coating to less than or equal to 0.25 MPa. The low mode field diameter also reduces crosstalk between cores. The optical fiber preferably includes a secondary coating with an in situ modulus greater than or equal to 1200 MPa. The relative refractive index profile of the optical fiber preferably includes a trench cladding region with a moat volume greater than or equal to 30% Δ-μm². The multicore optical fibers enable high core density in cables and cables with reduced sensitivity of attenuation to temperature.

This application claims the benefit of priority to U.S. Provisional Patent Application Ser. No. 63/780,904 filed on Mar. 31, 2025, the content of which is relied upon and incorporated herein by reference in its entirety.

### FIELD OF THE DISCLOSURE

This disclosure pertains to optical fibers and cables. More particularly, this disclosure pertains to optical fibers and cables designed for data center applications. Most particularly, this disclosure pertains to multicore optical fibers with low crosstalk and cables having a high density of the multicore optical fibers to increase data transmission capacity.

### BACKGROUND OF THE DISCLOSURE

Optical fibers are being widely used in telecommunication applications including in Fiber to the Home (FTTH), data centers, and silicon photonics. Continued demand for higher data throughput and more compact optical networks is placing increasingly stringent requirements on the performance of optical fibers. In particular, the need for higher fiber density in cables and limited space for fiber installation is motivating efforts to develop bend-insensitive optical fibers. Bend-insensitive optical fibers are optical fibers that exhibit minimal signal loss due to bending.

Bend loss includes signal losses due to microbending and macrobending. Microbending losses are caused by high frequency mechanical perturbations originating from external stimuli in the deployment environment of the optical fiber. Examples include lateral contact of the optical fiber with surfaces in a cable (e.g. tube wall or neighboring fibers). Physically, microbends correspond to randomly localized small radius bends (less than about 1 mm) that act along the length of the optical fiber. Microbends lead to mode coupling in the optical fiber and dissipation of power in the fundamental mode of single mode fiber into higher order modes.

Macrobending losses are signal losses caused by turning or winding of the optical fiber in the deployment environment. It is often necessary to physically bend an optical fiber to meet installation requirements in the field (e.g. around corners or in tight spaces in data centers or in-building networks). The bend diameter in physical installations is large (greater than about 2 mm and typically on the order of tens of millimeters) and the loss mechanism is leakage of light. As the optical fiber bends, a fraction of the optical signal refracts or tunnels out of the core to the cladding and is dissipated in the protective coating surrounding the fiber. The amount of lost signal increases as the optical fiber is bent more tightly (smaller bend diameter).

To meet the demand for high data transmission capacity in data centers, it is necessary to develop cables with an increasingly higher number of data channels per unit cross-sectional area of the cable. One strategy for increasing the number of data channels in cables is to continue the current practice of constructing cables with standard optical fibers but to reduce the diameter of the optical fibers utilized in the cable. Standard optical fibers consist of a glass fiber surrounded by a protective coating. The glass fiber includes a central waveguiding core surrounded by a cladding. The diameter of an optical fiber can be reduced by reducing the thickness of the glass cladding or the thickness of the protective coating. While viable, both approaches present challenges that need to be overcome. If the thickness of the glass cladding is reduced, the waveguiding core of the glass fiber is in closer proximity to the coating and signal losses to the coating increase.

Reducing the diameter of optical fibers by reducing the thickness of the protective coating is currently practiced as a solution for increasing fiber density in cables. Standard optical fibers have glass diameter of 125 μm and a coated diameter of about 240 μm (coating thickness of about 57.5 μm). Recent innovations have produced optical fibers with coated diameters of 190 μm (coating thickness of about 32.5 μm) and implementing such optical fibers in cables has enabled increases in fiber density up to about 10 fibers/mm². It would be desirable to develop optical fibers with coated diameters less than 190 μm to enable higher fiber density in cables. As coating thickness decreases, however, the spacing between optical fibers decreases and contact between adjacent optical fibers increases. As a result, mechanical interactions that occur at the coating interface between adjacent optical fibers in a cable have a more pronounced effect on the optical signals transmitted through the cores of the optical fibers, which leads to greater microbending losses. A similar effect occurs if the thickness of the coating is maintained and the thickness of the glass cladding is reduced due to closer proximity of the cores of the optical fiber to the coating interface between adjacent optical fibers in a cable.

A second strategy for increasing the number of data channels in a cable is to utilize multicore optical fibers. Multicore optical fibers include multiple core elements embedded in a common cladding. Each core element of a multicore optical fiber is a waveguide and acts as an independent channel for transmitting data. Since transmission capacity increases as the number of core elements in a multicore fiber increases, it is desirable to maximize the density of core elements in a given cross-sectional area of common cladding. Core element density can be increased by reducing the spacing between core elements. As the spacing between core elements is reduced, however, crosstalk between core elements occurs and signal quality degrades as signals transmitted in different core elements interfere with each other. Core element density is also limited by the spacing between core elements and the outer surface of the common cladding. The common cladding is surrounded by one or more protective coatings and signal intensity in core elements proximate to the outer surface of the common cladding is decreased by tunneling through the common cladding into the protective coating in contact with the common cladding when the core element is positioned too closely to the outer surface of the common cladding. Microbending losses also increase as core elements are positioned closer to the outer boundary of the multicore optical fiber. Minimization of microbending and signal loss to the coating can be achieved by increasing the diameter of the common cladding but this approach is contrary to the objective of achieving a high density of data channels.

With the recent development of AI (artificial intelligence), the demand for further increases in data transmission capacity is expected to grow, prompting a need for further increases in data channel density in cables. To increase data channel density, it would be desirable to develop multicore optical fibers having a greater number of core elements and a low diameter. There is accordingly a need for new multicore optical fibers with more core elements and/or a low diameter that exhibit low crosstalk and low sensitivity to microbending for assembly at high density in cables to meet future demands for high data transmission capacity in data centers.

### SUMMARY

The present disclosure provides multicore optical fibers with a low diameter, low sensitivity to microbending, and low crosstalk. Low microbending sensitivity is achieved by (1) configuring the relative refractive index profile of the core elements of the multicore optical fiber to have a low mode field diameter and (2) reducing the modulus of the primary coating that directly contacts the common cladding of the multicore optical fiber. Low mode field diameter enables closer spacing of core elements without increasing crosstalk. Closer spacing of core elements allows for a higher number of core elements in the multicore optical fiber and thus a higher density of data channels in cables constructed with the multicore optical fibers. The mode field diameter is less than or equal to 8.2 μm at 1310 nm, the in situ modulus of the primary coating is less than or equal to 0.25 MPa and the core element spacing is less than or equal to 40.0 μm. The multicore optical fiber further includes a higher modulus secondary coating in direct contact with the primary coating. The outer diameter of the secondary coating is less than or equal to 220 μm. The secondary coating preferably has an in situ modulus greater than or equal to 1200 MPa. The relative refractive index profile of the core elements preferably includes a trench cladding region with a moat volume greater than or equal to 30% Δ-μm². Embodiments with rectangular and triangular trench cladding regions are included.

The present description extends to:
A multicore optical fiber comprising:
   a glass fiber, the glass fiber comprising:
      a plurality of core elements, each core element comprising:
         a core region, the core region having an outer radius r₁ and a relative refractive index Δ₁ with a maximum relative refractive index Δ_{1 max};
         a dedicated cladding surrounding and directly adjacent to the core region;
      a common cladding surrounding and directly adjacent to the dedicated cladding of each of the core elements of the plurality, the common cladding having an outer radius R₄ and a relative refractive index Δ₄;
a primary coating surrounding and directly adjacent to the common cladding, the primary coating having a radius R₅, a thickness R₅−R₄, and an in situ modulus less than or equal to 0.30 MPa;
a secondary coating surrounding and directly adjacent to the primary coating, the secondary coating having an outer radius R₆ less than or equal to 110 μm, a thickness R₆−R₅, and an in situ modulus greater than or equal to 1400 MPa, and;
wherein each core element of the plurality of core elements has a mode field diameter in the range from 7.3 μm to 8.2 μm at 1310 nm and a macrobend loss at 1550 nm, as determined by a mandrel wrap test using a mandrel with a diameter of 15 mm, of less than or equal to 0.50 dB/turn; and
wherein the core element spacing is greater than or equal to 26 μm; and
wherein the co-propagating crosstalk between each pair of adjacent core elements is less than or equal to −35 dB/km at a wavelength of 1310 nm; and wherein the co-propagating crosstalk between each pair of adjacent core elements is less than or equal to −25 dB/km at a wavelength of 1550 nm.

The present disclosure extends to:
An optical fiber ribbon comprising the multicore optical fibers disclosed herein.

The present disclosure extends to:
An optical fiber cable comprising the multicore optical fibers disclosed herein.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings are illustrative of selected aspects of the present disclosure, and together with the description serve to explain principles and operation of methods, products, and compositions embraced by the present disclosure.

### BRIEF DESCRIPTION OF THE DRAWINGS

FIG. 1A is a schematic depiction of a system used to determine crosstalk in a 1×2 multicore optical fiber.

FIG. 1B is a schematic view of a representative optical fiber ribbon including multicore glass fibers.

FIG. 1C is a schematic view of a representative optical fiber cable including multicore glass fibers.

FIG. 1D depicts a cross-section of a multicore glass fiber having two core elements arranged in a 1×2 configuration.

FIG. 1E depicts representative cross-sections of embodiments of a multicore glass fiber having various numbers and arrangements of core elements.

FIG. 1F depicts a cross-section of a multicore glass fiber having two core elements arranged in a 1×2 configuration and illustrating selected dimensions.

FIGS. 2A-2B show cross-sections of embodiments of core elements for multicore glass fibers having two or more core elements.

FIGS. 3A-3B show selected cross-sections of multicore glass fibers having two core elements of the types shown in FIGS. 2A-2B arranged in a 1×2 configuration.

FIGS. 4A-4B show selected cross-sections of multicore glass fibers having two or more core elements of the types shown in FIGS. 2A-2B arranged in a 2×2 configuration.

FIG. 5A depicts a relative refractive index profile of a glass fiber having a core region with a graded index, a trench cladding region, and a common cladding region.

FIG. 5B depicts a relative refractive index profile of a glass fiber having a core region with a graded index, an offset cladding region, a trench cladding region, and a common cladding region.

FIG. 5C depicts a relative refractive index profile of a glass fiber having a core region with a graded index, a trench cladding region, and a common cladding region.

FIG. 5D depicts a relative refractive index profile of a glass fiber having a core region with a graded index, an offset cladding region, a trench cladding region, and a common cladding region.

FIG. 6A depicts a relative refractive index profile of a glass fiber having a core region with a step index, a trench cladding region, and a common cladding region.

FIG. 6B depicts a relative refractive index profile of a glass fiber having a core region with a step index, an offset cladding region, a trench cladding region, and a common cladding region.

FIG. 6C depicts a relative refractive index profile of a glass fiber having a core region with a step index, a trench cladding region, and a common cladding region.

FIG. 6D depicts a relative refractive index profile of a glass fiber having a core region with a step index, an offset cladding region, a trench cladding region, and a common cladding region.

FIG. 7A is a schematic depiction of soot preform deposition via an OVD process.

FIG. 7B depicts an apparatus for doping and consolidating a soot preform.

FIGS. 8A-8C depict deposition of a plurality of soot layers on a substrate.

FIG. 9A illustrates the variation in the Microbending Sensitivity Parameter with the in situ modulus of the primary coating for a representative multicore optical fiber;

FIG. 9B illustrates the variation in the Microbending Sensitivity Parameter with the in situ modulus of the secondary coating for a representative multicore optical fiber;

FIG. 9C illustrates a relationship that shows the in situ modulus of the secondary coating required to achieve good puncture resistance as the diameter 2R₆ of the secondary coating decreases.

FIGS. 10A and 10B are diagrams illustrating modeled relationships between optical fiber diameter and fiber density in an optical fiber cable for respective multicore optical fiber designs.

FIG. 11 is a diagram illustrating an expected maximum achievable core density in a modeled optical fiber cable for each of several optical fiber designs.

FIG. 12 is a cross-sectional view of an exemplary optical fiber cable.

FIG. 13 is a diagram illustrating modeled relationships between coefficient of thermal expansion of a cable jacket and an achievable optical fiber density in an optical fiber cable.

### DETAILED DESCRIPTION

The present disclosure is provided as an enabling teaching and can be understood more readily by reference to the following description, drawings, examples, and claims. To this end, those skilled in the relevant art will recognize and appreciate that many changes can be made to the various aspects of the embodiments described herein, while still obtaining the beneficial results. It will also be apparent that some of the desired benefits of the present embodiments can be obtained by selecting some of the features without utilizing other features. Accordingly, those who work in the art will recognize that many modifications and adaptations are possible and can even be desirable in certain circumstances and are a part of the present disclosure. Therefore, it is to be understood that this disclosure is not limited to the specific compositions, articles, devices, and methods disclosed unless otherwise specified. It is also to be understood that the terminology used herein is for the purposes of describing particular aspects only and is not intended to be limiting.

In this specification and in the claims that follow, reference will be made to a number of terms which shall be defined to have the following meanings:
“Include,” “includes,” or like terms means encompassing but not limited to, that is, inclusive and not exclusive.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When a value is said to be about or about equal to a certain number, the value is within +10% of the number. For example, a value that is about 10 refers to a value between 9 and 11, inclusive.

Specific and preferred values disclosed for compositions, components, ingredients, additives, and like aspects, and ranges thereof, are for illustration only; they do not exclude other defined values or other values within defined ranges. The compositions and methods of the disclosure include those having any value or any combination of the values, specific values, more specific values, and preferred values described herein.

The indefinite article “a” or “an” and its corresponding definite article “the” as used herein means at least one, or one or more, unless specified otherwise.

Where a range of numerical values is recited herein, comprising upper and lower values, unless otherwise stated in specific circumstances, the range is intended to include the endpoints thereof, and all integers and fractions within the range. It is not intended that the scope of the claims be limited to the specific values recited when defining a range. Further, when an amount, distance, concentration, or other value or parameter is given as a range, one or more preferred ranges or a list of upper preferable values and lower preferable values, this is to be understood as specifically disclosing all ranges formed from any pair of any upper range limit or preferred value and any lower range limit or preferred value, regardless of whether such pairs are separately disclosed. It will be further understood that the end-points of each of the ranges are significant both in relation to the other end-point, and independently of the other end-point. Finally, when the term “about” is used in describing a value or an end point of a range, the disclosure should be understood to include the specific value or end point referred to. When a numerical value or end point of a range does not recite “about,” the numerical value or end point of a range is intended to include two embodiments: one modified by “about,” and one not modified by “about.”

As used herein, “comprising” is an open-ended transitional phrase. A list of elements following the transitional phrase “comprising” is a non-exclusive list, such that elements in addition to those specifically recited in the list may also be present.

The term “wherein” is used as an open-ended transitional phrase, to introduce a recitation of a series of characteristics of the structure.

The terms “comprising,” and “comprises,” e.g., “A comprises B,” is intended to include as special cases the concepts of “consisting of” and “consisting essentially of” as in “A consists of B” or “A consists essentially of B”.

The term “or,” as used herein, is inclusive; more specifically, the phrase “A or B” means “A, B, or both A and B.” Exclusive “or” is designated herein by terms such as “either A or B” and “one of A or B,” for example.

As used herein, contact refers to direct contact or indirect contact. Direct contact refers to contact in the absence of an intervening material and indirect contact refers to contact through one or more intervening materials. Elements in direct contact touch each other. Elements in indirect contact do not touch each other but are rigidly or flexibly joined through one or more intervening materials. Contacting refers to placing two elements in direct or indirect contact. Elements in direct (indirect) contact may be said to directly (indirectly) contact each other.

As used herein, “directly adjacent” means directly contacting and “indirectly adjacent” mean indirectly contacting. The term “adjacent” encompasses elements that are directly or indirectly adjacent to each other.

“Optical fiber” refers to a waveguide having a glass portion surrounded by a coating. The glass portion includes a core and a cladding. The glass portion is referred to herein as a “glass fiber”. The glass fiber of a single-core optical fiber consists of a single core region surrounded by one or more cladding regions, where the single core region and the one or more cladding regions function collectively as a waveguide. The glass fiber of a multicore optical fiber includes two or more core elements surrounded by a common cladding, where each core element functions as a waveguide in the multicore optical fiber and each core element consists of a core region surrounded by a dedicated cladding that includes one or more dedicated cladding regions. The common cladding includes one or more common cladding regions. A multicore optical fiber is referred to herein as “heterogeneous” if at least two of the two or more core elements of the multicore optical fiber differ in the value of the propagation constant β.

“Radial position” and “radius” refer to position relative to a radial coordinate. The radial coordinate “r” refers to radial position or radius relative to the centerline (r=0) of a core element of the multicore optical fiber. Each of the two or more core elements of a multicore optical fiber has a centerline and a separate radial coordinate r. The radial coordinate “R” refers to radial position or radius relative to the centerline (R=0) of the multicore optical fiber. The multicore optical fiber has a single centerline and a single radial coordinate R. The radial coordinate r is used herein to refer to radial position in the core region and any of the dedicated cladding regions of the core elements described herein. The radial coordinate r or R will be used to refer to radial position in the common cladding described herein.

The terms “inner” and “outer” are used to refer to relative values of radial coordinate or relative positions of regions of the optical fiber, where “inner” means closer to the centerline of the core element (when used in the context of the radial coordinate r) or multicore optical fiber (when used in the context of the radial coordinate R) than “outer”. An inner radial coordinate is closer to the centerline than an outer radial coordinate. An inner radial coordinate is between the centerline and an outer radial coordinate. An inner region of a core element is closer to the centerline of the core element than an outer region of the core element. An inner region of a core element is between the centerline of the core element and the outer region of the core element.

The term “mode” refers to guided mode in a core element of the multicore optical fiber. A single-mode core element is a core element designed to guide only the fundamental LP01 mode over a substantial length of the optical fiber (e.g., at least several meters). The core elements of the multicore optical fibers disclosed herein are single-moded at a wavelength of 1550 nm.

“Refractive index” refers to the refractive index at a wavelength of 1550 nm.

The “refractive index profile” is the relationship between refractive index or relative refractive index and radius. For relative refractive index profiles of core elements depicted herein as having step boundaries between adjacent core and/or cladding regions, normal variations in processing conditions may preclude obtaining sharp step boundaries at the interface of adjacent regions. It is to be understood that although boundaries of refractive index profiles may be depicted herein as step changes in refractive index, the boundaries in practice may be rounded or otherwise deviate from perfect step function characteristics. It is further understood that the value of the relative refractive index may vary with radial position r or R within a core region and/or any of the dedicated or common cladding regions. When relative refractive index varies with radial position r or R in a particular region of the fiber (e.g. core region and/or any of the dedicated or common cladding regions described herein), it is expressed in terms of its actual or approximate functional dependence, or in terms of its value at a particular radial position r or R within the region, or in terms of an average value applicable to the region as a whole. Unless otherwise specified, if the relative refractive index of a region (e.g. core region and/or any of the dedicated or common cladding regions) is expressed as a single value or as a parameter (e.g. Δ or Δ%) applicable to the region as a whole, it is understood that the relative refractive index in the region is constant, or approximately constant, and corresponds to the single value, or that the single value or parameter represents an average value of a non-constant relative refractive index dependence with radial position r or R in the region. For example, if i is a region of a core element, the parameter Δᵢ refers to the average value of relative refractive index in the region, unless otherwise specified. Whether by design or a consequence of normal manufacturing variability, the dependence of relative refractive index on radial position may be sloped, curved, or otherwise non-constant.

“Relative refractive index,” as used herein, is defined in Eq. (1) for any radial position r as:

$$Δ \% = 100 \frac{( {n}^{2} - {n}_{ref}^{2} )}{2 {n}^{2}} \qquad ( 1 )$$

where nis the refractive index at the radial position r in the glass fiber and n_{ref} is the refractive index of pure silica glass. For purposes of the present disclosure, n_{ref}=1.444, which is the refractive index of pure silica at 1550 nm. Accordingly, as used herein, the relative refractive index percent is relative to pure silica glass. As used herein, the relative refractive index is represented by Δ (or “delta”) or Δ% (or “delta %) and its values are given in units of “%”, unless otherwise specified. Relative refractive index may also be expressed as Δ(r) or Δ(r) %. When referring to a specific region i of the multicore optical fiber, relative refractive index may also be expressed as Δᵢ, Δᵢ%, Δᵢ(r) or Δᵢ(r) %.

The average relative refractive index (Δₐᵥₑ) of a region of the multicore fiber is determined from Eq. (2):

$${Δ}_{ave} = {\int }_{{r}_{inner}}^{{r}_{outer}} \frac{Δ ( r ) dr}{( {r}_{outer} - {r}_{inner} )} \qquad ( 2 )$$

where rᵢₙₙₑᵣ is the inner radius of the region, router is the outer radius of the region, and Δ(r) is the relative refractive index of the region. An analogous definition of average refractive index can be expressed in terms of radial coordinate R.

The term “α-profile” refers to a relative refractive index profile Δ(r) of a core region of a core element that has the functional form defined in Eq. (3):

$$Δ ( r ) = Δ ( {r}_{0} ) [ 1 - {[ \frac{\vert r - {r}_{0} \vert}{( {r}_{z} - {r}_{0} )} ]}^{α} ] \qquad ( 3 )$$

where rₒ is the radial position at which Δ(r) is maximum, r_{z}>r₀ is the radial position at which Δ(r) decreases to its minimum value, and rᵢ≤r≤r_{f} in the range rᵢ≤r≤r_{f}, where r₁ is the initial radial position of the α-profile, r_{f} is the final radial position of the α-profile, and a is a real number. Δ(r₀) for an α-profile may be referred to herein as Δₘₐₓ or, when referring to a specific region i of the fiber, as Δ_{i,max}. When the relative refractive index profile of the core region of a core element is described by an α-profile with r₀ occurring at the centerline (r=0) and r_{z} corresponding to the outer radius r₁ of the core region, and Δ₁(r₁)=0, Eq. (3) simplifies to Eq. (4):

$${Δ}_{1} ( r ) = {Δ}_{1 max} [ 1 - {[ \frac{r}{{r}_{1}} ]}^{α} ] \qquad ( 4 )$$

“Effective area” of a core element of a multicore optical fiber is defined as:

$${A}_{eff} = \frac{2 {π [ {\int }_{0}^{∞} {( f ( r ) )}^{2} rdr ]}^{2}}{{\int }_{0}^{∞} {( f ( r ) )}^{4} rdr} \qquad ( 5 )$$

where f(r) is the transverse component of the electric field of the guided optical signal in the core element and r is radial position relative to the centerline of the core element. “Effective area” or “A_{eff}” depends on the wavelength of the optical signal and is understood herein to refer to a wavelength of 1550 nm, unless otherwise specified. Each core element of a multicore optical fibers has an effective area. The effective area may be the same or different for different core elements.

The “mode field diameter” or “MFD” of a core element of the multicore optical fiber is defined in Eq. (6) as:

$$MFD = 2 w \qquad ( 6 )$$

$${w}^{2} = 2 \frac{{\int }_{0}^{∞} {( f ( r ) )}^{2} {rdr}^{}}{{\int }_{0}^{∞} {( \frac{df ( r )}{dr} )}^{2} {rdr}^{}}$$

where f(r) is the transverse component of the electric field distribution of the guided optical signal and r is radial position in the fiber. “Mode field diameter” or “MFD” depends on the wavelength of the optical signal and is reported herein for a wavelength of 1310 nm. Unless otherwise specified, mode field diameter refers to the LP₀₁ mode at 1310 nm. Each core element of a multicore optical fibers has a mode field diameter. The mode field diameter may be the same or different for different core elements.

“Trench” or “trench region” or “trench cladding region” refers to the portion of the dedicated cladding of a core element that is surrounded by and directly adjacent to the common cladding. A trench cladding region is situated between the outer radius r₁ of the core region of a core element and the common cladding. The trench cladding region has a relative refractive index Δ₃ less than the relative refractive index Δ₄ of the common cladding. In some embodiments, a trench is directly adjacent to the core region. In other embodiments, the dedicated cladding includes an offset cladding region that surrounds and is directly adjacent to the core region and a trench cladding region that surrounds and is directly adjacent to the offset cladding region, where the offset cladding region has a relative refractive index Δ₂ less than the relative refractive index Δ₁ of the core region and greater than the relative refractive index Δ₃ of the trench cladding region.

“Trench volume” of a trench cladding region is defined as:

$${V}_{Trench} = \vert 2 {\int }_{{r}_{Trench , inner}}^{{r}_{Trench , outer}} ( {Δ}_{Trench} ( r ) - {Δ}_{4} ) rdr \vert \qquad ( 7 )$$

where r_{Trench,inner} is the inner radius r₂ of the trench cladding region, Trench, outer is the outer radius r₃ of the trench cladding region, Δ_{Trench}(r)=Δ₃(r) is the relative refractive index of the trench cladding region, and Δ₄ is the average relative refractive index of the common cladding of the glass fiber. In embodiments in which a trench cladding region is directly adjacent to the core region, r_{Trench,inner} is r₂=r₁ (outer radius of the core region), r_{Trench,outer} is r₃, and Δ_{Trench} is Δ₃(r). In embodiments in which a trench cladding region is directly adjacent to an offset cladding region, r_{Trench,inner} is r₂>r₁, r_{Trench,outer} is r₃, and Δ_{Trench} is Δ₃(r). Trench volume is defined as an absolute value and has a positive value. Trench volume is expressed herein in units of % Δ-micron², % Δ-μm², or %-micron², %-μm², whereby these units can be used interchangeably herein.

“Chromatic dispersion”, herein referred to as “dispersion” unless otherwise noted, of a core element of a multicore optical fiber is the sum of the material dispersion and the waveguide dispersion. The zero-dispersion wavelength (λ₀) is the wavelength at which the dispersion has a value of zero. Dispersion slope is the rate of change of dispersion with respect to wavelength. Dispersion and dispersion slope are reported herein at a wavelength of 1310 nm and are expressed in units of ps/nm km and ps/nm²·km, respectively. Each core element of a multicore optical fiber exhibits dispersion. The dispersion may be the same or different for different core elements.

The cutoff wavelength of a core element of a multicore optical fiber is the minimum wavelength at which the core element will support (guide) only one propagating mode. The cutoff wavelength of an optical fiber is the minimum wavelength at which the optical fiber will support only one propagating mode. Cutoff wavelength will be reported herein as a cable cutoff wavelength. The cable cutoff wavelength is based on a 22-meter cabled fiber length as specified in TIA-455-80: FOTP-80 IEC-60793-1-44 Optical Fibres-Part 1-44: Measurement Methods and Test Procedures-Cut-off Wavelength (21 May 2003), by Telecommunications Industry Association (TIA). Each core element of a multicore optical fibers exhibits a cutoff wavelength. The cutoff wavelength may be the same or different for different core elements of a multicore optical fiber.

The “propagation constant” β of a core element corresponds to the change in phase of the guided mode in the core element per unit length of propagation of the guided mode in the core element. The “effective index” n_{eff} of a core element is the ratio of the propagation constant of light with wavelength λ to the propagation constant β₀ of light with wavelength λ in vacuum:

$${n}_{eff} = \frac{β}{{β}_{0}} \qquad ( 8 )$$

$$where$$

$${β}_{0} = \frac{2 π}{λ} \qquad ( 9 )$$

For purposes of the present disclosure, the guided mode is the LP01 mode at a wavelength of 1550 nm, a wavelength at which the core elements described herein are single moded. For purposes of the present disclosure, the propagation constant β of a core element refers to the propagation constant of the core element in an isolated state in the common cladding, free of coupling and crosstalk to other core elements.

The term “coupling coefficient” κ, as used herein, is related to the overlap of the electric field of an optical signal in one core element with another core element. The coupling coefficient K depends on the refractive index profile of the core elements, the distance between the core elements and the difference Δβ between the propagation constant β of the core elements. The square of the coupling coefficient, κ², is related to the average power in a core element as influenced by the power in other cores in the multicore optical fiber. The coupling coefficient K is large when the spacing between core elements is small and decreases with increasing core element spacing. Core elements having a coupling coefficient k of zero are said to be “uncoupled”. The coupling coefficient k can be estimated from coupled power theory using the methods disclosed in M. Koshiba, K. Saitoh, K. Takenaga, and S. Matsuo, “Analytical Expression of Average Power-Coupling Coefficients for Estimating Intercore Crosstalk in Multicore Fibers,” IEEE Photonics J., 4(5), 1987-95 (2012); and T. Hayashi, T. Sasaki, E. Sasaoka, K. Saitoh, and M. Koshiba, “Physical Interpretation of Intercore Crosstalk in Multicore Fiber: Effects of Macrobend, Structure Fluctuation, and Microbend,” Optics Express, 21(5), 5401-12 (2013), the contents of which are incorporated by reference herein in their entirety.

The term “crosstalk” in a multicore optical fiber is a measure of the power of an optical signal that transfers from a reference core element to an adjacent core element. As used herein, the term “adjacent core element” refers to the core element that is nearest to the reference core element. The crosstalk from one core element to another core element depends on the coupling coefficient k between the core elements. If an optical signal with power P₁ is launched into a reference core element, the co-propagating power P₄ coupled from the reference core element to an adjacent core element can be determined using the following equation:

$$\frac{{P}_{4}}{{P}_{1}} = \frac{2 {κ}_{12}^{2} Ld}{1 + {( d Δ β )}^{2}} \qquad ( 10 )$$

where L is the length of the fiber, Δβ is the difference in propagation constants between the two adjacent core elements, κ₁₂ is the coupling coefficient, and d is the correlation length. The crosstalk X (in dB) is then determined using the following equation:

$$X = 10 log ( \frac{{P}_{4}}{{P}_{1}} ) . \qquad ( 11 )$$

The copropagating crosstalk between the two adjacent core elements increases linearly with fiber length in the linear scale but does not increase linearly with fiber length in the dB scale. As used herein, crosstalk is referenced to a 100 km length L of optical fiber. However, copropagating crosstalk can also be represented with respect to alternative optical fiber lengths L, with appropriate scaling. For optical fiber lengths other than 100 km, the copropagating crosstalk X(L) between adjacent core elements can be determined from the crosstalk X(100) for a length L=100 km using the following equation:

$$X ( L ) = X ( 100 ) + 10 log ( \frac{L}{100} ) \qquad ( 12 )$$

For example, for a 10 km length of optical fiber, the copropagating crosstalk can be determined by adding “−10 dB” to the crosstalk value for a 100 km length optical fiber. For a 1 km length of optical fiber, the copropagating crosstalk can be determined by adding “−20 dB” to the copropagating crosstalk value for a 100 km length of optical fiber. For transmission of optical signals over long distances in a multicore fiber, the crosstalk per 100 km length should be less than or equal to −30 dB, less than or equal to −40 dB, or even less than or equal to −50 dB.

Crosstalk leads to transfer of an optical signal from a reference core element to an adjacent core element. Once crosstalk occurs, the transferred signal can propagate in both directions in the adjacent core element. A distinction is made herein between co-propagating crosstalk and counterpropagating crosstalk. Co-propagating crosstalk refers to the power of the crosstalk signal transferred to the adjacent core element as measured at the end of the adjacent core element opposite to the end of the reference core element into which the signal with power P₁ was launched. Counterpropagating crosstalk refers to the power of the crosstalk signal transferred to the adjacent core element as measured at the end of the adjacent core element corresponding to the end of the reference core element into which the signal with power P₁ was launched. Typically, the power of counterpropagating crosstalk is less than the power of co-propagating crosstalk.

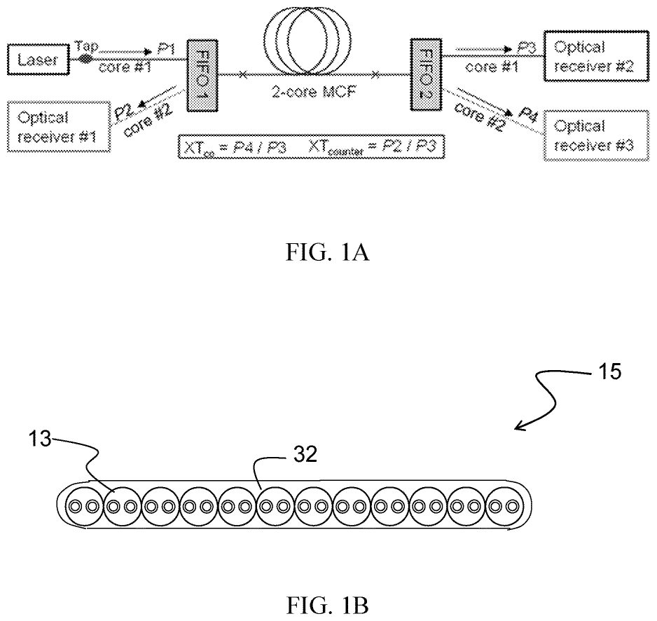

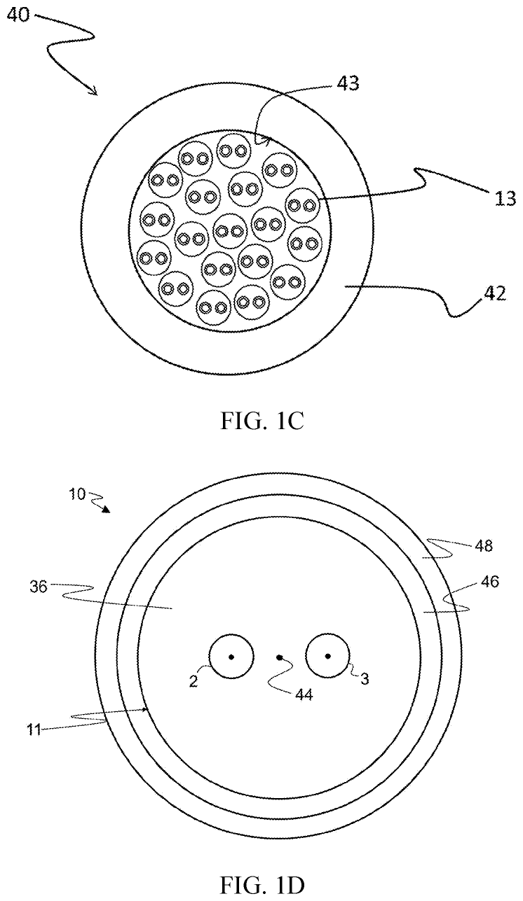

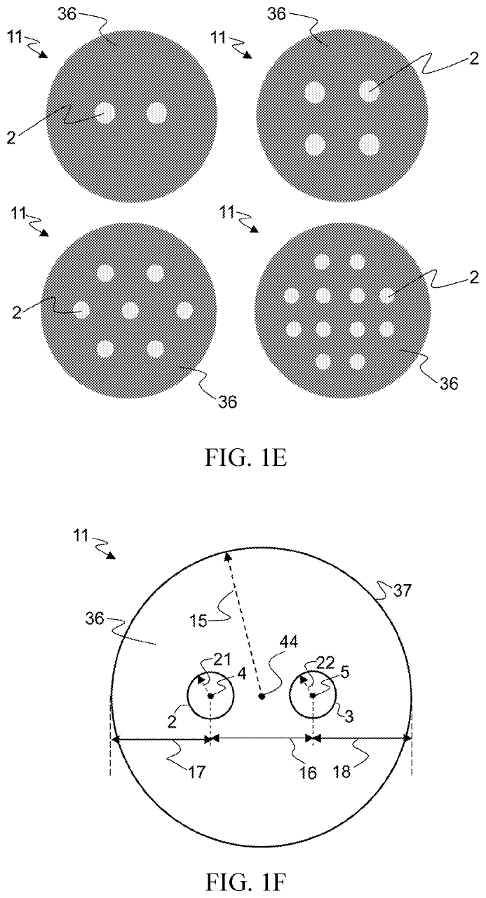

A system to measure crosstalk between two core elements of a multicore optical fiber is shown schematically in FIG. 1A. To measure the crosstalk, multicore fibers with a length between 20 km and 25 km can be tested with the system. For convenience, the multicore optical fiber can be wound (e.g., on a shipping spool) between the two fiber ends used in the measurement. The copropagating crosstalk similarly is seen to increase with as 10*log₁₀(R_{b}/R_{b,ref})+XT(R_{b,ref}), where R_{b} is the bending radius and subscript ref is the reference bend radius.

As shown in FIG. 1A, the system comprises a tunable laser source with a wavelength of 1550 nm and a linewidth of 200 kHz, a tap to monitor the laser output power, and a 1×2 multicore optical fiber fan-in/fan-out device (FIFO 1) spliced to one end of the fiber to inject light with power P₁ from the laser source into one end of one core element of the fiber. Fan-in/fan-out device (FIFO 1) is further coupled to optical receiver #1 to enable detection of the power P₂ of backward-propagating light at one end of the other core element. A second fan-in/fan-out device (FIFO 2) is spliced at the other ends of the core elements of the multicore optical fiber and its outputs are connected to optical receivers #2 and #3 to measure the power of forward-propagating light P₃ and P₄ out of each core element at the end opposite the end in which the source light with power P₁ is injected. Co-propagating crosstalk (XT_{co}) is defined as the power ratio P₄/P₃ and counterpropagating crosstalk (XTcounter) is defined as the power ratio P₂/P₃. The optical receivers #1, #2, and #3 are each a high sensitivity detector with −109 dBm noise sensitivity and linearity error with <20% deviation over the entire range of measured power (+5 to −75 dBm). All three optical receivers are calibrated. The multicore optical fiber used to fabricate the two fan-in/fan-out devices (FIFO 1, FIFO 2) has the same mode field diameter and core element spacing as the tested multicore optical fiber. For multicore optical fibers having three or more core elements, the system and technique as described above can be used for each pair of core elements to assess crosstalk therebetween.

Techniques for determining co-propagating and counterpropagating crosstalk between cores in a multicore optical fiber can be found in Akihide Sano et al., “Crosstalk-Managed High Capacity Long Haul Multicore Fiber Transmission With Propagation-Direction Interleaving,” Journal of Lightwave Technology, Vol. 32, No. 16, p. 2771-2779 (2014); T. Hayashi, et al., “Uncoupled Multi-Core Fiber Design for Practical Bidirectional Optical Communications”, Paper #MIE.1, Optical Fiber Communications Conference 2022, Optica Publishing Group (2022); and P. Tandon, et al., “Record Low Loss 0.144 dB/km 2-Core Optical Fiber for Submarine Transmission”, Journal of Lightwave Technology, Vol. 42, p. 4213-4221 (2024).

Crosstalk is reported herein in units of “dB/km”, which means decibels for 1 km of fiber length.

The multicore optical fibers disclosed herein include two or more core elements, two or more cladding regions surrounding the core elements, and a coating surrounding the cladding regions. Types of cladding regions include dedicated cladding regions and common cladding regions. A cladding region is said to be “dedicated” if it surrounds the core region of only one core element of the two or more core elements and is said to be “common” if it surrounds the core regions of at least two core elements of the two or more core elements. Each core element includes a core region and a dedicated cladding with one or more dedicated cladding regions. The multicore optical fiber also includes a common cladding with at least one common cladding region that surrounds and is directly adjacent to the dedicated cladding. The core regions, the dedicated cladding regions, and the common cladding region(s) are glass. The dedicated and common claddings may include multiple regions that differ in relative refractive index. In embodiments described herein, a common cladding region surrounds two or more core elements of the multicore fiber. Preferably, a common cladding region is common to all core elements of the multicore optical fiber. Each core element of the multicore optical fiber includes at least one dedicated cladding region and is surrounded by at least one common cladding region. In a preferred embodiment, each core element includes at least one dedicated cladding region directly adjacent to the core region of the core element. In embodiments in which each core element includes two or more dedicated cladding regions, at least one of the two or more dedicated cladding regions is directly adjacent to the core region and each of the others of the two or more dedicated cladding regions is directly adjacent to another of the two or more dedicated cladding region. In another preferred embodiment, the common cladding is directly adjacent to the dedicated cladding region furthest removed from the core region of each of the core elements. A common cladding region defines the outer surface of the glass fiber. In some embodiments, the common cladding of the multicore optical fiber has a single common cladding region. In some embodiments, an outer common cladding region surrounds and is directly adjacent to an inner common cladding region. In other embodiments, one or more intermediate common cladding regions is disposed between the inner common cladding region and the outer common cladding region. The multicore optical fibers further include a coating surrounding a common cladding region.

The core elements include a core region and a dedicated cladding. The dedicated cladding includes one or more dedicated cladding regions. When multiple dedicated cladding regions are present, they may differ in relative refractive index. The multiple dedicated cladding regions are preferably concentric regions about the centerline (r=0) of the core element. In preferred embodiments, the dedicated cladding regions of a core element include a dedicated trench cladding region. The dedicated trench cladding region surrounds the core region and is surrounded by and preferably directly adjacent to the common cladding. In some embodiments, a dedicated outer cladding region surrounds and is directly adjacent to the dedicated trench cladding region and the common cladding surrounds and is directly adjacent to the dedicated outer cladding region.

In some embodiments, the dedicated trench cladding region is directly adjacent to the core region. In other embodiments, the dedicated trench cladding region surrounds and is directly adjacent to a dedicated offset cladding region and the dedicated offset cladding region surrounds and is directly adjacent to the core region.

In some embodiments, the core region of a core element includes a dedicated offset cladding region surrounding and directly adjacent to the core region and a common cladding region surrounding and directly adjacent to the dedicated offset cladding region. The relative refractive index of the dedicated offset cladding region is less than the relative refractive index of the core region. In some embodiments, the relative refractive index of the common cladding region is greater than the relative refractive index of the dedicated offset cladding region.

In some embodiments, the core region of a core element includes a dedicated offset cladding region surrounding and directly adjacent to the core region, a dedicated trench cladding region surrounding and directly adjacent to the dedicated offset cladding region, and a common cladding region surrounding and directly adjacent to the dedicated trench cladding region. The relative refractive index of the dedicated offset cladding region is less than the relative refractive index of the core region and the relative refractive index of the dedicated trench cladding region is less than the relative refractive index of the dedicated offset cladding region. In some embodiments, the relative refractive index of the common cladding region is less than the relative refractive index of the dedicated offset cladding region. In some embodiments, the relative refractive index of the common cladding region is greater than the relative refractive index of the dedicated trench cladding region.

The core region, dedicated offset cladding region, dedicated trench cladding region, and dedicated outer cladding region are also referred to as core, offset cladding, trench, and outer cladding, respectively. The dedicated offset cladding region is optional and may also be referred to herein as an offset. The dedicated outer cladding region is also optional.

Whenever used herein, radial position r₁ and relative refractive index Δ₁ or Δ₁(r) refer to a core region, radial position r₂ and relative refractive index Δ₂ or Δ₂(r) refer to a dedicated offset cladding region, radial position r₃ and relative refractive index Δ₃ or Δ₃(r) refer to a dedicated trench cladding region, radial position r₄ and relative refractive index Δ_{4doc} or Δ_{4doc}(r) refer to a dedicated outer cladding region, radial position R₄ and relative refractive index Δ₄ or Δ₄(R) refer to the common cladding, radial position R₅ refers to a primary coating, radial position R₆ refers to a secondary coating, and radial position R₇ refers to a tertiary coating. Each radial position r₁ (i=1, 2, 3, or 4) and Rᵢ (i=4, 5, 6 or 7) refers to the outer radius of the region associated with the value i. For example, r₁ refers to the outer radius of a core region, r₂ refers to the outer radius of a dedicated inner cladding region etc.

When a symbol designating a radial position or relative refractive index includes a single subscript, it is understood that the symbol and subscript refer to any of the regions of type i in any of the core elements of the multicore glass fiber, where it is further understood that the numerical value associated with the symbol and subscript may be the same or different for the different regions of type i in the different core elements of the multicore glass fiber. For example, the radial position r₁ refers to the outer radius of the core region of any of the core elements of the multicore glass fiber, where it is understood that the numerical value of the outer radius r₁ may be the same or different for any two of the core regions in the different core elements of the multicore glass fiber.

The relative refractive index Δ₁(r) has a maximum value Δ_{1 max} and a minimum value Δ_{1 min}. The relative refractive index Δ₂(r) has a maximum value Δ_{2 max} and a minimum value Δ_{2 min}. The relative refractive index Δ₃(r) has a maximum value Δ_{3 max} and a minimum value Δ_{3 min}. The relative refractive index Δ_{4doc}(r) has a maximum value Δ_{4doc max} and a minimum value Δ_{4doc min}. The relative refractive index Δ₄(R) has a maximum value Δ_{4 max} and a minimum value Δ_{4 min}. In embodiments in which the relative refractive index is constant or approximately constant over a region (e.g., a step-index profile), the maximum and minimum values of the relative refractive index are equal or approximately equal. Unless otherwise specified, if a single value is reported for the relative refractive index of a region (dedicated or common), the single value corresponds to an average value for the region. For core regions with an α-profile or graded-index relative refractive index profile, Δ_{1 max} corresponds to the value of Δ₁ at the centerline (r=0) of the core region in some embodiments. In some embodiments, Δ_{1 max} is offset from the centerline (r=0) of the core (e.g., a centerline dip in relative refractive index may be present).

It is understood that a core region is substantially cylindrical in shape and that a dedicated offset cladding region, a dedicated trench cladding region, a dedicated outer cladding region, a primary coating, and a secondary coating are substantially annular in shape. Common cladding regions have shapes with internal cavities sized to accommodate the two or more core elements. The outer surface of the common cladding (or outermost of a plurality of common cladding regions) preferably has a circular circumference that defines the radius R₄. Annular regions are characterized in terms of an inner radius and an outer radius. Radial positions r₁, r₂, r₃, and r₄, refer herein to the outermost radii of a core region, a dedicated offset cladding region, a dedicated trench cladding region, and a dedicated outer cladding region, respectively, of a core element. The glass fiber of the multicore optical fiber is preferably substantially cylindrical in shape and R₄ refers to the outer radius of the glass fiber, which corresponds to the outer radius of the common cladding (or outermost of a plurality of common cladding regions). In preferred embodiments, the glass fiber is surrounded by a primary coating and a secondary coating, each of which is substantially annular in shape. The radius R₅ refers to the outer radius of the primary coating and the radius R₆ refers to the outer radius of the secondary coating.

When two dedicated cladding regions are directly adjacent to each other, the outer radius of the inner of the two dedicated cladding regions coincides with the inner radius of the outer of the two dedicated cladding regions. In one embodiment, for example, the glass fiber includes a core element having a core region with a dedicated offset cladding region surrounded by and directly adjacent to a dedicated trench cladding region. In such an embodiment, the radius r₂ corresponds to the outer radius of the dedicated offset cladding region and the inner radius of the dedicated trench cladding region. In embodiments in which the relative refractive index profile includes a dedicated offset cladding region directly adjacent to the core region, the radial position r₁ corresponds to the outer radius of the core region and the inner radius of the dedicated offset cladding region. In all embodiments herein, the dedicated trench cladding region has an inner radius r₂ and an outer radius r₃. In embodiments having an offset cladding region, the radius r₂>r₁ and corresponds to the outer radius of the dedicated offset cladding region and the inner radius of the dedicated trench cladding region. In embodiments without an offset cladding region, the radius r₂=r₁ corresponds to the outer radius of the core region and the inner radius of the dedicated trench cladding region.

The following terminology applies to embodiments in which the relative refractive index profile of a core element includes a dedicated offset cladding region surrounding and directly adjacent to a core region. The difference r₂−r₁ between radial position 12 and radial position r₁ is referred to herein as the thickness of the dedicated offset cladding region.

The following terminology applies to embodiments in which a dedicated trench cladding region is directly adjacent to a core region. The difference between radial position r₃ and radial position r₂=r₁ is referred to herein as the thickness or width of the dedicated trench cladding region.

The following terminology applies to embodiments in which the relative refractive index profile of a core element includes a dedicated offset cladding region surrounding and directly adjacent to a core region, a dedicated trench cladding region surrounding and directly adjacent to the dedicated offset cladding region. The difference r₂−r₁ between radial position r₂ and radial position r₁ is referred to herein as the thickness of the dedicated offset cladding region. The difference r₃−r₂ between radial position r₃ and radial position 12 is referred to herein as the thickness of the dedicated trench cladding region.

In embodiments with a primary coating surrounding and directly adjacent to a common cladding region, and a secondary coating surrounding and directly adjacent the primary coating, the difference R₅−R₄ between radial position R₅ and radial position R₄ is referred to herein as the thickness of the primary coating and the difference R₆−R₅ between radial position R₆ and radial position R₅ is referred to herein as the thickness of the secondary coating.

As will be described further hereinbelow, the relative refractive indices of the core region, dedicated offset cladding region, dedicated trench cladding region, dedicated outer cladding region, and common cladding region may differ. The relative refractive index of the core region is higher than the relative refractive index of any of the dedicated or common cladding regions. The relative refractive index of an offset cladding region may be greater than, less than or equal to the relative refractive index of a common cladding region. In embodiments in which a core element includes a core region, a dedicated offset cladding region, a dedicated trench cladding region, the relative refractive index of the dedicated trench cladding region is less than the relative refractive index of the dedicated offset cladding region and the relative refractive index of the common cladding region. Any or all of the relative refractive indices, radial positions, and thicknesses of the core region, dedicated offset cladding region, dedicated trench cladding region, and dedicated outer cladding region for different core elements of the multicore optical fiber may be the same or different. The multicore optical fiber may be homogeneous or heterogeneous. In different embodiments, all core elements of the multicore optical fiber have step-index profiles, all core elements of the multicore optical fiber have graded-index profiles, or some core elements of the multicore optical fiber have step-index profiles and other core elements of the multicore optical fiber have graded-index profiles.

As described herein, the relative refractive indices of the core region, dedicated offset cladding region, dedicated trench cladding region, dedicated outer cladding region, and common cladding region may differ. Each of the regions may be formed from doped or undoped silica glass. Variations in refractive index relative to undoped silica glass are accomplished by incorporating updopants or downdopants at levels designed to provide a targeted refractive index or refractive index profile using techniques known to those of skill in the art. Updopants are dopants that increase the refractive index of the glass relative to the undoped glass composition. Downdopants are dopants that decrease the refractive index of the glass relative to the undoped glass composition. In one embodiment, the undoped glass is silica glass. When the undoped glass is silica glass, updopants include Cl, Br, Ge, Al, P, Ti, Zr, Nb, and Ta, and downdopants include F and B. Other dopants, such as alkali metals (e.g., Na, K), that have little effect on the refractive index of silica glass may also be included. Regions of constant refractive index may be formed by not doping or by doping at a uniform concentration over the thickness of the region. Regions of variable refractive index are formed through non-uniform spatial distributions of dopants over the thickness of a region and/or through incorporation of different dopants in different regions. Refractive index varies approximately linearly with the concentration of the updopant or downdopant. For example, each 1 wt % Cl as a dopant in silica glass increases the relative refractive index by about 0.066% and each 1 wt % F as a dopant in silica glass decreases the relative refractive index by about 0.32%.

The coatings formed on glass fibers are formed from curable coating compositions. Curable coating compositions include one or more curable components. As used herein, the term “curable” is intended to mean that the component, when exposed to a suitable source of curing energy, includes one or more curable functional groups capable of forming covalent bonds that participate in linking the component to itself or to other components of the coating composition. The product obtained by curing a curable coating composition is referred to herein as the cured product of the composition. The cured product is preferably a polymer. The curing process is induced by energy. Forms of energy include radiation or thermal energy. In a preferred embodiment, curing occurs with radiation, where radiation refers to electromagnetic radiation. Curing induced by radiation is referred to herein as radiation curing or photocuring. A radiation-curable component is a component that can be induced to undergo a curing reaction when exposed to radiation of a suitable wavelength at a suitable intensity for a sufficient period of time. Suitable wavelengths include wavelengths in the infrared, visible, or ultraviolet portion of the electromagnetic spectrum. The radiation curing reaction occurs in the presence of a photoinitiator. A radiation-curable component may also be thermally curable. Similarly, a thermally curable component is a component that can be induced to undergo a curing reaction when exposed to thermal energy of sufficient intensity for a sufficient period of time. A thermally curable component may also be radiation curable.

A curable component includes one or more curable functional groups. A curable component with only one curable functional group is referred to herein as a monofunctional curable component. A curable component having two or more curable functional groups is referred to herein as a multifunctional curable component. Multifunctional curable components include two or more functional groups capable of forming covalent bonds during the curing process and can introduce crosslinks into the polymeric network formed during the curing process. Multifunctional curable components may also be referred to herein as “crosslinkers” or “curable crosslinkers”. Curable components include curable monomers and curable oligomers. Examples of functional groups that participate in covalent bond formation during the curing process are identified hereinafter.

The term “(meth)acrylate” means methacrylate, acrylate, or a combination of methacrylate and acrylate.

Reference will now be made in detail to illustrative embodiments of the present disclosure.

The present disclosure provides multicore glass fibers and multicore optical fibers as well as ribbons and cables containing multicore glass fibers and multicore optical fibers. In a ribbon, the multicore glass fibers or multicore optical fibers are aligned relative to one another in a substantially planar and parallel relationship. The multicore glass fibers or multicore optical fibers in ribbons are encapsulated by a ribbon matrix in any of several known configurations (e.g., edge-bonded ribbon, thin-encapsulated ribbon, thick-encapsulated ribbon, or multi-layer ribbon) by conventional methods of making fiber optic ribbons. The ribbon contains two or more multicore glass fibers or multicore optical fibers. In some embodiments, the ribbon contains four or more, or eight or more, or twelve or more, or sixteen or more multicore glass fibers or multicore optical fibers. The ribbon matrix has tensile properties similar to the tensile properties of a secondary coating and is formed from the same, similar, or different composition used to prepare a secondary coating. A cable includes a plurality of multicore glass fibers or multicore optical fibers surrounded by a jacket. The jacket typically has a circular cross-section and is flexible or rigid depending on the application requirement. Multicore glass fibers or multicore optical fibers are densely or loosely packed into a conduit enclosed by an inner surface of the jacket. The number of fibers placed in the jacket is referred to as the “fiber count” of cable. The jacket is formed from an extruded polymer material and may include multiple concentric layers of polymers or other materials. The cable may also include one or more strengthening members embedded within the jacket or placed within the conduit defined by the inner surface of the jacket. Strengthening members include fibers or rods that are more rigid than the jacket. The strengthening member is made from metal, braided steel, glass-reinforced plastic, fiber glass, or other suitable material. The cable may include other layers surrounded by the jacket (e.g., armor layers, moisture barrier layers, rip cords, etc.). The cable may have a stranded, loose tube core or other fiber optic cable construction.

FIG. 1B illustrates a planar optical fiber ribbon 15. The planar optical fiber ribbon 15 includes a plurality of multicore optical fibers 13 and a ribbon matrix 32 encapsulating the plurality of optical fibers. Multicore optical fibers 13 include two (depicted) or more core elements, each of which includes a core region and a dedicated cladding region, a common cladding, a primary coating, and a secondary coating as described herein. Multicore optical fibers 13 may also include a tertiary coating surrounding and directly adjacent to the secondary coating. Either of the secondary or tertiary coating may include a pigment. The multicore optical fibers 13 are aligned relative to one another in a substantially planar and parallel relationship. The multicore optical fibers 13 in planar optical fiber ribbon 15 are encapsulated by the ribbon matrix 32 in any known configuration (e.g., edge-bonded ribbon, thin-encapsulated ribbon, thick-encapsulated ribbon, or multi-layer ribbon) by conventional methods of making fiber optic ribbons. In FIG. 1B, the planar optical fiber ribbon 15 contains twelve (12) multicore optical fibers 13; however, it should be apparent to those skilled in the art that any number of multicore optical fibers 13 (e.g., two or more) may be employed to form planar optical fiber ribbon 15 disposed for a particular use. By way of example, and not limitation, the planar optical fiber ribbon 15 can include eight (8) multicore optical fibers 13, sixteen (16) multicore optical fibers 13, twenty-four (24) multicore optical fibers 13, or thirty-two (32) multicore optical fibers 13. The ribbon matrix 32 can be formed from the same composition used to prepare a secondary coating, or the ribbon matrix 32 can be formed from a different composition that is otherwise compatible for use.

FIG. 1C illustrates an optical fiber cable 40. Cable 40 includes a plurality of multicore optical fibers 13 surrounded by jacket 42. Multicore optical fibers 13 may be densely or loosely packed into a conduit enclosed by inner surface 43 of jacket 42. The number of multicore optical fibers 13 placed in jacket 42 is referred to as the “fiber count” of optical fiber cable 40. The jacket 42 is formed from an extruded polymer material and may include multiple concentric layers of polymers or other materials. Optical fiber cable 40 may include one or more strengthening members (not shown) embedded within jacket 42 or placed within the conduit defined by inner surface 43. Strengthening members include fibers or rods that are more rigid than jacket 42. The strengthening member is made from metal, braided steel, glass-reinforced plastic, fiberglass, or other suitable material. Optical fiber cable 40 may include other layers surrounded by jacket 42 (e.g. armor layers, moisture barrier layers, rip cords, etc.). Optical fiber cable 40 may have a stranded, loose tube core or other fiber optic cable construction. Additional embodiments of optical fiber cable 40 are described in greater detail below

FIG. 1D illustrates a multicore optical fiber in schematic cross-sectional view. Multicore optical fiber 10 includes a glass fiber 11 surrounded by primary coating 46 and secondary coating 48. Glass fiber 11 includes core elements 2 and 3 in common cladding 36. Glass fiber 11 as depicted in FIG. 1D includes two core elements. It should be apparent, however, that multicore glass fibers having more than two core elements are similarly contemplated and within the scope of the disclosure. The number of core elements in the multicore fiber is two or more, or three or more, or four or more, or six or more, or eight or more, or twelve or more, or sixteen or more, or between 2 and 32, or between 3 and 28, or between 4 and 24, or between 6 and 20, or between 8 and 16.

FIG. 1E illustrates representative glass fibers 11 that include various numbers and arrangements of core elements 2 in common cladding 36. Particular characteristics of the structure and arrangement of core elements that minimize crosstalk between core elements are described below.

FIG. 1F illustrates a glass fiber 11 of a multicore optical fiber 10 with two core elements in cross-sectional view. Multicore glass fiber 11 is a 1×2 multicore glass fiber with center 44 that includes core element 2 and core element 3, which are surrounded by common cladding 36. Core element 2 has a center 4 positioned on a centerline passing through core element 2 and an outer radius 21 (corresponding in various embodiments described below to r₁, r₂, r₃, or r₄). Core element 3 has a center 5 positioned on a centerline passing through core element 3 and an outer radius 22 (corresponding in various embodiments described below to r₁, r₂, r₃, or r₄). The core element spacing between the centerlines of core elements 2 and 3 is depicted at 16. As used herein, “core element spacing” of a core element refers to the distance between the centerline of the core element and the centerline of the closest core element. A core element and its closest core element are said to be “adjacent” to each other and are referred to herein as “adjacent core elements” or as a pair of adjacent core elements. The core element spacings for the different core elements in a multicore optical fiber having more than two core elements may be the same or different. If some of the core element spacings are the same, a core element may have more than one adjacent core element. The edge spacing between the centerline of core element 2 and the outer surface 37 of common cladding 36 is depicted at 17. The edge spacing between the centerline of core element 3 and the outer surface 37 of common cladding 36 is depicted at 18. As used herein, “edge spacing” of a core element refers to the shortest distance between the centerline of the core element and the outer surface 37 of the common cladding 36 (the surface defined by the radius R₄ (shown at 15)). Edge spacings 17 and 18 may be the same or different. In embodiments with three or more core elements, the edge spacing of different core elements may be the same or different. In glass fiber 11 of multicore optical fiber 10, the propagation constant β for core element 2 may be same as or different from the propagation constant β for core element 3. That is, glass fiber 11 of a multicore optical fiber 10 may be homogeneous or heterogeneous. Differences in the propagation constant β, if present, result from differences in the refractive index, dimensions and/or configuration of core element 2 and 3.

In some embodiments, the core region and dedicated cladding region of the core elements have a discernible core-cladding boundary. Alternatively, the core region and dedicated cladding region can lack a distinct boundary. One type of core element is a step-index core element, which has a core region with a constant or approximately constant relative refractive index. Another type of core element is a graded-index core element, which has a core region with a refractive index that varies with radial position from the centerline (r=0) of the core element. Examples of graded-index core elements are core elements with a core region having a relative refractive index profile characterized by the α-profile defined by Eq. (3) above. In embodiments, the value of α of the graded-index profile is in the range from 1.0 to 9.0, or in the range from 1.5 to 7.0, or in the range from 2.0 to 5.0. For purposes of the present disclosure, a step-index core element has a core region with a relative refractive index profile described by the α-profile defined by Eq. (3) above, where the value of the parameter α is greater than or equal to 10.

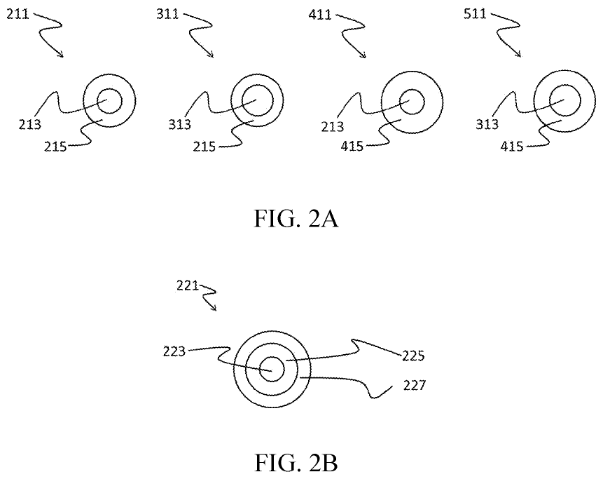

FIGS. 2A-2B shows various examples of core elements in accordance with the present disclosure. FIG. 2A shows core element 211 with a core region 213 and a dedicated cladding region 215. Dedicated cladding region 215 surrounds and is directly adjacent to core region 213. Core region 213 has a higher relative refractive index than dedicated cladding region 215. Core element 311 is a variant of core element 211 that includes dedicated cladding region 215 and core region 313 with a larger radius than core region 213. Core element 411 is a variant of core element 211 that includes core region 213 and a dedicated cladding region 415 and with a larger radius than dedicated cladding region 215. Core element 511 is a variant of core element 211 that includes core region 313 with a larger radius than core region 213 and dedicated cladding region 415 and with a larger radius than dedicated cladding region 215. In embodiments, dedicated cladding regions 215 and 415 are a dedicated offset cladding region or a dedicated trench cladding region as described herein. Core regions 213 and 313 may have the same or different relative refractive index and each has a relative refractive index greater than the relative refractive index of common cladding 36. Dedicated cladding regions 215 and 415 may have the same or different relative refractive index and each has a relative refractive index greater than, equal to, or less than the relative refractive index of common cladding 36. In a preferred embodiment, dedicated cladding regions 215 and 415 are a dedicated trench cladding region as described herein.

FIG. 2B shows core element 221 with core region 223, first dedicated cladding region 225, and second dedicated cladding region 227. Dedicated cladding region 225 surrounds and is directly adjacent to core region 223. Dedicated cladding region 227 surrounds and is directly adjacent to dedicated cladding region 225. Core region 223 has a higher relative refractive index than either first dedicated cladding region 225 or second dedicated cladding region 227. Core region 223 also has a relative refractive index greater than the relative refractive index of common cladding 36. First dedicated cladding region 225 and second dedicated cladding region 227 differ in relative refractive index and each has a relative refractive index greater than, equal to, or less than the relative refractive index of common cladding 36. In a preferred embodiment, dedicated cladding region 215 is a dedicated offset cladding region as described herein and dedicated cladding region 415 is a dedicated trench cladding region as described herein with dedicated cladding region 415 having a lower relative refractive index than dedicated cladding region 215. Embodiments (not shown) further include variations of core element 221 in which one or more of the core region, first dedicated cladding region and second dedicated cladding region differ in radius and/or relative refractive index from core region 223, first dedicated cladding region 225, and second dedicated cladding region 227.

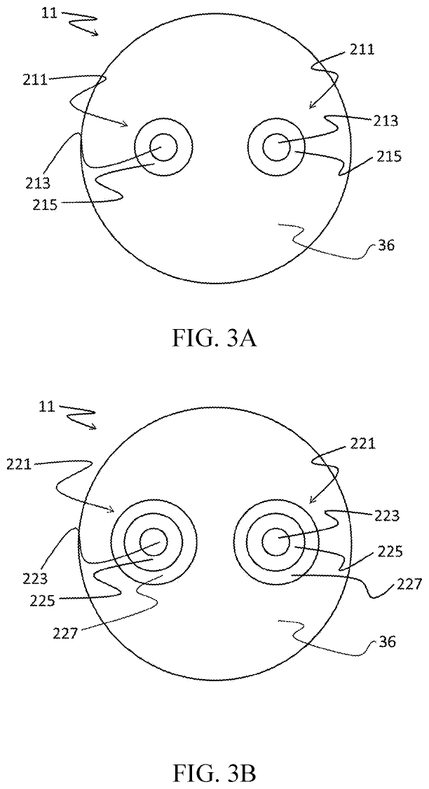

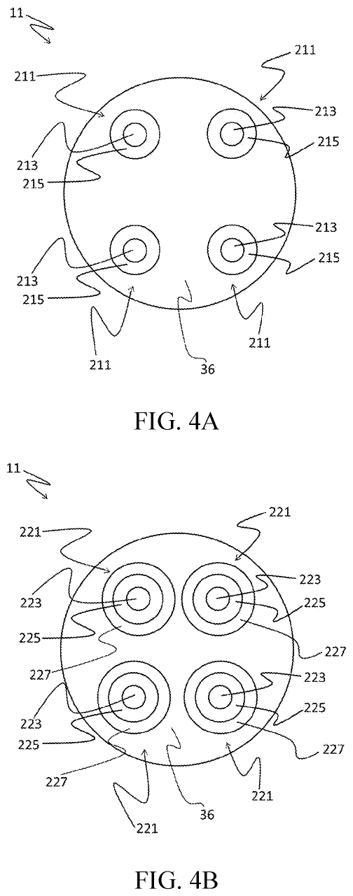

Embodiments of the multicore optical fibers of the present disclosure include two or more core elements of the types and variants thereof described in FIGS. 2A-2B. Various embodiments of multicore optical fibers are depicted in FIGS. 3A-4B. FIG. 3A shows a two-core (1×2) multicore glass fiber 11 that includes two of the core elements 211 shown in FIG. 2A. FIG. 3B shows a two-core (1×2) multicore glass fiber 11 that includes two of the core elements 221 shown in FIG. 2B. FIG. 4A shows a four-core (2×2) multicore glass fiber 11 that includes four of the core elements 211 shown in FIG. 2A. FIG. 4B shows a four-core (2×2) multicore glass fiber 11 that includes four of the core elements 221 shown in FIG. 2B. Similar embodiments of multicore glass fibers using other combinations of two or more of the core elements depicted in FIGS. 2A-2B and variations thereof, such as the arrangements depicted in FIG. 1E with various combinations of core elements 211 and 221 shown in FIGS. 2A and 2B, are within the scope of the present disclosure. Other arrangements of core elements include N×M generally, where N and M are integers respectively representing the number of row and columns in the configuration of core elements, and polygonal (e.g., hexagonal) where the number of core elements is as described herein.

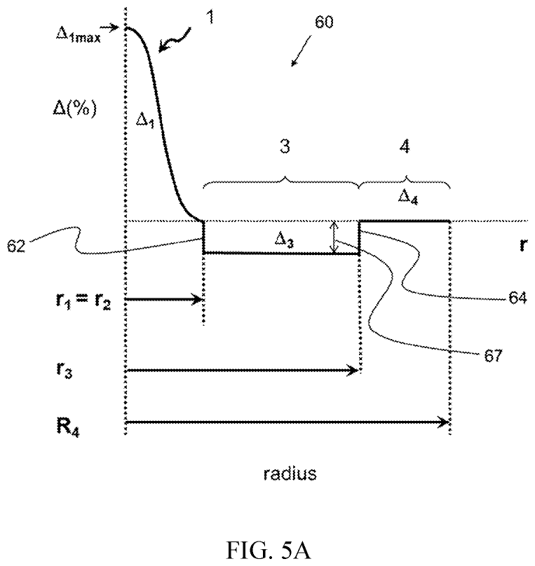

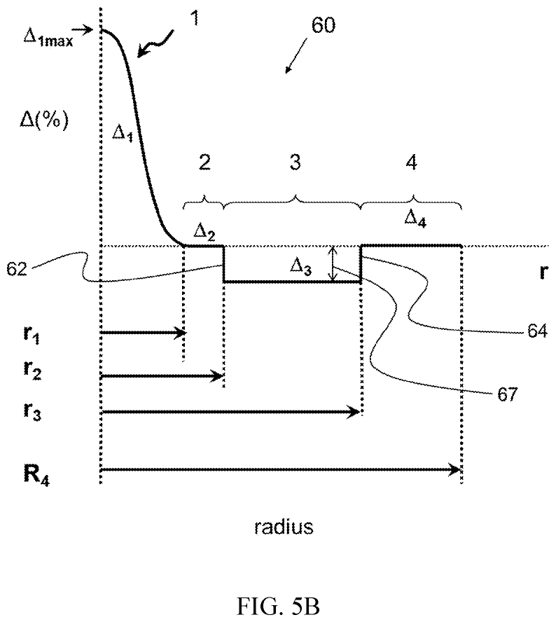

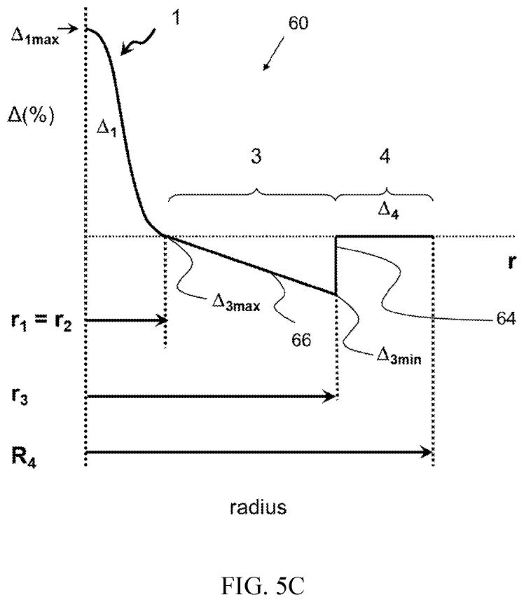

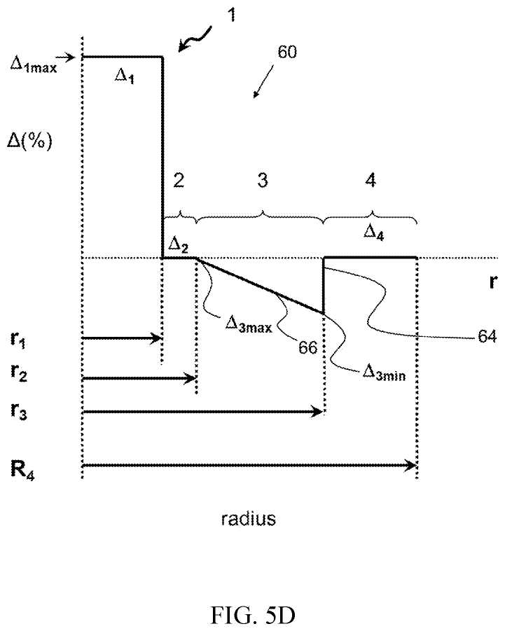

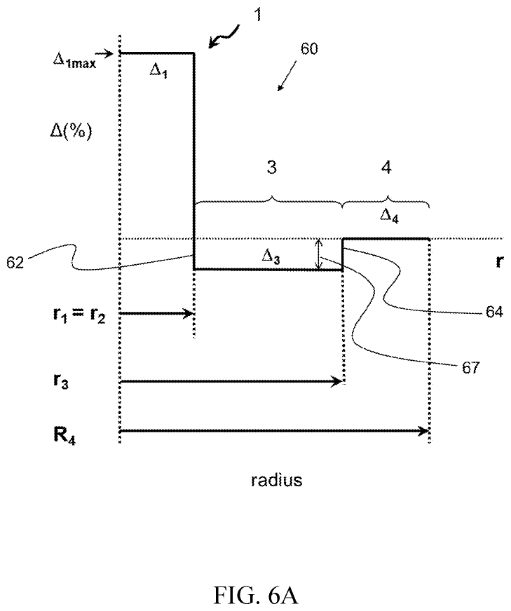

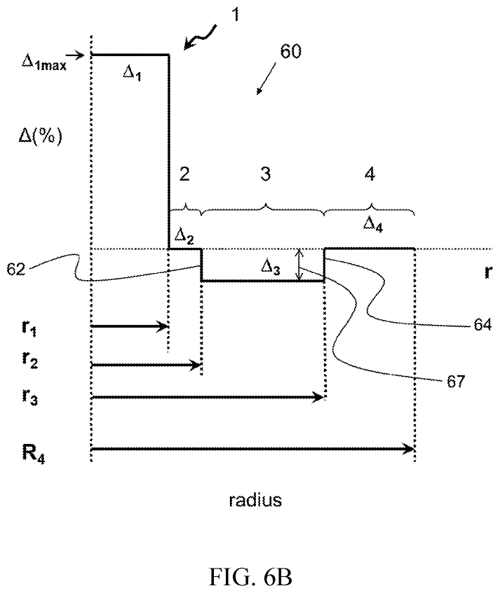

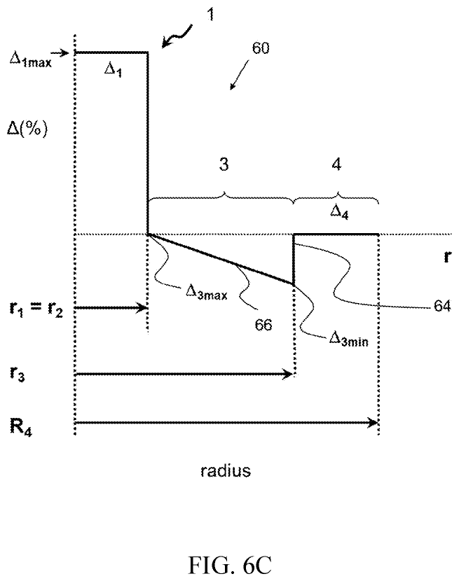

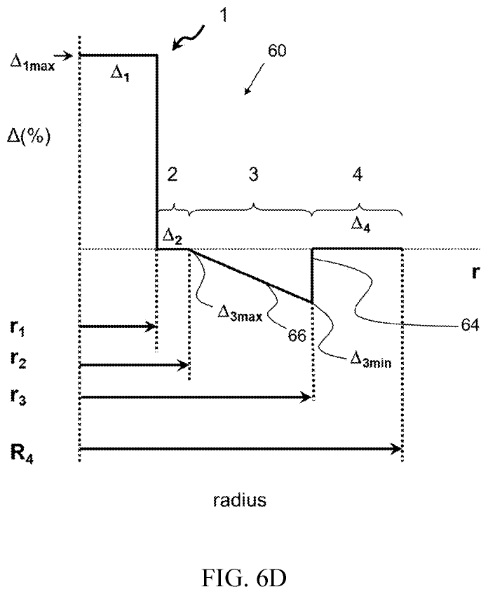

Representative relative refractive index profiles for core elements of a multicore glass fiber are presented in FIGS. 5A-6D.

FIG. 5A shows a graded index profile for a core element of a multicore glass fiber 60 having a core region (1) with outer radius r₁ and relative refractive index Δ₁ with maximum relative refractive index Δ_{1 max}, a dedicated trench cladding region (3) extending from radial position r₂−r₁ to radial position 13 and having relative refractive index Δ₃, and a common cladding region (4) extending from radial position r₃ to radial position R₄ and having relative refractive index Δ₄. In the embodiment of FIG. 5A, relative refractive index Δ₃ is constant or approximately constant from inner radius r₂ of the dedicated trench cladding region (3) to the outer radius r₃ of the dedicated trench cladding region (3).

FIG. 5B shows a graded index profile for a core element of a multicore glass fiber 60 having a core region (1) with outer radius r₁ and relative refractive index Δ₁ with maximum relative refractive index Δ_{1 max}, a dedicated offset cladding region (2) extending from radial position r₁ to radial position r₂>r₁ and having relative refractive index Δ₂, a dedicated trench cladding region (3) extending from radial position r₂ to radial position r₃ and having relative refractive index Δ₃, and a common cladding region (4) extending from radial position r₃ to radial position R₄ and having relative refractive index Δ₄. In the embodiment of FIG. 5B, the relative refractive index Δ₃ is constant or approximately constant from inner radius r₂ of the dedicated trench cladding region (3) to the outer radius r₃ of the dedicated trench cladding region (3).

FIG. 5C shows a graded index profile for a core element of a glass fiber 60 having a core region (1) with outer radius r₁ and relative refractive index Δ₁ with maximum relative refractive index Δ_{1 max}, a dedicated trench cladding region (3) extending from radial position r₂=r₁ to radial position r₃ and having relative refractive index Δ₃, and a common cladding region (4) extending from radial position r₃ to radial position R₄ and having relative refractive index Δ₄. In the embodiment of FIG. 5C, the relative refractive index Δ₃ is monotonically decreasing with a constant or approximately constant slope from a maximum value Δ_{3 max} at inner radius r₂ of the dedicated trench cladding region (3) to a minimum value Δ₃ min at the outer radius r₃ of the dedicated trench cladding region (3). FIG. 5C is an example of a dedicated trench cladding region in which the relative refractive index Δ₃ continuously varies between the inner radius r₂ of the dedicated trench cladding region (3) and the outer radius r₃ of the dedicated trench cladding region (3). FIG. 5C is also an example of a dedicated trench cladding region in which the radial position of the minimum value Δ₃ min is closer to the outer radius r₃ of the dedicated trench cladding region (3) than it is to the inner radius r₂ of the dedicated trench cladding region (3).

FIG. 5D shows a graded index profile for a core element of a multicore glass fiber 60 having a core region (1) with outer radius r₁ and relative refractive index Δ₁ with maximum relative refractive index Δ_{1 max}, a dedicated offset cladding region (2) extending from radial position r₁ to radial position r₂>r₁ and having relative refractive index Δ₂, a dedicated trench cladding region (3) extending from radial position 2 to radial position r₃ and having relative refractive index Δ₃, and a common cladding region (4) extending from radial position r₃ to radial position R₄ and having relative refractive index Δ₄. In the embodiment of FIG. 5D, the relative refractive index Δ₃ is monotonically decreasing with a constant or approximately constant slope from a maximum value Δ_{3 max} at inner radius r₂ of the dedicated trench cladding region (3) to a minimum value Δ₃ min at the outer radius r₃ of the dedicated trench cladding region (3).

In the profiles of FIGS. 5A and 5B, the dedicated trench cladding region (3) has a constant or average relative refractive index Δ₃ that is less than the relative refractive index Δ₄ of the common cladding region (4). In the profiles of FIGS. 5C and 5D, the dedicated trench cladding region (3) has a minimum relative refractive index Δ₃ min that is less than the relative refractive index Δ₄ of the common cladding region (4). Core region (1) has the highest average and highest maximum relative refractive index in the profile. Core region (1) may include a lower index region at or near the centerline (known in the art as a “centerline dip”) (not shown).

In the embodiments shown in FIGS. 5A-5D, the core region (1) of the glass fiber has a relative refractive index described by an α-profile. The radial position r₀ (corresponding to Δ_{1 max}) of the α-profile corresponds to the centerline (r=0) of the core element and the radial position r_{z} of the α-profile corresponds to the core radius r₁. In embodiments with a centerline dip, the radial position r₀ is slightly offset from the centerline of the core element (not shown). In other embodiments, core region (1) shown in FIGS. 5A-5D is a step index relative refractive index profile instead of an α-profile (see FIGS. 6A-6D). In still other embodiments, core region (1) has a relative refractive index profile not defined by any of an α-profile or a step-index profile. In some embodiments, the relative refractive index Δ₁ continuously decreases in the radial direction away from the centerline of the core element. In other embodiments, relative refractive index Δ₁ varies over some radial positions between the centerline of the core element and r₁, and also includes a constant or approximately constant value over other radial positions between the centerline of the core element and r₁.

In FIGS. 5A and 6A, transition region 62 from core region (1) to dedicated trench cladding region (3) and transition region 64 from dedicated trench cladding region (3) to common cladding region (4) are shown as step changes. In FIGS. 5B and 6B, transition region 62 from dedicated offset cladding region (2) to dedicated trench cladding region (3) and transition region 64 from dedicated trench cladding region (3) to common cladding region (4) are shown as step changes. In FIGS. 5C, 5D, 6C, and 6D, transition region 64 from dedicated trench cladding region (3) to common cladding region (4) is shown as a step change. It is to be understood that a step change is an idealization and that transition region 62 and transition region 64 may not be strictly vertical in practice. Instead, transition region 62 and/or transition region 64 may have a slope or curvature. When transition region 62 and/or transition region 64 are non-vertical, the inner radius (12) and outer radius (13) of trench cladding region (3) correspond to the mid-points of transition regions 62 and 64, respectively. The mid-points correspond to half of the depth 67 (FIGS. 5A, 5B, 6A, and 6B) or half the depth of the minimum relative refractive index Δ₃ min (FIGS. 5C, 5D 6C, and 6D) of the trench cladding region (3), where depth 67 or the depth of the minimum relative refractive index Δ₃ min is defined relative to relative refractive index Δ₄ of the common cladding region (4).

The relative ordering of relative refractive indices Δ₁, Δ₃, and Δ₄ in the relative refractive index profile shown in FIGS. 5A, 5B, 6A, and 6B satisfy the condition Δ_{1 max}>Δ₄>Δ₃. The relative ordering of relative refractive indices Δ₁, Δ₃ min, and Δ₄ in the relative refractive index profile shown in FIGS. 5C, 5D, 6C, and 6D satisfy the condition Δ_{1 max}>Δ₄>Δ₃ min.

The core region comprises silica glass. The silica glass of the core region is undoped silica glass, updoped silica glass, and/or downdoped silica glass. In one embodiment, the silica glass of the core region is Ge-free; that is the core region comprises silica glass that lacks Ge. In another embodiment, the core region comprises silica glass doped with germanium dioxide (GeO₂). Embodiments of updoped silica glass include silica glass doped with an alkali metal oxide (e.g. Na₂O, K₂O, Li₂O, Cs₂O, or Rb₂O) and/or a halogen (Cl or Br). Downdoped silica glass includes silica glass doped with F. In a preferred embodiment, the core region comprises Ge-doped silica glass.

In some embodiments, the relative refractive index of the core region of the core element of the multicore glass fiber is described by an α-profile with an a value in the range from 1.5 to 10, or in the range from 1.7 to 8.0, or in the range from 1.8 to 6.0, or in the range from 1.9 to 5.0, or in the range from 1.95 to 4.5, or in the range from 2.0 to 4.0, or in the range from 10 to 100, or in the range from 11 to 40, or in the range from 12 to 30. As the value of a increases, the relative refractive profile more closely approaches a step index profile. For purposes of the present disclosure, an α-profile with an a value greater than or equal to 10 is regarded as a step index profile.

The outer radius r₁ of the core region is in the range from 2.5 μm to 6.0 μm, or in the range from 3.0 μm to 5.5 μm, or in the range from 3.5 μm to 5.0 μm. In embodiments without a dedicated offset cladding region, the inner radius of the dedicated trench cladding region is r₂=r₁ and has the values listed for r₁ above.

The relative refractive index Δ₁ or Δ_{1 max} of the core region is in the range from 0.30% to 0.60%, or in the range from 0.35% to 0.55%, or in the range from 0.40% to 0.50%. The minimum relative refractive index Δ_{1 min} of the core region is in the range from −0.10% to 0.10%, or in the range from −0.05% to 0.05%, or in the range from −0.02% to 0.02%.

In some embodiments, the relative refractive index of the core region is described by a step-index profile having a constant or approximately constant value corresponding to Δ_{1 max} that extends over at least 70%, or at least 80%, or at least 90% of the distance between the centerline of the core element (r=0) and the outer radius r₁.

In some embodiments, the cladding includes a dedicated offset cladding region directly adjacent the core region and a dedicated trench cladding region directly adjacent the dedicated offset cladding region. In these embodiments, the dedicated offset cladding region has an inner radius r₁ as defined above and an outer radius r₂>r₁. In these embodiments, the outer radius r₂ of the dedicated offset cladding region is in the range from 5.0 μm to 12.0 μm, or in the range from 5.5 μm to 11.0 μm, or in the range from 6.0 μm to 10.0 μm. The thickness r₂−r₁ of the dedicated offset cladding region is in the range from 1.0 μm to 8.0 μm, or in the range from 1.5 μm to 7.0 μm, or in the range from 2.0 μm to 6.0 μm, or in the range from 2.0 μm to 5.0 μm. The relative refractive index Δ₂ of the dedicated offset cladding region is in the range from −0.10% to 0.10%, or in the range from −0.05% to 0.05%, or in the range from −0.02% to 0.02%.

The dedicated trench cladding region comprises downdoped silica glass. The preferred downdopant is F (fluorine). The relative refractive index Δ₃ or Δ₃ min of the dedicated trench cladding region is greater than or equal to −0.70% and/or less than or equal to −0.10%, or greater than or equal to −0.65% and/or less than or equal to −0.15%, or greater than or equal to −0.60% and/or less than or equal to −0.20%, or greater than or equal to −0.55% and/or less than or equal to −0.25%, or greater than or equal to −0.50% and/or less than or equal to −0.30%, or in the range from −0.10% to −0.70%, or in the range from −0.15% to −0.70%, or in the range from −0.15% to −0.55%, or in the range from −0.20% to −0.50% or in the range from −0.25% to −0.45%, or in the range from −0.30% to −0.60%. In some embodiments, the relative refractive index Δ₃ is constant or approximately constant, and in other embodiments, the relative refractive index Δ₃ varies continuously or decreases monotonically from inner radius r₂ to outer radius r₃. In a preferred embodiment, the monotonic decrease in Δ₃ exhibits a constant or approximately constant slope. In such embodiments, the dedicated trench cladding region is referred to herein as a triangular trench. The monotonic decrease in Δ₃ extends from a maximum value Δ_{3 max} at or near inner radius r₂ to a minimum value Δ₃ min at or near outer radius r₃. The relative refractive index Δ_{3 max} is in the range from −0.10% to 0.10%, or in the range from −0.05% to 0.05%, or in the range from −0.02% to 0.02%. In one embodiment, relative refractive index Δ_{3 max} is equal or approximately equal to the relative refractive index Δ_{1 min}. In another embodiment, the relative refractive index Δ_{3 max} is equal or approximately equal to the relative refractive index Δ₂. The relative refractive index Δ₃ min is in the range from −0.15% to −0.70%, or in the range from −0.20% to −0.70%, or in the range from −0.25% to −0.65%, or in the range from −0.30% to −0.60%, or in the range from −0.30% to −0.50% or in the range from −0.35% to −0.45%.

The inner radius r₂ of the dedicated trench cladding region is r₂=r₁ (in embodiments without an offset cladding region) or r₂>r₁ (in embodiments with an offset cladding region) and has the values specified above. The outer radius r₃ of the dedicated trench cladding region is in the range from 12.0 μm to 20.0 μm, or in the range from 12.5 μm to 18.0 μm, or in the range from 13.0 μm to 17.0 μm, or in the range from 13.5 μm to 16.5 μm. The thickness r₃−r₂ of the dedicated trench cladding region is in the range from 3.0 μm to 12.0 μm, or in the range from 5.0 μm to 11.0 μm, or in the range from 6.0 μm to 10.0 μm.

The dedicated trench cladding region has a trench volume greater than or equal to 30% μm², or greater than or equal to 35% μm², or greater than or equal to 40% μm², or greater than or equal to 45% μm², or greater than or equal to 50% μm², or greater than or equal to 55% μm², or in the range from 30% μm² to 60% μm², or in the range from 35% μm² to 55% μm², or in the range from 40% μm² to 50% μm². Trench volume can be controlled by varying the thickness r₃-r₂ of the dedicated trench cladding region, the relative refractive index (Δ₃, Δ₃ min, and/or Δ_{3 max}) of the dedicated trench cladding region and/or the difference between the relative refractive index of the common cladding region (Δ₄) and the relative refractive index of the dedicated trench cladding region (Δ₃, Δ₃ min, and/or Δ_{3 max}).

The relative refractive index Δ₄ or Δ_{4 max} of the common cladding (or any of a plurality of common cladding regions) is in the range from −0.10% to 0.10%, or in the range from −0.05% to 0.05%, or in the range from −0.02% to 0.02%. The relative refractive index Δ₄ is preferably constant or approximately constant.

The common cladding surrounds and is directly adjacent to the core elements. The outer radius R₄ of the common cladding is in the range from 55.0 μm to 70.0 μm, or in the range from 57.5 μm to 67.5 μm, or in the range from 60.0 μm to 65.0 μm, or in the range from 61.0 μm to 64.0 μm, or in the range from 62.0 μm to 63.0 μm, or about 62.5 μm.

Optical Fiber Coatings. The transmissivity of light through an optical fiber is dependent on the properties of the coatings applied to the glass fiber. The coatings typically include a primary coating and a secondary coating, where the secondary coating surrounds and directly contacts the primary coating and the primary coating surrounds and directly contacts the glass fiber. The secondary coating is a harder material (higher in situ modulus (e.g. greater than 1200 MPa)) than the primary coating and is designed to protect the glass fiber from damage caused by abrasion or external forces that arise during processing, handling, and installation of the optical fiber. The primary coating is a softer material (lower in situ modulus (e.g. less than 1 MPa)) than the secondary coating and is designed to buffer or dissipates stresses that result from forces applied to the outer surface of the secondary coating. Dissipation of stresses within the primary coating attenuates the stress and minimizes the stress that reaches the glass fiber. The primary coating is especially important in dissipating stresses that arise due to the microbends that the optical fiber encounters when deployed in a cable. The microbending stresses transmitted to the glass fiber need to be minimized because microbending stresses create local perturbations in the refractive index profile of the glass fiber. The local refractive index perturbations lead to intensity losses for the light transmitted through the glass fiber. By dissipating stresses, the primary coating minimizes microbend-induced intensity losses.

The primary coating 46 preferably has a higher refractive index than the cladding region of the glass fiber in order to allow it to strip errant optical signals away from the core region. The primary coating should maintain adequate adhesion to the glass fiber during thermal and hydrolytic aging, yet be strippable from the glass fiber for splicing purposes.

Primary and secondary coatings are typically formed by applying a curable coating composition to the glass fiber as a viscous liquid and curing. The optical fiber may also include a tertiary coating (not shown) that surrounds the secondary coating. The tertiary coating may include pigments, inks, or other coloring agents to mark the optical fiber for identification purposes and typically has an in situ modulus similar to the in situ modulus of the secondary coating.

Primary Coating Compositions. The primary coating is a cured product of a curable primary coating composition. The curable primary coating compositions provide a primary coating for optical fibers that exhibits low in situ modulus, low pullout force, and strong cohesion. The curable primary coating compositions further enable formation of a primary coating that features clean strippability and high resistance to defect formation during the stripping operation. Low pullout force facilitates clean stripping of the primary coating with minimal residue and strong cohesion inhibits initiation and propagation of defects in the primary coating when it is subjected to stripping forces.

The primary coating is a cured product of a radiation-curable primary coating composition that includes an oligomer, a monomer, a photoinitiator and, optionally, an additive. The following disclosure describes oligomers for the radiation-curable primary coating compositions, radiation-curable primary coating compositions containing at least one of the oligomers, cured products of the radiation-curable primary coating compositions that include at least one of the oligomers, glass fibers coated with a radiation-curable primary coating composition containing at least one of the oligomers, and glass fibers coated with the cured product of a radiation-curable primary coating composition containing at least one of the oligomers.

The oligomer preferably includes a polyether urethane diacrylate compound or a combination of a polyether urethane diacrylate compound and a di-adduct compound. In one embodiment, the polyether urethane diacrylate compound has a linear molecular structure. In one embodiment, the oligomer is formed from a reaction between a diisocyanate compound, a polyol compound, and a hydroxy acrylate compound, where the reaction produces a polyether urethane diacrylate compound as a primary product (majority product) and a di-adduct compound as a byproduct (minority product). The reaction forms a urethane linkage upon reaction of an isocyanate group of the diisocyanate compound and an alcohol group of the polyol. The hydroxy acrylate compound reacts to quench residual isocyanate groups that are present in the composition formed from reaction of the diisocyanate compound and polyol compound. As used herein, the term “quench” refers to conversion of isocyanate groups through a chemical reaction with hydroxyl groups of the hydroxy acrylate compound. Quenching of residual isocyanate groups with a hydroxy acrylate compound converts terminal isocyanate groups to terminal acrylate groups.

The diisocyanate compound, hydroxy acrylate compound and polyol are combined simultaneously and reacted, or are combined sequentially (in any order) and reacted. In one embodiment, the oligomer is formed by reacting a diisocyanate compound with a hydroxy acrylate compound and reacting the resulting product composition with a polyol. In another embodiment, the oligomer is formed by reacting a diisocyanate compound with a polyol compound and reacting the resulting product composition with a hydroxy acrylate compound.

The oligomer is formed from a reaction of a diisocyanate compound, a hydroxy acrylate compound, and a polyol, where the molar ratio of the diisocyanate compound to the hydroxy acrylate compound to the polyol in the reaction process is n:m:p. n, m, and p are referred to herein as mole numbers or molar proportions of diisocyanate, hydroxy acrylate, and polyol; respectively. The mole numbers n, m and p are positive integer or positive non-integer numbers. In embodiments, when p is 2.0, n is in the range from 3.0 to 5.0, or in the range from 3.2 to 4.8, or in the range from 3.4 to 4.6, or in the range from 3.5 to 4.4, or in the range from 3.6 to 4.2, or in the range from 3.7 to 4.0; and m is in the range from 1.5 to 4.0, or in the range from 1.6 to 3.6, or in the range from 1.7 to 3.2, or in the range from 1.8 to 2.8, or in the range from 1.9 to 2.4. For values of p other than 2.0, the molar ratio n:m:p scales proportionally. For example, the molar ratio n:m:p=4.0:3.0:2.0 is equivalent to the molar ratio n:m:p=2.0:1.5:1.0.

The curable primary coating composition further includes one or more monomers. The one or more monomers is/are selected to be compatible with the oligomer, to control the viscosity of the primary coating composition to facilitate processing, and/or to influence the physical or chemical properties of the coating formed as the cured product of the primary coating composition. The monomers include radiation-curable monomers such as ethylenically-unsaturated compounds, ethoxylated acrylates, ethoxylated alkylphenol monoacrylates, propylene oxide acrylates, n-propylene oxide acrylates, isopropylene oxide acrylates, monofunctional acrylates, monofunctional aliphatic epoxy acrylates, multifunctional acrylates, multifunctional aliphatic epoxy acrylates, and combinations thereof.

Representative radiation-curable ethylenically unsaturated monomers include alkoxylated monomers with one or more acrylate or methacrylate groups. An alkoxylated monomer is one that includes one or more alkoxylene groups, where an alkoxylene group has the form —O—R— and R is a linear or branched alkylene group. Examples of alkoxylene groups include ethoxylene (—O—CH₂—CH₂—), n-propoxylene (—O—CH₂—CH₂—CH₂—), isopropoxylene (—O—CH₂—CH(CH₃)—, or —O—CH(CH₃)—CH₂—), etc. As used herein, the degree of alkoxylation refers to the number of alkoxylene groups in the monomer. In one embodiment, the alkoxylene groups are bonded consecutively in the monomer.

In some embodiments, the primary coating composition includes an alkoxylated monomer of the form R′—R″—O—(CH(CH₃)CH₂—O)_{q}—C(O) CH═CH₂, where R′ and R″ are aliphatic, aromatic, or a mixture of both, and q=1 to 10, or R′″—O—(CH(CH₃)CH₂—O)_{q}—C(O)CH═CH₂, where C(O) is a carbonyl group, R′″ is aliphatic or aromatic, and q=1 to 10.

In some embodiments, the monomer component of the primary coating composition includes a multifunctional (meth)acrylate. Multifunctional ethylenically unsaturated monomers include multifunctional acrylate monomers and multifunctional methacrylate monomers. Multifunctional acrylates are acrylates having two or more polymerizable acrylate moieties per molecule, or three or more polymerizable acrylate moieties per molecule.

In some embodiments, the primary coating composition includes an N-vinyl amide monomer such as an N-vinyl lactam, or N-vinyl pyrrolidinone, or N-vinyl caprolactam.

In addition to a curable monomer and a curable oligomer, the curable primary coating composition also includes a polymerization initiator. The polymerization initiator facilitates initiation of the polymerization process associated with the curing of the coating composition to form the coating. Polymerization initiators include thermal initiators, chemical initiators, electron beam initiators, and photoinitiators. Photoinitiators include ketonic photoinitiators and/or phosphine oxide photoinitiators. When used in the curing of the coating composition, the photoinitiator is present in an amount sufficient to enable rapid radiation curing.

The curable primary coating composition optionally includes one or more additives. Additives include an adhesion promoter, a strength additive, an antioxidant, a catalyst, a stabilizer, an optical brightener, a property-enhancing additive, an amine synergist, a wax, a lubricant, and/or a slip agent. Some additives operate to control the polymerization process, thereby affecting the physical properties (e.g., modulus, glass transition temperature) of the polymerization product formed from the coating composition. Other additives affect the integrity of the cured product of the primary coating composition (e.g., protect against de-polymerization or oxidative degradation).

To minimize the overall diameter of the coated optical fiber, it is preferable to minimize the thickness R₅−R₄ of the primary coating. In embodiments, the thickness R₅−R₄ of the primary coating is less than or equal to 25.0 μm, or less than or equal to 22.5 μm, or less than or equal to 20.0 μm, or less than or equal to 17.5 μm.

To minimize microbending, preferred primary coatings have an in situ modulus less than or equal to 0.30 MPa, or less than or equal to 0.27 MPa, or less than or equal to 0.25 MPa, or less than or equal to 0.22 MPa, or less than or equal to 0.20 MPa, or less than or equal to 0.15 MPa. Representative suitable primary coating compositions are the DeSolite® COV-DP-1900 and the DeSolite® COV-DP-1032 primary optical fiber coatings that are commercially available from Covestro (Fiber Optic Center, New Bedford, MA).

For primary coatings, the in situ modulus is measured using the following procedure. A six-inch sample of a coated fiber sample is obtained and a one-inch section from the center of the fiber sample is window stripped and wiped with isopropyl alcohol. The window-stripped fiber sample is mounted on a sample holder/alignment stage equipped with 10 mm×5 mm rectangular aluminum tabs that are used to affix the fiber sample. Two tabs are oriented horizontally and positioned so that the short 5 mm sides are facing each other and separated by a 5 mm gap. The window-stripped fiber sample is laid horizontally on the sample holder across the tabs and over the gap separating the tabs. The coated end of one side of the window-stripped region of the fiber sample is positioned on one tab and extends halfway into the 5 mm gap between the tabs. The one-inch window-stripped region extends over the remaining half of the gap and across the opposing tab. After alignment, the fiber sample is moved and a small dot of glue is applied to the half of each tab closest to the 5 mm gap. The fiber sample is then returned to position and the alignment stage is raised until the glue just touches the fiber sample. The coated end is then pulled away from the gap and through the glue such that the majority of the 5 mm gap between the tabs is occupied by the window-stripped region of the fiber sample. The portion of the window-stripped region remaining on the opposing tab is in contact with the glue. The very tip of the coated end is left to extend beyond the tab and into the gap between the tabs. This portion of the coated end is not embedded in the glue and is the object of the in situ modulus measurement. The glue is allowed to dry with the fiber sample in this configuration to affix the fiber sample to the tabs. After drying, the length of fiber sample fixed to each of the tabs is trimmed to 5 mm. The coated length embedded in glue, the non-embedded coated length (the portion extending into the gap between the tabs), and the primary diameter are measured.

The in situ modulus measurements for the primary coatings are performed on a Rheometrics DMTA IV dynamic mechanical testing apparatus at a constant strain of 9×10⁻⁶ l/s for a time of forty-five minutes at room temperature (21° C.). The gauge length is 15 mm. Force and delta length are recorded and used to calculate the in situ modulus of the primary coating. The tab-mounted fiber samples are prepared by removing any epoxy from the tabs that would interfere with the 15 mm clamping length of the testing apparatus to insure that there is no contact of the clamps with the fiber and that the sample is secured squarely to the clamps. The instrument force is zeroed out. The tab to which the non-coated end of the fiber sample is affixed is then mounted to the lower clamp (measurement probe) of the testing apparatus and the tab to which the coated end of the fiber sample is affixed was mounted to the upper (fixed) clamp of the testing apparatus. The test is then executed and the fiber sample is removed once the analysis is completed.

Secondary Coating—Compositions. The secondary coating is a cured product of a curable secondary coating composition that includes a monomer, a photoinitiator, an optional oligomer, and an optional additive. The present disclosure describes optional oligomers for the radiation-curable secondary coating compositions, radiation-curable secondary coating compositions, cured products of the radiation-curable secondary coating compositions, optical fibers coated with a radiation-curable secondary coating composition, and optical fibers coated with the cured product of a radiation-curable secondary coating composition.

The secondary coating is formed as the cured product of a radiation-curable secondary coating composition that includes a monomer component with one or more monomers. The monomers preferably include ethylenically unsaturated compounds. In one embodiment, the secondary coating is the radiation-cured product of a secondary coating composition that contains urethane acrylate monomers.

The monomers include functional groups that are polymerizable groups and/or groups that facilitate or enable crosslinking. The monomers are monofunctional monomers or multifunctional monomers. In combinations of two or more monomers, the constituent monomers are monofunctional monomers, multifunctional monomers, or a combination of monofunctional monomers and multifunctional monomers. In one embodiment, the monomer component of the curable secondary coating composition includes ethylenically unsaturated monomers. Suitable functional groups for ethylenically unsaturated monomers include, without limitation, (meth)acrylates, acrylamides, N-vinyl amides, styrenes, vinyl ethers, vinyl esters, acid esters, and combinations thereof.

Representative radiation-curable ethylenically unsaturated monomers included alkoxylated monomers with one or more acrylate or methacrylate groups. An alkoxylated monomer is one that includes one or more alkoxylene groups, where an alkoxylene group has the form —O—R— and R is a linear or branched hydrocarbon. Examples of alkoxylene groups include ethoxylene (—O—CH₂—CH₂—), n-propoxylene (—O—CH₂—CH₂—CH₂—), isopropoxylene (—O—CH₂—CH(CH₃)—), etc. As used herein, the degree of alkoxylation refers to the number of alkoxylene groups in the monomer. In one embodiment, the alkoxylene groups are bonded consecutively in the monomer.

Multifunctional ethylenically unsaturated monomers for the curable secondary coating composition include, without limitation, alkoxylated bisphenol A diacrylates, such as ethoxylated bisphenol A diacrylate, with the degree of alkoxylation being 2 or greater. The monomer component of the secondary coating composition may include ethoxylated bisphenol A diacrylate with a degree of ethoxylation ranging from 2 to about 30 or propoxylated bisphenol A diacrylate with the degree of propoxylation being 2 or greater; for example, ranging from 2 to about 30; methylolpropane polyacrylates with and without alkoxylation such as ethoxylated trimethylolpropane triacrylate with the degree of ethoxylation being 3 or greater.

The curable secondary coating composition also includes a photoinitiator and optionally includes additives such as anti-oxidant(s), optical brightener(s), amine synergist(s), tackifier(s), catalyst(s), a carrier or surfactant, and a stabilizer as described above in connection with the curable primary coating composition.

To minimize the overall diameter of the coated optical fiber, it is preferable to minimize the outer radius R₆ and/or the thickness R₆−R₅ of the secondary coating. In embodiments, the outer radius R₆ of the secondary coating is less than or equal to 120.0 μm, or less than or equal to 110.0 μm, or less than or equal to 100.0 μm, or less than or equal to 95.0 μm, or less than or equal to 90.0 μm, or less than or equal to 85.0 μm, or less than or equal to 80.0 μm. In embodiments, the thickness R₆−R₅ of the secondary coating is less than or equal to 25.0 μm, or less than or equal to 22.5 μm, or less than or equal to 20.0 μm, or less than or equal to 17.5 μm.

To maintain adequate protection of the glass fiber, it is preferable for the secondary coating to have a high in situ modulus. Preferred secondary coatings have an in situ modulus greater than or equal to 1200 MPa, or greater than or equal to 1400 MPa, or greater than or equal to 1600 MPa, greater than or equal to 1800 MPa, or greater than or equal to 2000 MPa, or greater than or equal to 2200 MPa, or greater than or equal to 2400 MPa, or greater than or equal to 2600 MPa, or greater than or equal to 2800 MPa, or greater than or equal to 3000 MPa. Representative suitable secondary coating compositions are the DeSolite® COV-DS-2500 and the DeSolite® COV-DP-2900 secondary optical fiber coatings that are commercially available from Covestro (Fiber Optic Center, New Bedford, MA).

For secondary coatings, the in situ modulus is measured using fiber tube-off samples prepared from the fiber samples. A 0.0055 inch Miller stripper is clamped down approximately 1 inch from the end of the fiber sample. This one-inch region of fiber sample is immersed into a stream of liquid nitrogen and held for 3 seconds. The fiber sample is then removed and quickly stripped. The stripped end of the fiber sample is then inspected. If coating remains on the glass portion of the fiber sample, the tube-off sample is deemed defective and a new tube-off sample is prepared. A proper tube-off sample is one that stripped clean from the glass and consists of a hollow tube with primary and secondary coating. The glass, primary and secondary coating diameter are measured from the end-face of the un-stripped fiber sample.

The fiber tube-off samples are run using a Rheometrics DMTA IV instrument at a sample gauge length 11 mm to obtain the in situ modulus of the secondary coating. The width, thickness, and length are determined and provided as input to the operating software of the instrument. The sample is mounted and run using a time sweep program at ambient temperature (21° C.) using the following parameters:

$$Frequency \text{:} 1 Rad / sec$$

$$Strain \text{:} 0.3 \%$$

$$Total Time = 120 sec .$$

$$Time Per Measurement = 1 sec$$

$$Initial Static Force = 15. g$$

$$Static > Dynamic Force by = 10. \%$$

Once completed, the last five E′ (storage modulus) data points are averaged. Each sample is run three times (fresh sample for each run) for a total of fifteen data points. The averaged value of the three runs is reported.

Optical Fiber Preform. In production, optical fibers are drawn from preforms. The preform is a dense glass monolith which may have a typical diameter of about 27 cm and a typical length of about 200 cm. The preform includes a plurality of core elements surrounded by an annular common cladding. The composition of the core elements and common cladding of the preform correspond to the compositions of the core elements and common cladding of a multicore optical fiber drawn from the preform. The diameters of the core region and dedicated cladding region(s) of the core elements of the preform and the thickness of the common cladding of the preform are in proportion to the diameters of the core region and dedicated cladding region(s) of the core elements of a multicore optical fiber and the thickness of the common cladding of a multicore optical fiber drawn from the preform.

Silica and doped silica for the core region and dedicated cladding region(s) of preform core elements, and the preform common cladding of a multicore optical fiber preform can be produced by methods known in the art. Suitable methods include flame combustion methods, flame oxidation methods, flame hydrolysis methods, OVD (outside vapor deposition), IVD (inside vapor deposition), VAD (vapor axial deposition), double crucible methods, rod-in-tube procedures, cane-in-soot method, and doped deposited silica processes. A variety of CVD (chemical vapor deposition) and plasma-enhanced CVD processes are known and are suitable for producing silica or doped silica.

Formation of silica occurs through reaction or decomposition of a silica precursor. Suitable precursors for silica include OMCTS (octamethylcyclotetrasiloxane) and SiCl₄. Doping is accomplished with a doping precursor. The doping precursor can be introduced with the silica precursor in the deposition process or used to treat a silica body formed from the silica precursor. The increase in the refractive index of the core region of the preform core element is achieved by doping the core region with a dopant that increases the index. The dopants in the core region increasing the index include germania (GeO₂), titania (TiO₂), phosphorus (P₂O₅), chlorine, among others. Core dopants can be incorporated by flowing the dopant precursors such as germanium tetrachloride (GeCl₄), titania tetrachloride (TiCl₄), phosphorus oxychloride (POC₁₃) among others in the burner along with the silica precursors during the core region step of the preform core element deposition process. Halogens are doped by treating the soot preform during the consolidation and sintering of the preform. Suitable precursors for doping silica with chlorine include C₁₂, SiCl₄, Si₂Cl₆, Si₂OCl₆, and CC₁₄. Suitable precursors for doping silica with fluorine include F₂, CF₄, and SiF₄. The silica precursor and/or doping precursor is preferably provided as a gas to the deposition process. The gas phase silica precursor or gas phase doping precursor is supplied undiluted or in combination with an inert diluent gas (e.g. He, N₂, Ar).

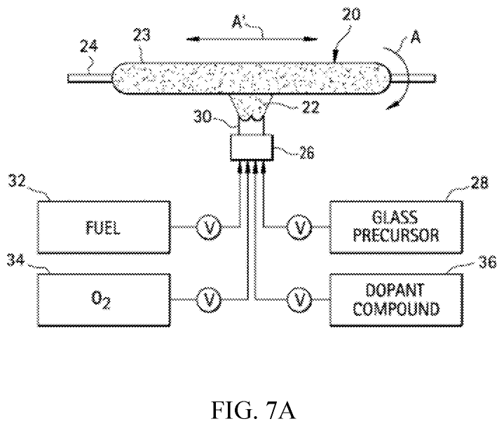

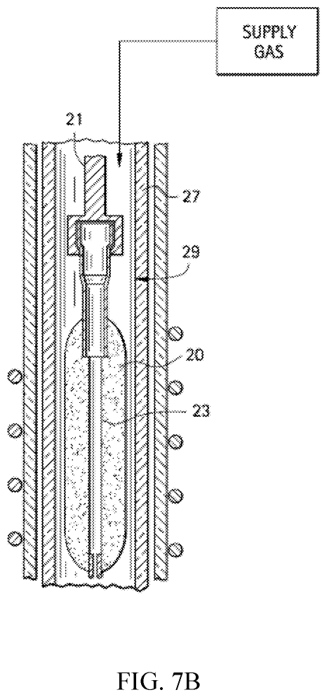

The preform core elements are made by forming the core region and dedicated cladding region(s) in one or more process steps. Typical process steps include soot deposition, doping, and consolidation. By way of illustration and not intended to be limiting, formation of a silica or doped silica in the form of a core soot body according to the OVD method is illustrated in FIGS. 7A and 7B. In FIG. 7A, core soot body 20 is formed by depositing silica-containing soot 22 onto the outer surface of a rotating and translating mandrel 24. Mandrel 24 is preferably tapered. The soot 22 for core soot body 20 is formed by providing a glass/soot precursor 28 in gaseous form to the flame 30 of a burner 26 to oxidize, hydrolyze, combust, or otherwise react or decompose it. Fuel 32, such as methane (CH₄), and a combustion supporting gas 34, such as oxygen, are provided to the burner 26 and ignited to form the flame 30. A dopant compound 36 is also optionally provided to the burner 26. Mass flow controllers, labelled V, meter the appropriate amounts of glass/soot precursor 28, fuel 32, combustion supporting gas 34, and dopant compound 36, all preferably in gaseous form, to the burner 26. The glass/soot precursor 28 is a glass former compound (e.g. silica precursor) and is oxidized in the flame 30 to form a generally cylindrical core soot region 23.

FIG. 7B illustrates another process for doping a preform core element soot body 20. Prior to consolidation, the bait rod 24 illustrated in FIG. 6A is removed to form a hollow, cylindrical preform core element soot body. During the doping and consolidation process, the preform core element soot body 20 is suspended, for example, inside a pure quartz muffle tube 27 of the furnace 29 by a holding mechanism 21. Prior to or during the consolidation step, the preform core element soot body 20 is optionally exposed to a doping precursor. The doping precursor is preferably provided in gas-phase form and is supplied directly to preform core element soot body 20 before or during consolidation. In one embodiment, the gas-phase doping precursor is a vapor formed by heating or evaporating a liquid precursor. The doping precursor is supplied neat (undiluted) or in combination with a diluent gas. The doping concentration can be controlled by controlling, without limitation, the temperature of doping, the temperature of vaporization of a liquid doping precursor, the pressure or partial pressure of a gas-phase doping precursor in the processing ambient of the core soot body, time of doping, number of doping cycles, and the porosity or surface area of the core soot body (high porosity and/or high surface area promote higher doping concentrations).

In one embodiment after doping, the preform core element soot body is consolidated to form densified glass with the composition and refractive index profile of the core region of the preform core element of a multicore optical fiber. Typical temperatures of consolidation are in the range from 1100° C. to 1600° C. The densified glass has a density of at least 1.90 g/cm³. After densification, the densified preform core glass is optionally redrawn to desired dimensions and is used as a substrate for depositing additional concentric soot layers having the composition and relative refractive index of one or more preform dedicated cladding regions. Alternatively, the additional concentric soot cladding layers can be deposited on the preform core element soot body before consolidation and the combination of layers can be consolidated to form a preform core element of the preform.

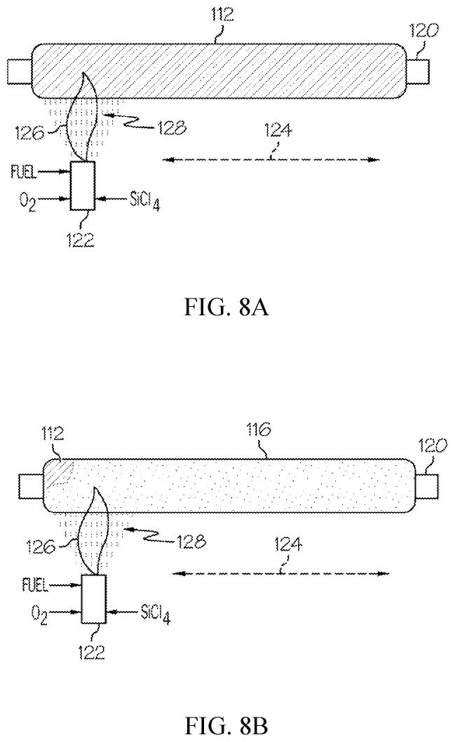

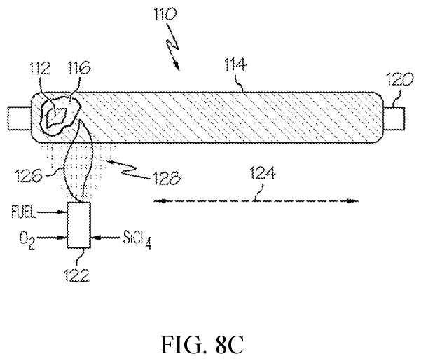

FIGS. 8A-8C illustrate fabrication of a soot body having three porous soot layers. It is recognized, however, that the procedure outlined is generally applicable to a soot bodies having any number of porous soot layers.

FIG. 8A illustrates deposition of a silica-based soot layer 112 on substrate 120. The silica-based glass soot is formed by providing a vapor phase silica-based glass precursor material, such as SiCl₄ or octamethylcyclotetrasiloxane (OMCTS), to a burner 122. The gas-fed burner 122 is supplied with fuel, such as H₂, CH₄, D₂ (deuterium), CD₄ or CO. Oxygen is also provided to burner 122 and the fuel and oxygen are combusted to create flame 126. In some embodiments, the vapor phase silica-based glass precursor material is SiCl₄ and the gas-fed burner 122 is supplied with a non-hydrogenated fuel such as D₂, CD₄ or CO in order to limit the amount of residual OH in the deposited silica-based glass soot. The vapor phase silica-based glass precursor material may be delivered to the burner at a flow rate from about 4 L/min to about 10 L/min, while the fuel may be supplied to the burner at a flow rate from about 10 L/min to about 40 L/min.

The vapor phase silica-based glass precursor material is reacted in the flame 126 to produce silica-based glass soot 128, which is deposited as soot layer 112 on substrate 120 as the bait rod is rotated. The rotation rate may be from about 20 rpm to about 400 rpm, or preferably from 30 rpm to about 100 rpm. Soot layer 112 may have the same, higher, or lower refractive index than undoped silica. Higher or lower refractive indices may be achieved by supplying an updopant or downdopant precursor to burner 122. Soot layer 112 may constitute a single-layer soot cladding monolith or may constitute the innermost (smallest radius) layer of a multilayer soot cladding monolith. The flame 126 of the gas-fed burner 122 is traversed back and forth along the axial length of the substrate 120 as indicated by arrow 124 as the bait rod is rotated thereby building up silica-based glass soot and forming soot layer 112 on the substrate 120.

FIG. 8B depicts deposition of soot layer 116 on soot layer 112. Soot layer 116 may be formed in a similar manner as soot layer 112. For example, a vapor phase silica-based glass precursor material, such as SiCl₄ or OMCTS, and index increasing dopant precursor material, such as GeCl₄ or TiCl₄ or POC₁₃, may be supplied to the gas-fed burner 122 and reacted in the flame 126 to form silica-based glass soot and doped glass soot which is deposited as soot layer 116 on soot layer 112 as the bait rod is rotated. Soot layer 116 may have the same, higher, or lower refractive index than soot layer 112.

FIG. 8C depicts deposition of soot layer 114 on soot layer 116. Soot layer 114 may be formed in a similar manner as soot layer 112 or soot layer 116. For example, a vapor phase silica-based glass precursor material, such as SiCl₄ or OMCTS, and index increasing dopant precursor material, such as GeCl₄ or TiCl₄ or POCl₃, may be supplied to the gas-fed burner 122 and reacted in the flame 126 to form silica-based glass soot and doped glass soot which is deposited as soot layer 114 on soot layer 116 as the substrate 120 is rotated. Soot layer 114 may have the same, higher, or lower refractive index than soot layer 116 or soot layer 112. Additional layers of may be deposited similarly to obtain a soot body having any desired number of layers. After deposition of the soot layers, the soot body is consolidated to form a core element of a preform.

Process conditions used to form the different layers of a multilayer soot body may be the same or different. Process variables include flame temperature, flow rates of precursors for silicon or dopants, traversal rate of the burner along the length of the substrate, and rotation rate of the substrate. The dopant concentration can be controlled by varying the flow rate of the dopant precursor, selection of dopant precursor, and temperature of doping. Dopant concentration distributions that are uniform or variable in the radial direction are achievable. To form a dedicated trench cladding region with a relative refractive index that decreases monotonically in the radial direction, the concentration of downdoping precursor (e.g. SiF₄) is progressively increased during deposition of the dedicated trench cladding layer during soot deposition as the concentric monolayers of trench cladding soot are formed. Alternatively, the dedicated trench cladding region can be formed by exposing a soot layer to a downdoping precursor (e.g., SiF₄) during a consolidation step. The downdoping precursor is introduced to the outer surface of the soot layer. The downdoping precursor diffuses and reacts with the soot layer to form downdoped soot. As consolidation occurs, the soot layer densifies and diffusion of the downdopant is inhibited. This is one strategy for forming trench cladding regions with a radially varying concentration of downdopant (e.g., a triangular dedicated trench cladding region). Further discussion of forming dedicated trench cladding regions with a monotonically decreasing relative refractive index is given in U.S. Pat. No. 9,975,802, U.S. Publication No. 20020073740, and Tandon, P., J. Non-Crystalline Solids 351, 1466 (2005), the disclosures of which are hereby incorporated by reference herein. Variations in process conditions can control the deposition rate of soot and density of soot in the as-deposited state. The flame temperature may be 1500° C. or higher. Higher flame temperatures promote higher as-deposited soot density. Conversely, lower flame temperatures lower as-deposited soot density.

In one embodiment, substrate 120 is a consolidated glass having the composition and refractive index of the core region of a core element of a multicore optical fiber to be drawn from the preform. In this embodiment, soot layer 112 corresponds to a dedicated offset cladding region of a preform core element or a dedicated trench cladding region of a preform core element. If the former, soot layer 116 corresponds to a dedicated trench cladding region of a preform core element and soot layer 114 is optional. In another embodiment, substrate 120 is a bait rod, soot layer 112 corresponds to the core region of a preform core element, and soot layers 116 and 114 correspond to two different portions of the dedicated cladding of the preform core element (a dedicated offset cladding region and a dedicated trench cladding region). The soot layers, when consolidated, provide a preform core element of a preform configured to permit drawing of multicore optical fibers having the relative refractive index profiles disclosed herein.

The common cladding of the preform is formed by soot deposition and consolidation as described above to form a large glass monolith. Once formed, the preform common cladding is processed to enable integration of preform core elements and final fusing to form the preform. Typically, the preform common cladding is processed by drilling holes sized to receive two or more preform core elements (in a consolidated state) at pre-determined locations (corresponding to scaled positions of the intended placement of core elements in multicore optical fibers drawn from the preform). The preform core elements are inserted into the holes of the preform common cladding and the assembly is consolidated to fuse the preform core elements to the preform common cladding to form the preform.

Optical Fiber Draw Process. In a continuous multicore optical fiber manufacturing process, a multicore glass fiber is drawn from a heated preform and sized to a target diameter (e.g., 125 μm, corresponding to an outer radius R₄=62.5 μm for the glass fiber). The multicore glass fiber is then cooled and directed to a coating system that applies a liquid primary coating composition to the multicore glass fiber. Two process options are viable after application of the liquid primary coating composition to the multicore glass fiber. In one process option (wet-on-dry process), the liquid primary coating composition is cured to form a solidified primary coating, the liquid secondary coating composition is applied to the cured primary coating, and the liquid secondary coating composition is cured to form a solidified secondary coating. In a second process option (wet-on-wet process), the liquid secondary coating composition is applied to the liquid primary coating composition, and both liquid coating compositions are cured simultaneously to provide solidified primary and secondary coatings. After the multicore optical fiber exits the coating system, the multicore optical fiber is collected and stored at room temperature. Collection of the multicore optical fiber typically entails winding the multicore optical fiber on a spool and storing the spool.

In some processes, the coating system further applies a tertiary coating composition to the secondary coating and cures the tertiary coating composition to form a solidified tertiary coating. Typically, the tertiary coating is an ink layer used to mark the multicore optical fiber for identification purposes and has a composition that includes a pigment and is otherwise similar to the secondary coating. The tertiary coating is applied to the secondary coating and cured. The secondary coating has typically been cured at the time of application of the tertiary coating. The primary, secondary, and tertiary coating compositions can be applied and cured in a common continuous manufacturing process. Alternatively, the primary and secondary coating compositions are applied and cured in a common continuous manufacturing process, the coated multicore optical fiber is collected, and the tertiary coating composition is applied and cured in a separate offline process to form the tertiary coating.

The wavelength of curing radiation is infrared, visible, or ultraviolet (UV). Representative wavelengths include wavelengths in the range from 250 nm to 1000 nm, or in the range from 250 nm to 700 nm, or in the range from 250 nm to 450 nm, or in the range from 275 nm to 425 nm, or in the range from 300 nm to 400 nm, or in the range from 320 nm to 390 nm, or in the range from 330 nm to 380 nm, or in the range from 340 nm to 370 nm. Curing can be accomplished with light sources that include a lamp source (e.g. Hg lamp), an LED source (e.g. a UVLED, visible LED, or infrared LED), or a laser source.

Each of the primary, secondary, and tertiary compositions are curable with any of the wavelengths and any of the light sources referred to above. The same wavelength or source can be used to cure each of the primary, secondary, and tertiary compositions, or different wavelengths and/or different sources can be used to cure the primary, secondary, and tertiary compositions. Curing of the primary, secondary, and tertiary compositions can be accomplished with a single wavelength or a combination of two or more wavelengths.

To improve process efficiency, it is desirable to increase the draw speed of the multicore fiber along the process pathway extending from the preform to the collection point. As the draw speed increases, however, the cure speed of coating compositions must increase. The coating compositions disclosed herein are compatible with multicore fiber draw processes that operate at a draw speed greater than or equal to 35 m/s, or greater than or equal to 40 m/s, or greater than or equal to 45 m/s, or greater than or equal to 50 m/s, or greater than or equal to 55 m/s, or greater than or equal to 60 m/s, or greater than or equal to 65 m/s, or greater than or equal to 70 m/s.

### EXAMPLES

Microbend Sensitivity. The transmission of optical signals in multicore optical fibers is sensitive to microbending. As noted above, microbending leads to losses in the intensity of the optical signal, which makes it more difficult to transmit optical signals over large distances in cables. It is accordingly desirable to minimize the sensitivity of multicore optical fibers to microbending. Microbending losses are characterized by a Microbending Sensitivity Parameter, which provides a measure of microbending loss for multicore optical fibers having different coating configurations relative to a reference configuration.

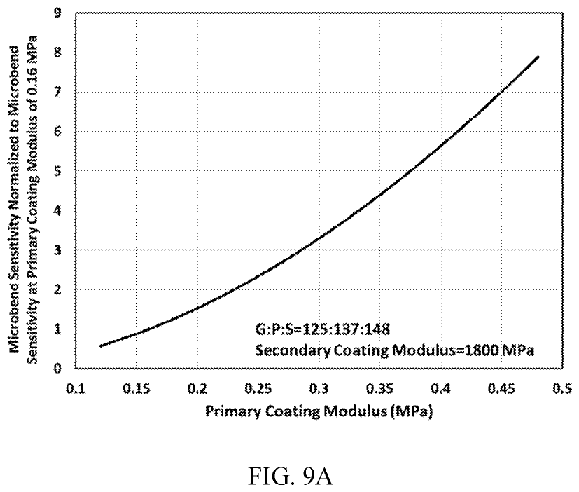

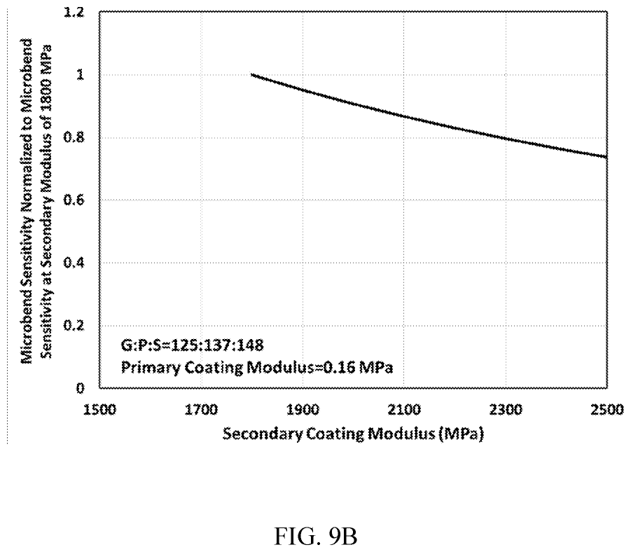

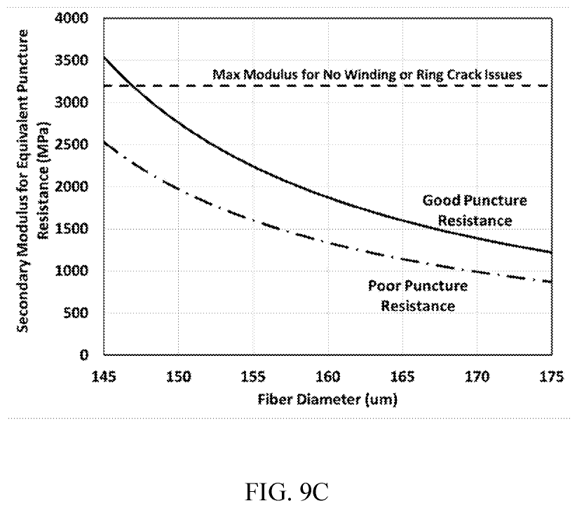

The microbend sensitivity parameter varies with the in situ modulus of the primary and secondary coatings of the optical fiber. To minimize losses due to microbending, it is desirable to configure the optical fiber to minimize the Microbending Sensitivity Parameter. FIG. 9A illustrates the variation in the Microbending Sensitivity Parameter with the in situ modulus of the primary coating for a representative multicore optical fiber that includes a silica multicore glass fiber with an outer radius R₄=62.5 μm, a primary coating outer radius R₅=68.5 μm, a secondary coating outer radius R₆=74 μm. For purposes of FIG. 9A, the in situ modulus of the secondary and tertiary coatings were configured to be 1800 MPa. FIG. 9A indicates that the Microbend Sensitivity Parameter decreases with decreasing in situ modulus of the primary coating.

FIG. 9B illustrates the variation in the Microbending Sensitivity Parameter with the in situ modulus of the secondary coating for a representative multicore optical fiber that includes a silica multicore glass fiber with an outer radius R₄=62.5 μm, an outer primary coating radius R₅=68.5 μm, an outer secondary coating radius R₆=74 μm. For purposes of FIG. 9B, the in situ modulus of the primary coating was configured to be 0.45 MPa and the in situ modulus of the tertiary coating was configured to be 1800 MPa. FIG. 9B indicates that the Microbend Sensitivity Parameter decreases with increasing in situ modulus of the secondary coating.

Further, as the thickness of the secondary coating decreases, the puncture resistance of the multicore optical fiber is negatively impacted. To compensate for the reduction in secondary coating cross-sectional area as the thickness of the secondary coating decreases and yet have good puncture resistance performance, a secondary coating with a higher in situ modulus is required. FIG. 9C shows the in situ modulus of the secondary coating that result in good puncture resistance performance for different diameters (2R₆) of the secondary coating. The data shown in FIG. 9C is for a multicore optical fiber with a glass fiber having a diameter of 125 μm, a primary coating having an in situ modulus of 0.16 MPa. and a 1:1 ratio of the thickness R₆−R₅ of secondary coating to thickness R₅−R₄ of primary coating.

Based on the results depicted in FIGS. 9A-9C, it is preferable to configure the multicore optical fiber to have a primary coating with a low in situ modulus and a secondary coating with a high in situ modulus. Embodiments for suitable in situ moduli of the primary and secondary coatings are disclosed above.

Multicore Optical Fibers-Step Index-Triangular Trench. The following six modelled examples Ex1-Ex6 illustrate core elements of 2×2 multicore optical fibers having a single common cladding region with a radius R₄=62.5 μm. Each of Ex1-Ex6 had a relative refractive index profile of the type shown in FIG. 6D. Table 1 lists selected parameters for Ex1-Ex6. The shape of the dedicated trench cladding region of each of Ex1-Ex6 was triangular with a relative refractive index that varied continuously with a monotonic decrease between the inner radius r₂ and the outer radius r₃ of the dedicated trench cladding region. Each of Ex1-Ex6 included a core region, a dedicated offset cladding region surrounding and directly adjacent to the core region, a dedicated trench cladding region surrounding and immediately adjacent to the dedicated offset cladding region, and a common cladding region surrounding and directly adjacent to the dedicated trench cladding region. The relative refractive index and outer radius of each region is listed in Table 1. The core regions of Ex1-Ex6 included a step-index relative refractive index profile (α=12). V₃ is the trench volume of the dedicated trench cladding region. MFD refers to mode field diameter of the core element. A_{eff} refers to effective area of the core element. 2 is the zero dispersion wavelength of the core element. MFD, A_{eff}, λ₀, dispersion and dispersion slope were determined assuming no interactions of the core element with other core elements. Each of Ex1-Ex6 included a primary coating with an in situ modulus of 0.16 MPa and a secondary coating with an in situ modulus of 1800 MPa. The ratio of the thickness R₆−R₅ of the secondary coating to the thickness R₅−R₄ of the primary coating was 0.8 for each of Ex1-Ex6. The outer radius R₆ of the secondary coating is listed in Table 1.

TABLE 1

| | Ex1 | Ex2 | Ex3 | Ex4 | Ex5 | Ex6 |
|---|---|---|---|---|---|---|
| Δ₁ₘₐₓ (%) | 0.38 | 0.40 | 0.42 | 0.44 | 0.46 | 0.50 |
| r₁ (μm) | 4.05 | 3.95 | 3.8 | 3.7 | 3.63 | 3.45 |
| α | 12 | 12 | 12 | 12 | 12 | 12 |
| Δ₂ (%) | 0 | 0 | 0 | 0 | 0 | 0 |
| r₂ (μm) | 7.0 | 7.0 | 7.0 | 7.0 | 7.0 | 7.0 |
| Δ_{3, min} (%) | −0.50 | −0.50 | −0.50 | −0.50 | −0.50 | −0.50 |
| r₃ (μm) | 14.5 | 14.5 | 14.5 | 14.5 | 14.5 | 14.5 |
| V₃ (% Δ-μm²) | 46 | 46 | 46 | 46 | 46 | 46 |
| Δ₄ (%) | 0 | 0 | 0 | 0 | 0 | 0 |
| R₄ (μm) | 62.5 | 62.5 | 62.5 | 62.5 | 62.5 | 62.5 |
| R₆ (μm) | 108 | 100 | 97 | 91 | 85 | 81 |
| MFD at 1310 nm (μm) | 8.4 | 8.2 | 8 | 7.85 | 7.7 | 7.3 |
| A_{eff} at 1550 nm (μm²) | 68.5 | 65.32 | 62.78 | 60.3 | 57.64 | 53.02 |
| Cable Cutoff (nm) | 1194 | 1191 | 1192 | 1191 | 1190 | 1162 |
| Dispersion at 1310 nm | −0.353 | −0.749 | −1.106 | −1.501 | −1.891 | −3.171 |
| (ps/nm/km) | | | | | | |
| Dispersion Slope at | 0.089 | 0.0885 | 0.0881 | 0.0876 | 0.0871 | 0.0853 |
| 1310 nm (ps/nm²/km) | | | | | | |
| λ₀ (nm) | 1322.0 | 1326.5 | 1330.6 | 1335.1 | 1339.7 | 1355.2 |

Multicore Optical Fibers—Step Index—Rectangular Trench. The following twelve modelled examples Ex7-Ex18 illustrate multicore optical fibers having a single common cladding region with a radius R₄=62.5 μm. Each of Ex7-Ex18 had a relative refractive index profile of the type shown in FIG. 6B. Tables 2 and 3 list selected parameters for Ex7-Ex18. The shape of the dedicated trench cladding region of each of Ex7-Ex18 was rectangular with a relative refractive index that was constant between the inner radius r₂ and the outer radius r₃ of the dedicated trench cladding region. Each of Ex7-Ex18 included a core region, a dedicated offset cladding region surrounding and directly adjacent to the core region, a dedicated trench cladding region surrounding and immediately adjacent to the offset cladding region, and a common cladding region surrounding and directly adjacent to the dedicated trench cladding region. The relative refractive index and outer radius of each region is listed in Tables 2 and 3. The core regions of Ex7-Ex18 included a step-index relative refractive index profile (α=12). V₃ is the trench volume of the dedicated trench cladding region. MFD refers to mode field diameter of the core element. A_{eff} refers to effective area of the core element. λ₀ is the zero dispersion wavelength of the core element. MFD, A_{eff}, λ₀, dispersion and dispersion slope were determined assuming no interactions of the core element with other core elements. Each of Ex7-Ex18 included a primary coating with an in situ modulus of 0.16 MPa and a secondary coating with an in situ modulus of 1800 MPa. The ratio of the thickness R₆−R₅ of the secondary coating to the thickness R₅−R₄ of the primary coating was 0.8 for each of Ex7-Ex18. The outer radius R₆ of the secondary coating is listed in Tables 2 and 3.

TABLE 2

| | Ex7 | Ex8 | Ex9 | Ex10 | Ex11 | Ex12 |
|---|---|---|---|---|---|---|
| Δ₁ₘₐₓ (%) | 0.38 | 0.40 | 0.42 | 0.44 | 0.46 | 0.50 |
| r₁ (μm) | 4.05 | 3.95 | 3.8 | 3.7 | 3.63 | 3.45 |
| α | 12 | 12 | 12 | 12 | 12 | 12 |
| Δ₂ (%) | 0 | 0 | 0 | 0 | 0 | 0 |
| r₂ ((μm) | 10 | 10 | 10 | 10 | 10 | 10 |
| Δ_{3, min} (%) | −0.32 | −0.32 | −0.32 | −0.32 | −0.32 | −0.32 |
| r₃ (μm) | 16 | 16 | 16 | 16 | 16 | 16 |
| V₃ (% Δ-μm²) | 50 | 50 | 50 | 50 | 50 | 50 |
| Δ₄ (%) | 0 | 0 | 0 | 0 | 0 | 0 |
| R₄ (μm) | 62.5 | 62.5 | 62.5 | 62.5 | 62.5 | 62.5 |
| R₆ (μm) | 108 | 100 | 97 | 91 | 85 | 81 |
| MFD at 1310 nm (μm) | 8.46 | 8.26 | 8.03 | 7.85 | 7.68 | 7.36 |
| A_{eff} at 1550 nm (μm²) | 70.25 | 67.03 | 63.74 | 60.97 | 58.52 | 53.92 |
| Cable Cutoff (nm) | 1213 | 1214 | 1199 | 1194 | 1197 | 1187 |
| Dispersion at 1310 nm | −0.82 | −1.158 | −1.772 | −2.188 | −2.46 | −3.34 |
| (ps/nm/km) | | | | | | |
| Dispersion Slope at 1310 | 0.0879 | 0.0873 | 0.0865 | 0.0857 | 0.0851 | 0.0837 |
| nm (ps/nm²/km) | | | | | | |
| λ₀ (nm) | 1327.3 | 1331.3 | 1338.5 | 1343.5 | 1346.9 | 1357.9 |

TABLE 3

| | Ex13 | Ex14 | Ex15 | Ex16 | Ex17 | Ex18 |
|---|---|---|---|---|---|---|
| Δ₁ₘₐₓ (%) | 0.38 | 0.40 | 0.42 | 0.44 | 0.46 | 0.50 |
| r₁ (μm) | 4.1 | 4.0 | 3.85 | 3.75 | 3.7 | 3.5 |
| α | 12 | 12 | 12 | 12 | 12 | 12 |
| Δ₂ (%) | 0 | 0 | 0 | 0 | 0 | 0 |
| r₂ (μm) | 10 | 10 | 10 | 10 | 10 | 10 |
| Δ_{3, min} (%) | −0.24 | −0.24 | −0.24 | −0.24 | −0.24 | −0.24 |
| r₃ (μm) | 16 | 16 | 16 | 16 | 16 | 16 |
| V₃ (% Δ-μm²) | 37 | 37 | 37 | 37 | 37 | 37 |
| Δ₄ (%) | 0 | 0 | 0 | 0 | 0 | 0 |
| R₄ (μm) | 62.5 | 62.5 | 62.5 | 62.5 | 62.5 | 62.5 |
| R₆ (μm) | 108 | 100 | 97 | 91 | 85 | 81 |
| MFD at 1310 nm (μm) | 8.5 | 8.29 | 8.06 | 7.87 | 7.73 | 7.39 |
| A_{eff} at 1550 nm (μm²) | 70.87 | 67.58 | 64.23 | 61.4 | 59.3 | 54.25 |
| Cable Cutoff (nm) | 1192 | 1194 | 1177 | 1174 | 1184 | 1167 |
| Dispersion at 1310 nm | −0.72 | −1.026 | −1.06 | −1.987 | −2.41 | −3.05 |
| (ps/nm/km) | | | | | | |
| Dispersion Slope at 1310 | 0.0875 | 0.0869 | 0.0861 | 0.0854 | 0.0854 | 0.0835 |
| nm (ps/nm²/km) | | | | | | |
| λ₀ (nm) | 1326.2 | 1329.8 | 1330.3 | 1341.3 | 1346.2 | 1354.5 |

### Multicore Optical Fibers—Crosstalk.

Co-propagating and counterpropagating crosstalk was computed for multicore optical fibers including the core elements of Ex1-Ex18. Each multicore optical fiber was homogeneous and included four identical core elements arranged in a 2×2 square configuration as shown in FIG. 4B. Each multicore optical fiber included four instances of a different one of the core elements of Ex1-Ex18. The core element spacing between each of the four pairs of adjacent core elements in each multicore optical fiber was the same. Core element spacing for purposes of these examples corresponds to the side length of the square formed by the centers of the four core elements. All four side lengths were equal, which means that the core element spacing was uniform for each multicore optical fiber considered. For multicore optical fibers based on each core element, co-propagating and counterpropagating crosstalk was determined for several embodiments differing in core element spacing. In all embodiments, core element spacing was uniform. The value of the uniform core element spacing, however, was varied to illustrate the effect of core element spacing on co-propagating and counterpropagating crosstalk at the wavelengths 1310 nm and 1550 nm.

The results are summarized in Tables 4-21, where each of Tables 4-21 corresponds to a homogeneous 2×2 multicore optical fiber based on a different one of core elements Ex1-Ex18. The co-propagating and counterpropagating crosstalk reported in Tables 4-21 are the values for each pair of adjacent core elements in each of the multicore optical fiber. Because of the uniformity of core element spacing, co-propagating and counterpropagating crosstalk was the same for each pair of adjacent core elements in each of the multicore optical fibers. The co-propagating and counterpropagating crosstalk values reported for each pair of core elements considered in Tables 4-21 is expected to be the same in other multicore optical fibers that include the pair of core elements, even if such other multicore optical fibers differ in number or configuration of core elements from a 2×2 configuration.

TABLE 4
2 × 2 Multicore Optical Fiber - Ex1 as Core Element

| Core | | | | |
|---|---|---|---|---|
| element | Co-Propagating | Co-propagating | Counterpropagating | Counterpropagating |
| spacing | Crosstalk | Crosstalk | Crosstalk | Crosstalk |
| (μm) | 1310 nm (dB/km) | 1550 nm (dB/km) | 1310 nm (dB/km) | 1550 nm (dB/km) |
| 26 | −36.2 | −15.22 | −59.33 | −32.23 |
| 28 | −44.66 | −21.77 | −67.88 | −42.63 |
| 30 | −53.06 | −28.28 | −76.29 | −50.79 |
| 32 | −61.43 | −34.77 | −84.66 | −57.75 |
| 34 | −69.77 | −41.21 | −93 | −64.3 |
| 36 | −78.08 | −47.63 | −101.31 | −70.55 |
| 38 | −86.37 | −54.03 | −109.6 | −77.15 |
| 40 | −94.63 | −60.4 | −117.86 | −83.53 |

TABLE 5
2 × 2 Multicore Optical Fiber - Ex2 as Core Element

| Core | | | | |
|---|---|---|---|---|
| element | Co-Propagating | Co-propagating | Counterpropagating | Counterpropagating |
| spacing | Crosstalk | Crosstalk | Crosstalk | Crosstalk |
| (μm) | 1310 nm (dB/km) | 1550 nm (dB/km) | 1310 nm (dB/km) | 1550 nm (dB/km) |
| 26 | −37.89 | −16.36 | −61.05 | −34.2 |
| 28 | −46.59 | −23.02 | −69.81 | −44.35 |
| 30 | −55.15 | −29.64 | −78.38 | −52.31 |
| 32 | −63.68 | −36.23 | −86.91 | −59.25 |
| 34 | −72.17 | −42.78 | −95.4 | −65.88 |
| 36 | −80.64 | −49.31 | −103.87 | −72.43 |
| 38 | −89.08 | −55.82 | −112.31 | −78.94 |
| 40 | −97.5 | −62.3 | −120.73 | −85.43 |

TABLE 6
2 × 2 Multicore Optical Fiber - Ex3 as Core Element

| Core | | | | |
|---|---|---|---|---|
| element | Co-Propagating | Co-propagating | Counterpropagating | Counterpropagating |
| spacing | Crosstalk | Crosstalk | Crosstalk | Crosstalk |
| (μm) | 1310 nm (dB/km) | 1550 nm (dB/km) | 1310 nm (dB/km) | 1550 nm (dB/km) |
| 26 | −36.67 | −17.41 | −59.8 | −35.96 |
| 28 | −48.4 | −24.16 | −71.62 | −45.84 |
| 30 | −57.1 | −30.87 | −80.33 | −53.64 |
| 32 | −65.76 | −37.54 | −88.99 | −60.59 |
| 34 | −74.39 | −44.18 | −97.92 | −67.29 |
| 36 | −82.99 | −50.8 | −106.22 | −73.92 |
| 38 | −91.57 | −57.39 | −114.81 | −80.51 |
| 40 | −100.13 | −63.96 | −123.36 | −87.09 |

TABLE 7
2 × 2 Multicore Optical Fiber - Ex4 as Core Element

| Core | | | | |
|---|---|---|---|---|
| element | Co-Propagating | Co-propagating | Counterpropagating | Counterpropagating |
| spacing | Crosstalk | Crosstalk | Crosstalk | Crosstalk |
| (μm) | 1310 nm (dB/km) | 1550 nm (dB/km) | 1310 nm (dB/km) | 1550 nm (dB/km) |
| 26 | −41.42 | −18.6 | −64.65 | −37.89 |
| 28 | −50.34 | −25.48 | −73.57 | −47.5 |
| 30 | −59.21 | −32.32 | −82.44 | −55.19 |
| 32 | −68.05 | −39.12 | −91.28 | −62.19 |
| 34 | −76.86 | −45.9 | −100.09 | −69.01 |
| 36 | −85.64 | −52.64 | −108.87 | −75.68 |
| 38 | −94.4 | −59.37 | −117.63 | −82.49 |
| 40 | −103.13 | −66.07 | −126.36 | −89.2 |

TABLE 8
2 × 2 Multicore Optical Fiber - Ex5 as Core Element

| Core | | | | |
|---|---|---|---|---|
| element | Co-Propagating | Co-propagating | Counterpropagating | Counterpropagating |
| spacing | Crosstalk | Crosstalk | Crosstalk | Crosstalk |
| (μm) | 1310 nm (dB/km) | 1550 nm (dB/km) | 1310 nm (dB/km) | 1550 nm (dB/km) |
| 26 | −43.25 | −19.89 | −66.48 | −39.89 |
| 28 | −52.37 | −26.93 | −75.6 | −49.13 |
| 30 | −61.45 | −33.93 | −84.68 | −56.88 |
| 32 | −70.49 | −40.89 | −93.72 | −63.98 |
| 34 | −79.51 | −47.83 | −102.74 | −70.95 |
| 36 | −88.49 | −54.73 | −111.72 | −77.85 |
| 38 | −97.46 | −61.61 | −120.69 | −84.74 |
| 40 | −106.39 | −68.47 | −129.62 | −91.6 |

TABLE 9
2 × 2 Multicore Optical Fiber - Ex6 as Core Element

| Core | | | | |
|---|---|---|---|---|
| element | Co-Propagating | Co-propagating | Counterpropagating | Counterpropagating |
| spacing | Crosstalk | Crosstalk | Crosstalk | Crosstalk |
| (μm) | 1310 nm (dB/km) | 1550 nm (dB/km) | 1310 nm (dB/km) | 1550 nm (dB/km) |
| 26 | −46.58 | −22.12 | −69.81 | −43.12 |
| 28 | −56.02 | −29.4 | −79.25 | −52.4 |
| 30 | −65.43 | −36.63 | −88.66 | −59.66 |
| 32 | −74.8 | −43.83 | −98.03 | −66.94 |
| 34 | −84.14 | −51 | −107.37 | −74.12 |
| 36 | −93.44 | −58.14 | −116.67 | −81.26 |
| 38 | −102.73 | −62.25 | −125.96 | −85.37 |
| 40 | −111.99 | −72.34 | −135.22 | −95.46 |

TABLE 10
2 × 2 Multicore Optical Fiber - Ex7 as Core Element

| Core | | | | |
|---|---|---|---|---|
| element | Co-Propagating | Co-propagating | Counterpropagating | Counterpropagating |
| spacing | Crosstalk | Crosstalk | Crosstalk | Crosstalk |
| (μm) | 1310 nm (dB/km) | 1550 nm (dB/km) | 1310 nm (dB/km) | 1550 nm (dB/km) |
| 26 | −38.29 | −16.99 | −61.29 | −33.91 |
| 28 | −46.68 | −23.49 | −69.91 | −44.97 |
| 30 | −55.03 | −29.95 | −78.26 | −52.65 |
| 32 | −63.35 | −36.67 | −86.58 | −59.39 |
| 34 | −71.63 | −42.76 | −94.86 | −65.56 |
| 36 | −79.89 | −49.13 | −103.12 | −72.26 |
| 38 | −88.62 | −55.47 | −111.85 | −78.59 |
| 40 | −96.33 | −61.8 | −119.56 | −84.92 |

TABLE 11
2 × 2 Multicore Optical Fiber - Ex8 as Core Element

| Core | | | | |
|---|---|---|---|---|
| element | Co-Propagating | Co-propagating | Counterpropagating | Counterpropagating |
| spacing | Crosstalk | Crosstalk | Crosstalk | Crosstalk |
| (μm) | 1310 nm (dB/km) | 1550 nm (dB/km) | 1310 nm (dB/km) | 1550 nm (dB/km) |
| 26 | −40.15 | −18.27 | −63.15 | −37.36 |
| 28 | −48.74 | −24.93 | −71.97 | −46.82 |
| 30 | −57.3 | −31.55 | −80.53 | −54.37 |
| 32 | −65.83 | −38.13 | −89.06 | −61.19 |
| 34 | −74.32 | −44.68 | −97.55 | −67.79 |
| 36 | −82.79 | −51.21 | −106.02 | −74.33 |
| 38 | −91.23 | −57.71 | −114.46 | −80.83 |
| 40 | −99.65 | −64.19 | −122.88 | −87.31 |

TABLE 12
2 × 2 Multicore Optical Fiber - Ex9 as Core Element

| Core | | | | |
|---|---|---|---|---|
| element | Co-Propagating | Co-propagating | Counterpropagating | Counterpropagating |
| spacing | Crosstalk | Crosstalk | Crosstalk | Crosstalk |
| (μm) | 1310 nm (dB/km) | 1550 nm (dB/km) | 1310 nm (dB/km) | 1550 nm (dB/km) |
| 26 | −41.81 | −19.31 | −64.81 | −39 |
| 28 | −50.54 | −26.05 | −73.77 | −48.19 |
| 30 | −59.24 | −32.76 | −82.47 | −55.66 |
| 32 | −67.9 | −39.43 | −91.13 | −62.5 |
| 34 | −76.52 | −46.07 | −99.75 | −69.18 |
| 36 | −85.13 | −52.69 | −108.36 | −75.81 |
| 38 | −93.7 | −59.28 | −116.93 | −82.4 |
| 40 | −102.26 | −65.84 | −125.49 | −88.96 |

TABLE 13
2 × 2 Multicore Optical Fiber - Ex10 as Core Element

| Core | | | | |
|---|---|---|---|---|
| element | Co-Propagating | Co-propagating | Counterpropagating | Counterpropagating |
| spacing | Crosstalk | Crosstalk | Crosstalk | Crosstalk |
| (μm) | 1310 nm (dB/km) | 1550 nm (dB/km) | 1310 nm (dB/km) | 1550 nm (dB/km) |
| 26 | −43.54 | −20.48 | −66.77 | −40.77 |
| 28 | −52.46 | −27.56 | −75.69 | −49.73 |
| 30 | −61.33 | −34.19 | −84.56 | −57.15 |
| 32 | −70.17 | −41 | −93.4 | −64.09 |
| 34 | −78.97 | −47.77 | −102.2 | −70.89 |
| 36 | −87.75 | −54.52 | −110.98 | −77.64 |
| 38 | −96.51 | −61.24 | −119.74 | −84.36 |
| 40 | −105.24 | −67.93 | −128.47 | −91.05 |

TABLE 14
2 × 2 Multicore Optical Fiber - Ex11 as Core Element

| Core | | | | |
|---|---|---|---|---|
| element | Co-Propagating | Co-propagating | Counterpropagating | Counterpropagating |
| spacing | Crosstalk | Crosstalk | Crosstalk | Crosstalk |
| (μm) | 1310 nm (dB/km) | 1550 nm (dB/km) | 1310 nm (dB/km) | 1550 nm (dB/km) |
| 26 | −45.34 | −21.75 | −68.57 | −42.6 |
| 28 | −54.46 | −28.79 | −77.69 | −51.36 |
| 30 | −63.54 | −35.79 | −86.77 | −58.8 |
| 32 | −72.59 | −42.75 | −95.82 | −65.85 |
| 34 | −81.6 | −49.68 | −104.83 | −72.8 |
| 36 | −90.58 | −56.59 | −113.81 | −79.71 |
| 38 | −99.58 | −63.46 | −122.81 | −86.58 |
| 40 | −108.48 | −70.32 | −131.71 | −93.44 |

TABLE 15
2 × 2 Multicore Optical Fiber - Ex12 as Core Element

| Core | | | | |
|---|---|---|---|---|
| element | Co-Propagating | Co-propagating | Counterpropagating | Counterpropagating |
| spacing | Crosstalk | Crosstalk | Crosstalk | Crosstalk |
| (μm) | 1310 nm (dB/km) | 1550 nm (dB/km) | 1310 nm (dB/km) | 1550 nm (dB/km) |
| 26 | −48.64 | −23.96 | −71.87 | −45.58 |
| 28 | −58.08 | −31.23 | −81.31 | −54.03 |
| 30 | −67.49 | −38.46 | −90.72 | −61.52 |
| 32 | −76.85 | −45.66 | −100.08 | −68.77 |
| 34 | −86.19 | −52.82 | −109.42 | −75.94 |
| 36 | −95.5 | −59.96 | −118.73 | −83.08 |
| 38 | −104.78 | −67.07 | −128.01 | −90.19 |
| 40 | −114.04 | −74.07 | −137.27 | −97.19 |

TABLE 16
2 × 2 Multicore Optical Fiber - Ex13 as Core Element

| Core | | | | |
|---|---|---|---|---|
| element | Co-Propagating | Co-propagating | Counterpropagating | Counterpropagating |
| spacing | Crosstalk | Crosstalk | Crosstalk | Crosstalk |
| (μm) | 1310 nm (dB/km) | 1550 nm (dB/km) | 1310 nm (dB/km) | 1550 nm (dB/km) |
| 26 | −32.43 | −11.87 | −54.53 | −26.14 |
| 28 | −40.88 | −18.43 | −63.88 | −37.62 |
| 30 | −49.29 | −24.94 | −72.52 | −46.83 |
| 32 | −57.66 | −31.43 | −80.89 | −54.25 |
| 34 | −66.01 | −37.88 | −89.24 | −60.93 |
| 36 | −74.32 | −44.3 | −97.55 | −67.41 |
| 38 | −82.61 | −50.7 | −105.84 | −73.82 |
| 40 | −90.88 | −57.08 | −114.11 | −80.2 |

TABLE 17
2 × 2 Multicore Optical Fiber - Ex14 as Core Element

| Core | | | | |
|---|---|---|---|---|
| element | Co-Propagating | Co-propagating | Counterpropagating | Counterpropagating |
| spacing | Crosstalk | Crosstalk | Crosstalk | Crosstalk |
| (μm) | 1310 nm (dB/km) | 1550 nm (dB/km) | 1310 nm (dB/km) | 1550 nm (dB/km) |
| 26 | −34.38 | −13.23 | −56.58 | 28.66 |
| 28 | −43.04 | −29.95 | −66.04 | −39.98 |
| 30 | −51.66 | −26.63 | −74.89 | −48.88 |
| 32 | −60.24 | −33.27 | −83.47 | −56.19 |
| 34 | −68.79 | −39.89 | −92.02 | −62.97 |
| 36 | −77.32 | −46.47 | −100.55 | −69.59 |
| 38 | −85.82 | −53.03 | −109.05 | −76.15 |
| 40 | −94.3 | −59.57 | −117.53 | −82.69 |

TABLE 18
2 × 2 Multicore Optical Fiber - Ex15 as Core Element

| Core | | | | |
|---|---|---|---|---|
| element | Co-Propagating | Co-propagating | Counterpropagating | Counterpropagating |
| spacing | Crosstalk | Crosstalk | Crosstalk | Crosstalk |
| (μm) | 1310 nm (dB/km) | 1550 nm (dB/km) | 1310 nm (dB/km) | 1550 nm (dB/km) |
| 26 | −36.12 | −14.33 | −58.32 | −38.65 |
| 28 | −44.92 | −21.15 | −67.92 | −41.75 |
| 30 | −53.68 | −27.52 | −76.91 | −50.38 |
| 32 | −62.41 | −34.65 | −85.64 | −57.93 |
| 34 | −71.1 | −41.36 | −94.33 | −64.45 |
| 36 | −79.76 | 48.04 | −102.99 | −71.16 |
| 38 | −88.4 | −54.69 | −111.63 | −77.81 |
| 40 | −97.02 | −61.32 | −120.25 | −84.44 |

TABLE 19
2 × 2 Multicore Optical Fiber - Ex16 as Core Element

| Core | | | | |
|---|---|---|---|---|
| element | Co-Propagating | Co-propagating | Counterpropagating | Counterpropagating |
| spacing | Crosstalk | Crosstalk | Crosstalk | Crosstalk |
| (μm) | 1310 nm (dB/km) | 1550 nm (dB/km) | 1310 nm (dB/km) | 1550 nm (dB/km) |
| 26 | −37.94 | −15.58 | −60.14 | 32.86 |
| 28 | −46.93 | −22.53 | −69.93 | −43.69 |
| 30 | −55.87 | −29.43 | −79.17 | −52.07 |
| 32 | −64.77 | −36.3 | −88.07 | 59.32 |
| 34 | −73.65 | −43.14 | −96.95 | −66.24 |
| 36 | −82.5 | −49.96 | −105.8 | −73.08 |
| 38 | −91.32 | −56.74 | −114.62 | −79.86 |
| 40 | −100.12 | −63.51 | −123.42 | −86.63 |

TABLE 20
2 × 2 Multicore Optical Fiber - Ex17 as Core Element

| Core | | | | |
|---|---|---|---|---|
| element | Co-Propagating | Co-propagating | Counterpropagating | Counterpropagating |
| spacing | Crosstalk | Crosstalk | Crosstalk | Crosstalk |
| (μm) | 1310 nm (dB/km) | 1550 nm (dB/km) | 1310 nm (dB/km) | 1550 nm (dB/km) |
| 26 | −39.91 | −17.03 | −62.11 | 35.33 |
| 28 | −49.13 | −24.17 | −72.36 | −45.85 |
| 30 | −58.3 | −31.26 | −81.53 | −54.06 |
| 32 | −67.44 | −38.32 | −90.67 | −61.38 |
| 34 | −76.55 | −45.35 | −99.78 | −68.46 |
| 36 | −85.63 | −52.35 | −108.86 | −75.47 |
| 38 | −94.68 | −59.32 | −117.91 | −82.44 |
| 40 | −103.72 | −66.27 | −126.95 | −89.39 |

TABLE 21
2 × 2 Multicore Optical Fiber - Ex18 as Core Element

| Core | | | | |
|---|---|---|---|---|
| element | Co-Propagating | Co-propagating | Counterpropagating | Counterpropagating |
| spacing | Crosstalk | Crosstalk | Crosstalk | Crosstalk |
| (μm) | 1310 nm (dB/km) | 1550 nm (dB/km) | 1310 nm (dB/km) | 1550 nm (dB/km) |
| 26 | −43.29 | −19.27 | −65.49 | −38.94 |
| 28 | −52.82 | −26.63 | −76.05 | −48.88 |
| 30 | −62.3 | −33.93 | −85.53 | −56.88 |
| 32 | −71.74 | −41.21 | −94.97 | −64.3 |
| 34 | −81.51 | −48.45 | −104.74 | −71.57 |
| 36 | −90.53 | −55.67 | −113.76 | −78.79 |
| 38 | −99.89 | −62.86 | −123.12 | −85.98 |
| 40 | −109.23 | −70.02 | −132.46 | −93.14 |

Based on the above examples, the following parameters are preferred or manifest:

The mode field diameter at 1310 nm of each core element of the multicore optical fibers disclosed herein is in the range from 7.3 μm to 8.2 μm, or in the range from 7.4 μm to 8.1 μm, or in the range from 7.5 μm to 8.0 μm.

The effective area A_{eff} at 1550 nm of each core element of multicore optical fibers disclosed herein is in the range from 40 μm² to 85 μm², or in the range from 45 μm² to 80 μm², or in the range from 50 μm² to 75 μm², or in the range from 52.5 μm² to 72.5 μm², or in the range from 55 μm² to 70 μm².

The zero dispersion wavelength λ₀ of each core element of multicore optical fibers disclosed herein is in the range from 1280 nm to 1370 nm, or in the range from 1290 nm to 1360 nm, or in the range from 1300 nm to 1350 nm, or in the range from 1310 nm to 1345 nm.

The dispersion at 1310 nm of each core element of multicore optical fibers disclosed herein is in the range from −3.5 ps/nm/km to 0.0 ps/nm/km, or in the range from −3.3 ps/nm/km to −0.3 ps/nm/km, or in the range from −3.0 ps/nm/km to −0.5 ps/nm/km, or in the range from −2.7 ps/nm/km to −0.7 ps/nm/km, or in the range from −2.5 ps/nm/km to −1.0 ps/nm/km, or in the range from −2.3 ps/nm/km to −1.2 ps/nm/km, or in the range from −2.0 ps/nm/km to −1.5 ps/nm/km.

The dispersion slope at 1310 nm of each core element of multicore optical fibers disclosed herein is in the range from in the range from 0.075 ps/nm²/km to 0.099 ps/nm²/km, or in the range from 0.077 ps/nm²/km to 0.097 ps/nm²/km, or in the range from 0.080 ps/nm²/km to 0.095 ps/nm²/km, or in the range from 0.082 ps/nm²/km to 0.092 ps/nm²/km.

The cable cutoff wavelength of each core element of the multicore optical fibers disclosed herein is less than or equal to 1260 nm, or less than or equal to 1240 nm, or less than or equal to 1220 nm, or less than or equal to 1200 nm, or less than or equal to 1180 nm, or less than or equal to 1160 nm, or less than or equal to 1140 nm, or less than or equal to 1120 nm, or in the range from 1100 nm to 1260 nm, or in the range from 1120 nm to 1250 nm, or in the range from 1140 nm to 1240 nm, or in the range from 1160 nm to 1230 nm, or in the range from 1180 nm to 1220 nm, or greater than or equal to 1125 nm and less than or equal to 1260 nm.

Macrobend loss is calculated at 1550 nm for mandrel diameters of 15 mm, 20 mm, and 30 mm. The conditions used in the computation of macrobend loss were in accordance with the mandrel wrap test specified in standard TIA-455-62: FOTP-62 IEC-60793-1-47 Optical Fibres-Part 1-47: Measurement Methods and Test Procedures-Macrobending Loss, by Telecommunications Industry Association (TIA). In the mandrel wrap test, the fiber is wrapped one or more times around a smooth cylindrical mandrel having a specified diameter, and the increase in attenuation at a specified wavelength due to the bending is determined. Macrobend loss is expressed in units of dB/turn, where dB refers to decibels and one turn refers to one revolution of the fiber about the mandrel.

The macrobend loss at 1550 nm of each core element of the multicore optical fibers disclosed herein, in accordance with the mandrel wrap test using a mandrel with a diameter of 30 mm, is less than or equal to 0.0040 dB/turn, or less than or equal to 0.0035 dB/turn, or less than or equal to 0.0030 dB/turn, or less than or equal to 0.0025 dB/turn, or less than or equal to 0.0020 dB/turn, or in the range from 0.0015 dB/turn to 0.0040 dB/turn, or in the range from 0.0020 dB/turn to 0.0035 dB/turn.

The macrobend loss at 1550 nm of each core element of the multicore optical fibers disclosed herein, in accordance with the mandrel wrap test using a mandrel with a diameter of 20 mm, is less than or equal to 0.20 dB/turn, or less than or equal to 0.15 dB/turn, or less than or equal to 0.12 dB/turn, or less than or equal to 0.10 dB/turn, or less than or equal to 0.08 dB/turn, or less than or equal to 0.05 dB/turn, or in the range from 0.05 dB/turn to 0.20 dB/turn, or in the range from 0.05 dB/turn to 0.15 dB/turn, or in the range from 0.07 dB/turn to 0.13 dB/turn.

The macrobend loss at 1550 nm of each core element of the multicore optical fibers disclosed herein, in accordance with the mandrel wrap test using a mandrel with a diameter of 15 mm, is less than or equal to 0.70 dB/turn, or less than or equal to 0.60 dB/turn, or less than or equal to 0.50 dB/turn, or less than or equal to 0.40 dB/turn, or less than or equal to 0.30 dB/turn, or in the range from 0.20 dB/turn to 0.70 dB/turn, or in the range from 0.30 dB/turn to 0.60 dB/turn, or in the range from 0.35 dB/turn to 0.55 dB/turn.

The core element spacing of the multicore optical fibers disclosed herein is less than or equal to 40 μm, or less than or equal to 38 μm, or less than or equal to 36 μm, or less than or equal to 34 μm, or less than or equal to 32 μm, or less than or equal to 30 μm, or less than or equal to 28 μm.

The co-propagating crosstalk between each pair of adjacent core elements of the multicore optical fibers disclosed herein is less than or equal to −35 dB/km, or less than or equal to −40 dB/km, or less than or equal to −45 dB/km, or less than or equal to −50 dB/km, or less than or equal to −55 dB/km, or less than or equal to −60 dB/km, or less than or equal to −65 dB/km, or less than or equal to −70 dB/km, or less than or equal to −75 dB/km, or less than or equal to −80 dB/km, or less than or equal to −85 dB/km, or less than or equal to −90 dB/km, or less than or equal to −100 dB/km, or less than or equal to −110 dB/km, or in a range from −35 dB/km to −130 dB/km, or in a range from −40 dB/km to −125 dB/km, or in a range from −45 dB/km to −120 dB/km, or in a range from −50 dB/km to −115 dB/km, or in a range from −60 dB/km to −110 dB/km, or in a range from −65 dB/km to −105 dB/km at a wavelength of 1310 nm for a core element spacing less than or equal to 40 μm.

The co-propagating crosstalk between each pair of adjacent core elements of the multicore optical fibers disclosed herein is less than or equal to −30 dB/km, or less than or equal to −35 dB/km, or less than or equal to −40 dB/km, or less than or equal to −45 dB/km, or less than or equal to −50 dB/km, or less than or equal to −55 dB/km, or less than or equal to −60 dB/km, or less than or equal to −65 dB/km, or less than or equal to −70 dB/km, or less than or equal to −75 dB/km, or less than or equal to −80 dB/km, or less than or equal to −85 dB/km, or less than or equal to −90 dB/km, or less than or equal to −100 dB/km, or in a range from −30 dB/km to −110 dB/km, or in a range from −40 dB/km to −100 dB/km, or in a range from −45 dB/km to −95 dB/km, or in a range from −50 dB/km to −90 dB/km, or in a range from −55 dB/km to −85 dB/km at a wavelength of 1310 nm for a core element spacing less than or equal to 34 μm.

The co-propagating crosstalk between each pair of adjacent core elements of the multicore optical fibers disclosed herein is less than or equal to −25 dB/km, or less than or equal to −30 dB/km, or less than or equal to −35 dB/km, or less than or equal to −40 dB/km, or less than or equal to −45 dB/km, or less than or equal to −50 dB/km, or less than or equal to −55 dB/km, or less than or equal to −60 dB/km, or less than or equal to −65 dB/km, or less than or equal to −70 dB/km, or less than or equal to −75 dB/km, or less than or equal to −80 dB/km, or less than or equal to −85 dB/km, or less than or equal to −90 dB/km, or in a range from −25 dB/km to −100 dB/km, or in a range from −30 dB/km to −90 dB/km, or in a range from −35 dB/km to −80 dB/km, or in a range from −40 dB/km to −75 dB/km at a wavelength of 1310 nm for a core element spacing less than or equal to 28 μm.

The co-propagating crosstalk between each pair of adjacent core elements of the multicore optical fibers disclosed herein is less than or equal to −25 dB/km, or less than or equal to −30 dB/km, or less than or equal to −35 dB/km, or less than or equal to −40 dB/km, or less than or equal to −45 dB/km, or less than or equal to −50 dB/km, or less than or equal to −55 dB/km, or less than or equal to −60 dB/km, or less than or equal to −65 dB/km, or less than or equal to −70 dB/km, or in a range from −25 dB/km to −85 dB/km, or in a range from −30 dB/km to −80 dB/km, or in a range from −35 dB/km to −75 dB/km or in a range from −40 dB/km to −70 dB/km, or in a range from −45 dB/km to −65 dB/km at a wavelength of 1550 nm for a core element spacing less than or equal to 40 μm.

The co-propagating crosstalk between each pair of adjacent core elements of the multicore optical fibers disclosed herein is less than or equal to −20 dB/km, or less than or equal to −25 dB/km, or less than or equal to −30 dB/km, or less than or equal to −35 dB/km, or less than or equal to −40 dB/km, or less than or equal to −45 dB/km, or less than or equal to −50 dB/km, or less than or equal to −55 dB/km, or less than or equal to −60 dB/km, or less than or equal to −65 dB/km, or in a range from −20 dB/km to −75 dB/km, or in a range from −25 dB/km to −70 dB/km, or in a range from −30 dB/km to −65 dB/km or in a range from −35 dB/km to −60 dB/km at a wavelength of 1550 nm for a core element spacing less than or equal to 34 μm.

The co-propagating crosstalk between each pair of adjacent core elements of the multicore optical fibers disclosed herein is less than or equal to −15 dB/km, less than or equal to −20 dB/km, or less than or equal to −25 dB/km, or less than or equal to −30 dB/km, or less than or equal to −35 dB/km, or less than or equal to −40 dB/km, or less than or equal to −45 dB/km, or less than or equal to −50 dB/km, or less than or equal to −55 dB/km, or less than or equal to −60 dB/km, or in a range from −15 dB/km to −65 dB/km, or in a range from −20 dB/km to −60 dB/km, or in a range from −25 dB/km to −55 dB/km or in a range from −30 dB/km to −50 dB/km at a wavelength of 1550 nm for a core element spacing less than or equal to 28 μm.

The counterpropagating crosstalk between each pair of adjacent core elements of the multicore optical fibers disclosed herein is less than or equal to −50 dB/km, or less than or equal to −60 dB/km, or less than or equal to −70 dB/km, or less than or equal to −80 dB/km, or less than or equal to −90 dB/km, or less than or equal to −100 dB/km, or less than or equal to −110 dB/km, or less than or equal to −120 dB/km, or less than or equal to −130 dB/km, or less than or equal to −135 dB/km, or in a range from −50 dB/km to −150 dB/km, or in a range from −60 dB/km to −145 dB/km, or in a range from −70 dB/km to −140 dB/km or in a range from −75 dB/km to −135 dB/km, or in a range from −80 dB/km to −130 dB/km, or in a range from −85 dB/km to −125 dB/km at a wavelength of 1310 nm for a core element spacing less than or equal to 40 μm.

The counterpropagating crosstalk between each pair of adjacent core elements of the multicore optical fibers disclosed herein is less than or equal to −40 dB/km, or less than or equal to −50 dB/km, or less than or equal to −60 dB/km, or less than or equal to −70 dB/km, or less than or equal to −80 dB/km, or less than or equal to −90 dB/km, or less than or equal to −100 dB/km, or less than or equal to −110 dB/km, or less than or equal to −120 dB/km, or less than or equal to −130 dB/km, or in a range from −40 dB/km to −140 dB/km, or in a range from −50 dB/km to −130 dB/km, or in a range from −60 dB/km to −120 dB/km or in a range from −70 dB/km to −110 dB/km at a wavelength of 1310 nm for a core element spacing less than or equal to 34 μm.

The counterpropagating crosstalk between each pair of adjacent core elements of the multicore optical fibers disclosed herein is less than or equal to −30 dB/km, or less than or equal to −40 dB/km, or less than or equal to −50 dB/km, or less than or equal to −60 dB/km, or less than or equal to −70 dB/km, or less than or equal to −80 dB/km, or less than or equal to −90 dB/km, or less than or equal to −100 dB/km, or less than or equal to −110 dB/km, or less than or equal to −120 dB/km, or in a range from −30 dB/km to −130 dB/km, or in a range from −40 dB/km to −120 dB/km, or in a range from −50 dB/km to −110 dB/km or in a range from −60 dB/km to −100 dB/km at a wavelength of 1310 nm for a core element spacing less than or equal to 28 μm.

The counterpropagating crosstalk between each pair of adjacent core elements of the multicore optical fibers disclosed herein is less than or equal to −40 dB/km, or less than or equal to −45 dB/km, or less than or equal to −50 dB/km, or less than or equal to −55 dB/km, or less than or equal to −60 dB/km, or less than or equal to −65 dB/km, or less than or equal to −70 dB/km, or less than or equal to −75 dB/km, or less than or equal to −85 dB/km, or less than or equal to −90 dB/km, or less than or equal to −95 dB/km, or in a range from −40 dB/km to −120 dB/km, or in a range from −45 dB/km to −115 dB/km, or in a range from −50 dB/km to −110 dB/km or in a range from −55 dB/km to −105 dB/km, or in a range from −60 dB/km to −100 dB/km, or in a range from −65 dB/km to −95 dB/km at a wavelength of 1550 nm for a core element spacing less than or equal to 40 μm.

The counterpropagating crosstalk between each pair of adjacent core elements of the multicore optical fibers disclosed herein is less than or equal to −35 dB/km, less than or equal to −40 dB/km, or less than or equal to −45 dB/km, or less than or equal to −50 dB/km, or less than or equal to −55 dB/km, or less than or equal to −60 dB/km, or less than or equal to −65 dB/km, or less than or equal to −70 dB/km, or less than or equal to −75 dB/km, or less than or equal to −85 dB/km, or less than or equal to −90 dB/km, or in a range from −35 dB/km to −100 dB/km, or in a range from −40 dB/km to −95 dB/km, or in a range from −45 dB/km to −90 dB/km or in a range from −50 dB/km to −85 dB/km, or in a range from −55 dB/km to −80 dB/km at a wavelength of 1550 nm for a core element spacing less than or equal to 34 μm.

The counterpropagating crosstalk between each pair of adjacent core elements of the multicore optical fibers disclosed herein is less than or equal to −30 dB/km, or less than or equal to −35 dB/km, less than or equal to −40 dB/km, or less than or equal to −45 dB/km, or less than or equal to −50 dB/km, or less than or equal to −55 dB/km, or less than or equal to −60 dB/km, or less than or equal to −65 dB/km, or less than or equal to −70 dB/km, or less than or equal to −75 dB/km, or less than or equal to −85 dB/km, or in a range from −30 dB/km to −90 dB/km, or in a range from −35 dB/km to −85 dB/km, or in a range from −40 dB/km to −80 dB/km or in a range from −45 dB/km to −75 dB/km at a wavelength of 1550 nm for a core element spacing less than or equal to 28 μm.

The multicore optical fibers disclosed herein are suited to use in cables intended for high-density applications. Optical fiber cables are often installed in ducts to facilitate installation of the cables by pulling or jetting. Cost-effective installation of optical fiber cables is often limited by the ability of a cable to be effectively pulled or jetted through such ducts. Since duct space is limited, and the installation of ducts themselves is costly, various attempts have been made to increase a number of optical fibers in a cable for a given outside diameter of the cable. Similarly, installation of cables in existing structures such as buildings, routing trays, or the like, is limited by the physical space available in such existing structures. However, microbending losses exhibited by optical fibers have led to limited success by the industry in achieving higher fiber density cables without unacceptably increasing attenuation.

As noted above, multicore optical fibers have been used in an attempt to increase the density of available data channels in optical fiber cables. Previously, multicore optical fibers have been limited in their performance by microbending losses and core-to-core crosstalk. As set forth above, the multicore optical fibers disclosed herein have low diameter and exhibit low microbend sensitivity and low crosstalk. Thus, the multicore optical fibers described herein are well-suited for use in high-density optical fiber cables.

As used herein, “core density” of an optical fiber cable refers to a number of glass cores in the cable divided by the area of a circle that has a diameter equal to an outside diameter of the optical fiber cable. As used herein, “fiber density” of an optical fiber cable refers to a number of distinct optical fibers divided by the area of a circle that has a diameter equal to an outside diameter of the optical fiber cable.

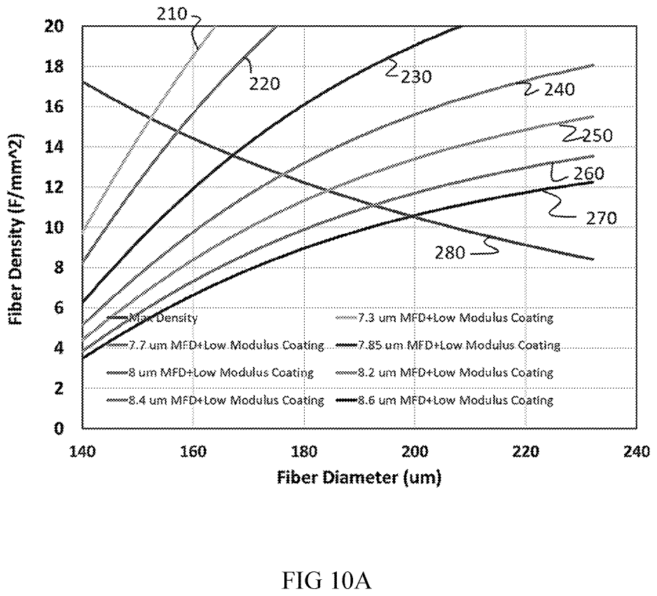

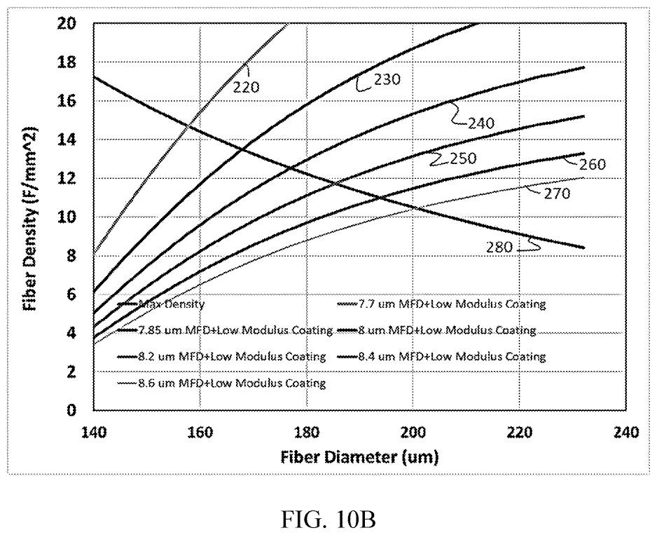

Modeling efforts by the inventors have indicated that practical achievable fiber density in an optical fiber cable depends on fiber diameter, cable core packing density, fiber primary coating modulus, and fiber mode field diameter. Referring now to FIGS. 10A and 10B, diagrams of maximum cable fiber density plotted against outside fiber diameter are shown for a modeled cable having multicore fibers disposed in subunits, the subunits being surrounded by a cable jacket. FIG. 10A illustrates maximum cable fiber density plotted against outside fiber diameter when the modeled cable includes multicore optical fibers having a 1×2 core design with a core element spacing of 40 μm. FIG. 10B illustrates maximum cable fiber density plotted against outside fiber diameter when the modeled cable includes multicore optical fibers having a 2×2 core design with a core element spacing of 40 μm. For the purposes of the models described by FIGS. 10A and 10B, each optical fiber in the modeled cable is assumed to have a same outer diameter, which is a diameter of the fiber taken at its outermost coating layer. Furthermore, the models described by FIGS. 10A and 10B assumed that each of the optical fibers included a primary coating having a low in situ modulus of 0.16 MPa, an undoped silica common cladding region with an outer radius R₄=62.5 μm, a secondary coating having a modulus of 1800 MPa, and that the cores of each modeled multicore optical fiber were identical with a trench-assisted design with a refractive index trench having a trench volume of approximately 46% Δ-μm². The mode field diameter (MFD) of the cores was the same within each modeled multicore optical fiber and was varied in different ones of the modeled multicore optical fibers for purposes of comparison.

The MFDs at 1310 nm of the cores depicted in the multicore optical fibers of FIGS. 10A (1×2) and 10B (2×2) are 7.3 μm (Trace 210), 7.7 μm (Trace 220), 7.85 μm (Trace 230), 8.0 μm (Trace 240), 8.2 μm (Trace 250), 8.4 μm (Trace 260), and 8.6 μm (Trace 270).

The curve “Max Density” (Trace 280) in each of FIGS. 10A and 10B depicts a maximum number of optical fibers that can be packed into available space within the modeled cable, assuming that the modeled cable has a minimum cable jacket wall of 1.3 mm with strength members embedded in the cable jacket wall, a maximum fiber filling coefficient in each subunit of 77%, and a maximum subunit packing density in a central bore defined by the cable jacket of 80%, wherein the subunit packing density refers to a fraction of the cross-sectional area of the central bore of the cable (i.e., the area enclosed by the inner surface of the cable jacket) that is occupied by the subunits. For the purposes of computing subunit packing density of a cable, it is assumed that any free space within the subunits themselves is nevertheless occupied by the subunits.

As can be seen from each of FIGS. 10A and 10B, a maximum number of optical fibers that can be packed into a cable generally decreases with increasing fiber diameter. However, this maximum packing density is often not achievable in practical optical fiber cables due to other cable requirements and constraints, particularly limits on maximum allowable attenuation. As a number of optical fibers in a cable is increased, all else being equal, microbending-induced attenuation tends to increase. Microbending also manifests itself through the attenuation increase that is induced during the thermal cycling of the cable. Thus, FIGS. 10A and 10B show plots of expected maximum achievable fiber density in the modeled cable when constrained by microbending-induced attenuation for multicore optical fibers having different MFDs at a wavelength of 1310 nanometers. In particular, FIGS. 10A and 10B show, for each of the modeled optical fibers, a maximum density achievable in the modeled cable while maintaining an attenuation change of less than or equal to 0.15 dB/km at a lowest temperature during a thermal cycling test (e.g., −40° C. during a thermal cycling test performed according to IEC 60794-1-212:2024), given an outside diameter of the optical fiber.

As can be seen from FIGS. 10A and 10B, for each of the optical fibers there is a generally positive relationship between fiber diameter and fiber density, ultimately limited by the “Max Density” curve (Trace 280) illustrating the geometric packing limit of fibers in the modeled cable. Generally, the lower the MFD of the optical fibers, the greater the optical fiber density at which the microbending-constrained curves intersect with the geometric packing limit of the modeled cable. Further, the intersection points of these microbending-constrained curves with the “Max Density” curve (Trace 280) shown in FIGS. 10A and 10B provide expected optimum fiber outside diameter to provide maximum cable fiber density, balancing microbend sensitivity and geometric packing limit to yield a highest packing density for each fiber design.

Referring now solely to FIG. 10A, a microbending sensitivity of the 1×2-core modeled multicore optical fiber was estimated to be approximately 2.8 times greater than a single-core fiber having an identical refractive index profile. The modeling of FIG. 10A yielded an expected optimum fiber outside diameter for a 1×2-core, 8.6-μm-MFD fiber modeled of 200 μm, yielding a fiber density of 10.59 fibers/mm² and a core density of 21.18 cores/mm² in the modeled cable. An expected optimum fiber outside diameter for a 1×2-core fiber having 8.4-μm-MFD is 192 μm yielding a fiber density of 11.05 fibers/mm² and a core density of 22.1 cores/mm². An expected optimum fiber outside diameter for a 1×2-core 8.2-μm-MFD fiber is 184 μm yielding a fiber density of 11.79 fibers/mm² and a core density of 23.58 cores/mm². An expected optimum fiber outside diameter of a 1×2-core 8-μm-MFD fiber is 176 μm, yielding a fiber density of 12.6 fibers/mm² and a core density of 25.2 cores/mm². An expected optimum fiber outside diameter for the 7.85-μm-MFD fiber is 168 μm, yielding a fiber density of 13.77 fibers/mm² and a core density of 27.54 cores/mm². The optical fiber 10 at MFD of 7.7 μm is expected to allow the modeled cable to achieve a fiber density of 15.02 fibers/mm² and a core density of 30.04 cores/mm² if the optical fiber 10 has an outside diameter of 158 μm. The optical fiber 10 at MFD of 7.3 μm is expected to allow the modeled cable to achieve a fiber density of 15.26 fibers/mm² and a core density of 30.52 cores/mm² if the optical fiber 10 has an outside diameter of 152 μm.

Referring now to FIG. 10B, a microbending sensitivity of the 2×2-core modeled multicore optical fiber with a core element spacing of 40 μm was estimated to be approximately 3 times greater than a single-core fiber having an identical refractive index profile. Thus, the 2×2-core modeled fiber is expected to have a greater microbending sensitivity than the 1×2-core fibers described by FIG. 10A. Accordingly, for each MFD the intersection of the microbend-constrained fiber diameter/fiber density curves with the “Max Density” curve occurs at a greater fiber diameter and a lower fiber density for the 2×2-core modeled fiber than the 1×2-core modeled fiber. However, since the 2×2-core fiber has twice as many cores as the 1×2-core fiber, core densities achievable with the 2×2-core fiber in the modeled cable are generally greater than those achieved with the 1×2-core fiber in the modeled cable.

The modeling of FIG. 10B for a loose fiber cables yielded an expected optimum fiber diameter of 200 and maximum fiber density of 10.4 fibers/mm² and core density of 41.6 cores/mm² for the 2×2-core 8.6-μm-MFD modeled fiber. An expected optimum fiber outside diameter for the modeled 2×2-core fiber having 8.4-μm-MFD is 194 μm yielding a fiber density of 11.02 fibers/mm² and a core density of 54.08 cores/mm². An expected optimum fiber outside diameter for the modeled 2×2 core 8.2-μm-MFD fiber is 186 μm yielding a fiber density of 11.81 fibers/mm² and a core density of 47.24 cores/mm². An expected optimum fiber outside diameter of the modeled 2×2 core 8-μm-MFD fiber is approximately 176 μm, yielding a fiber density of 12.38 fibers/mm² and a core density of 49.32 cores/mm². An expected optimum fiber outside diameter for the modeled 2×2 core 7.85-μm-MFD fiber is 168 μm, yielding a fiber density of 13.52 fibers/mm² and a core density of 54.08 cores/mm². The modeled 2×2 core optical fiber 10 at MFD of 7.7 μm is expected to allow the modeled cable to achieve a fiber density of approximately 14.76 fibers/mm² and a core density of 59.04 cores/mm² if the optical fiber 10 has an outside diameter of 158 μm.

As noted above, multicore optical fibers considered in the modeling for FIGS. 10A and 10B each had a primary coating having a modulus of 0.16 MPa, a secondary coating having a modulus of 1800 MPa, and cores with a trench-assisted design with a refractive index trench having a trench volume of approximately 46% A μm² and the cable is a loose tube cable design. It is to be appreciated that the microbend-constrained curves for particular fiber designs shown in FIGS. 10A and 10B may not be valid for other fiber designs. For instance, changes in coatings or trench volume may yield different achievable optimal combinations of fiber density in a cable or optical fiber diameter. However, it will be appreciated by those of skill in the art from the full scope of the present disclosure that the multicore optical fibers described herein are well-suited to enabling the cable fiber and core densities contemplated by the diagrams of FIGS. 10A and 10B and their accompanying description.

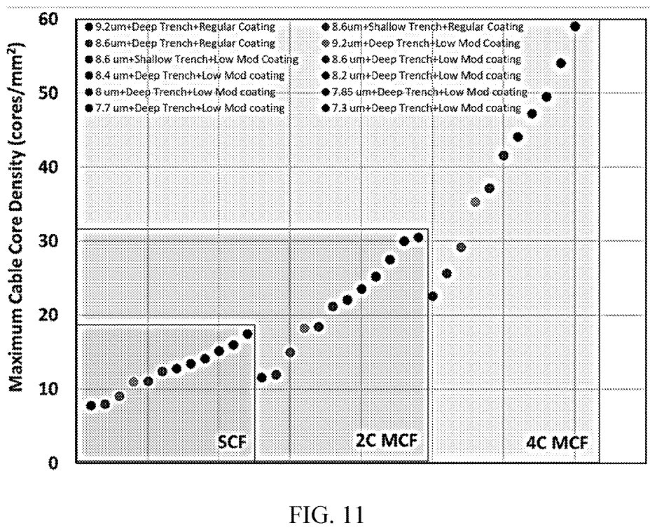

Referring now to FIG. 11, a graph of maximum cable core density for the modeled cable for each of several modeled fibers is shown. For each of the modeled fibers indicated, the indicated MFD is at a wavelength of 1310 nanometers, a “shallow trench” is a refractive index trench having a trench volume of 5% A μm², a “deep trench” is a refractive index trench having a trench volume of 46% A μm², the low modulus coating refers to a primary coating having an in situ modulus of 0.16 MPa, and the “regular” coating refers to a primary coating having an in situ modulus of 0.4 MPa. The differently boxes of FIG. 11 bound data points for different types of fibers: single-core fibers (SCF), 1×2-core multicore optical fibers (2C MCF), and 2×2-core multicore optical fibers (4C MCF).

Generally, the data points on the diagram of FIG. 11 represent intersection points of the “Max Density” curve with modeled microbend-constrained curves, modeled with a same modeled cable and multicore optical fibers as described above with respect to FIGS. 10A and 10B. Within each box (SCF, 2C MCF, 4C MCF), the data points are arranged from left to right in order of decreasing MFD at 1310 nm according to the following series: 9.2 μm+Deep Trench+Regular Coating, 8.6 μm+Shallow Trench+Regular Coating, 8.6 μm+Deep Trench+Regular Coating, 9.2 μm+Deep Trench+Low Modulus Coating, 8.6 μm+Shallow Trench+Low Modulus Coating, 8.6 μm+Deep Trench+Low Modulus Coating, 8.4 μm+Deep Trench+Low Modulus Coating, 8.2 μm+Deep Trench+Low Modulus Coating, 8.0 μm+Deep Trench+Low Modulus Coating, 7.85 μm+Deep Trench+Low Modulus Coating, 7.7 μm+Deep Trench+Low Modulus Coating, 7.3 μm+Deep Trench+Low Modulus Coating (not included in the data for 4C MCF). The inventors have determined that, all else being equal and as shown in FIG. 11, a low-modulus primary coating, a low MFD at 1310 nanometers, and a deep refractive index trench provide improved maximum cable core density. Furthermore, for each equivalent fiber design (i.e., combination of MFD, trench design, and coating modulus), a greater core density is achieved by a 1×2-core multicore optical fiber than a single-core fiber, and a still greater core density is achieved by a 2×2-core multicore optical fiber than a 1×2-core multicore optical fiber.

It is further to be appreciated that the expected optimum combinations of fiber diameter and fiber density illustrated in FIGS. 10A and 10B are only achievable with a cable design that is capable of achieving the subunit packing density and cable core packing density of the modeled cable, as represented by the “Max Density” curve of FIGS. 10A and 10B. A cable joining low-MFD multicore optical fibers, such as the optical fibers 10 described herein, with a high-density cable design capable of achieving dense packing can achieve fiber densities that have heretofore been out of practical reach for optical fiber cables.

Various additional modeling data are presented below. Unless otherwise stated, cabel modeling parameters (e.g., subunit packing density, subunit fiber filling coefficient) are the same as those discussed above with respect to FIGS. 10A and 10B. In Table 22 are shown the fiber and core densities in loose fiber cables using multicore optical fibers with a core element spacing of 40 μm, with each core element having a trench assisted design having trench volume of 46% Δ-μm² and the fiber having a primary coating with an in situ modulus of 0.16 MPa and secondary coating having a modulus of 1800 MPa. In Table 23 are shown the expected achievable fiber and core densities in ribbon fiber cables using multicore optical fibers with a core element spacing of 40 μm, with each core element having a trench assisted design having trench volume of 46% Δ-μm² and the fiber having a primary coating with an in situ modulus of 0.16 MPa and secondary coating having a modulus of 1800 MPa. In Table 24 are shown the fiber and core densities in loose fiber cables using multicore optical fibers with a core element spacing of 40 μm, with each core element having a trench assisted design having trench volume of 46% Δ-μm² and the fiber having a primary coating with an in situ modulus of 0.16 MPa and secondary coating having a modulus of 2500 MPa.

TABLE 22
Fiber and core densities in loose fiber cables using multicore optical
fibers with a core element spacing of 40 μm, with each core element
having a trench assisted design having trench volume of 46% Δ-μm²
and the fiber having a primary coating with an in situ modulus
of 0.16 MPa and secondary coating having a modulus of 1800 MPa.

| | | Primary | Secondary | | Fiber | Core |
|---|---|---|---|---|---|---|
| MFD at | Trench | Coating | Coating | Fiber | Density | Density |
| 1310 nm | Volume | Modulus | Modulus | Diameter | in Cables | in |
| (μm) | (% Δ-μm²) | (MPa) | (MPa) | (μm) | (#/mm²) | Cable |
| 8.6 | 46 | 0.16 | 1800 | 200 | 10.4 | 41.6 |
| 8.4 | 46 | 0.16 | 1800 | 194 | 11.02 | 44.08 |
| 8.2 | 46 | 0.16 | 1800 | 186 | 11.81 | 47.24 |
| 8 | 46 | 0.16 | 1800 | 176 | 12.38 | 49.52 |
| 7.85 | 46 | 0.16 | 1800 | 168 | 13.52 | 54.08 |
| 7.7 | 46 | 0.16 | 1800 | 158 | 14.76 | 59.04 |

TABLE 23
Fiber and core densities in ribbon fiber cables using multicore optical
fibers with a core element spacing of 40 μm, with each core element
having a trench assisted design having trench volume of 46% Δ-μm²
and the fiber having a primary coating with an in situ modulus
of 0.16 MPa and secondary coating having a modulus of 1800 MPa.

| | | Primary | Secondary | | Fiber | Core |
|---|---|---|---|---|---|---|
| MFD at | Trench | Coating | Coating | Fiber | Density | Density |
| 1310 nm | Volume | Modulus | Modulus | Diameter | in Cables | in |
| (μm) | (% Δ-μm²) | (MPa) | (MPa) | (μm) | (#/mm²) | Cable |
| 8.6 | 46 | 0.16 | 1800 | 226 | 8.82 | 35.28 |
| 8.4 | 46 | 0.16 | 1800 | 216 | 9.38 | 37.52 |
| 8.2 | 46 | 0.16 | 1800 | 204 | 10.09 | 40.36 |
| 8 | 46 | 0.16 | 1800 | 194 | 11.01 | 44.04 |
| 7.85 | 46 | 0.16 | 1800 | 182 | 12.09 | 48.36 |
| 7.7 | 46 | 0.16 | 1800 | 168 | 13.31 | 53.24 |

TABLE 24
Fiber and core densities in ribbon fiber cables using multicore optical
fibers with a core element spacing of 40 μm, with each core element
having a trench assisted design having trench volume of 46% Δ-μm²
and the fiber having a primary coating with an in situ modulus
of 0.16 MPa and secondary coating having a modulus of 2500 MPa.

| | | Primary | Secondary | | Fiber | Core |
|---|---|---|---|---|---|---|
| MFD at | Trench | Coating | Coating | Fiber | Density | Density |
| 1310 nm | Volume | Modulus | Modulus | Diameter | in Cables | in |
| (μm) | (% Δ-μm²) | (MPa) | (MPa) | (μm) | (#/mm²) | Cable |
| 8.6 | 46 | 0.16 | 2500 | 216 | 9.38 | 37.52 |
| 8.4 | 46 | 0.16 | 2500 | 208 | 9.96 | 39.84 |
| 8.2 | 46 | 0.16 | 2500 | 198 | 10.73 | 42.92 |
| 8 | 46 | 0.16 | 2500 | 188 | 11.59 | 46.36 |
| 7.85 | 46 | 0.16 | 2500 | 176 | 12.49 | 49.96 |
| 7.7 | 46 | 0.16 | 2500 | 164 | 13.75 | 55 |

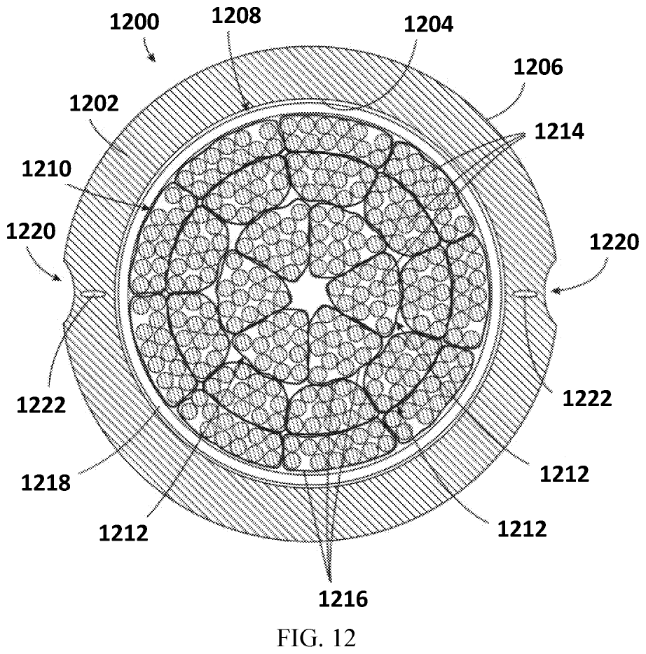

Referring now to FIG. 12, a high fiber density optical fiber cable 1200 is illustrated. The optical fiber cable 1200 has a design configured to allow high fiber packing density within each of several subunits, and a high subunit packing density within a core of the cable 1200, wherein the core of an optical fiber cable refers collectively to those elements disposed within a central bore of the cable. Thus, when employed with the inventive optical fibers 10 described herein, the high-density optical fiber cable 1200 is well-suited to achieving multicore fiber densities in excess of 10 fibers/mm² and core densities in excess of 24 cores/mm² while meeting other performance needs of the cable 1200, such as but not limited to attenuation performance.

The optical fiber cable 1200 includes a cable jacket 1202 having an inner surface 1204 and an outer surface 1206. The inner surface 1204 of the optical fiber cable 1200 defines a central bore 1208 that extends along a longitudinal axis of the optical fiber cable 1200. The outer surface 1206 defines an outermost surface of the optical fiber cable 1200. Generally, the cable jacket 1202 is formed from one or more extrudable polymeric materials. The cable jacket 1202 can have one or more layers. Furthermore, the cable jacket 1202 can have reinforcing fibers or filaments embedded therein.

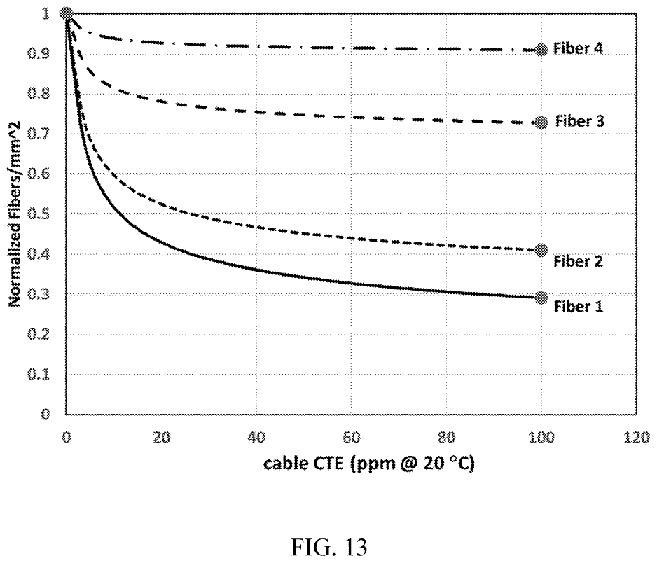

Referring now to FIG. 13, a diagram is shown that illustrates a modeled relationship between coefficient of linear thermal expansion (CTE) at 20° C. of the cable jacket 1202 and a fiber density of an optical fiber cable for four different optical fibers having different combinations of glass profile (i.e., configuration of glass core and cladding) and coating systems (e.g., primary and/or secondary coating modulus). The diagram of FIG. 13 shows that the fiber density, normalized to a fiber density achievable at a cable jacket CTE of 0 ppm/° C., generally decreases as cable jacket CTE increases for each of the 4 modeled fibers. However, the greatest impacts on fiber density for each of the fibers are observed as the CTE increases from 0 ppm/° C. to 100 ppm/° C., after which the reduction in fiber density for increases in CTE levels off. Accordingly, in embodiments, the cable jacket 1202 is configured to have a CTE of less than or equal to 100 ppm/° C. at 20° C., or still more particularly less than or equal to 50 ppm/° C. at 20° C., or yet more particularly less than or equal to 20 ppm/° C. at 20° C. By way of example, and not limitation, the cable jacket 1202 can be formed from polyethylene or other polymer or polymer blend that is reinforced by extruded filaments of polycarbonate or a liquid crystal polymer (LCP). In still other examples, the cable jacket 1202 can be formed from a copolyester and stabilizer blend that on its own exhibits such a low CTE.

Referring once again to FIG. 12, disposed within the central bore 1208 of the optical fiber cable 1200 is cable core 1210 including a plurality of subunits 1212. The subunits 1212 each include a plurality of optical fibers 1214 surrounded by a membrane 1216. The optical fibers 1214 can be, for example, the optical fibers 10 described in detail above.

The membrane 1216 is formed from an extruded polymeric material. The thermoplastic polymers are not particularly limited in terms of molecular weight and distributions, and the thermoplastic polymers may be homopolymers, heteropolymers, or copolymers. In general, the thermoplastic polymers are selected from among polyolefins, polyvinylchloride, polystyrene, acrylonitrile butadiene styrene, styrene-acrylonitrile, styrene-ethylene-butylene-styrene, and technical thermoplastics. In one or more embodiments, the polyolefins include polyethylenes (very low density, linear low density, low density, medium density, high density, and ultrahigh molecular weight), polypropylene (isotactic, syndiotactic, and atactic), and polyolefin-based thermoplastic elastomers (such as ethylene vinyl acetate, ethylene butyl acrylate, ethylene methyl acrylate, thermoplastic olefin elastomer, ethylene-propylene rubber, and ethylene propylene diene monomer rubber). In one or more embodiments, the technical thermoplastics include polyesters (such as polybutylene terephthalate, polyethylene terephthalate, polycarbonate, poly methyl methacrylate, and polyoxymethylene), polyethers (such as polyphenylene ether and poly(p-phenylene oxide)), polyamides (such as polyamide 6, polyamide 12, polyamide 6.6, polyamide 4.6, and polyamide 11), polyacetal, polysulfones (such as polyethersulfone, polysulfone, and polyphenylene sulfide), polyimides, and polyketones. The membrane 1216 is a thin and flexible sheath that allows for the subunit 1212 to be reconfigured into a variety of different shapes. In this way, the subunits 1212 can be densely packed within the cable core 1210 by changing shape, e.g., flattening out, bunching up, or bending, as necessary to fill space within the cable core 1210.

In one or more embodiments, the interior surface of the membrane 1216 defines an interior cross-sectional area of the subunit 1212. The portion of this interior cross-sectional area that is not occupied by the optical fibers 1214 is referred to as “free space.” In one or more embodiments, each subunit 1212 comprises a free space of 50% or less, 40% or less, 30% or less, or 25% or less. The low free space within the subunits 1212 contributes to the high fiber density of the optical fiber cable 1200. In one or more embodiments, the subunits 1212 may also include a water-blocking material, such as a water-blocking gel, super-absorbent powders, or water-blocking yarn.

The subunits 1212 may be stranded (such as SZ-stranded) in the cable core 1210 in embodiments. The stranding enhances the ability to bend the cable while minimizing tensile and contractive forces within any of the fibers. During cable bending, the optical fibers 1214 must be able to shift position, moving longitudinally to relieve those forces so as not to cause attenuation or break the optical fibers 1214. Because the membranes 1216 and cable core 1210 provide limited free space for the optical fibers 1214 to increase fiber density by design, the subunits 1212 may be configured to move relative to each other in certain embodiments by using solid or gel lubricants, such as talc, or using water-absorbing powders.

Thus, in one or more embodiments, the optical fiber cable 1200 may consist essentially of the cable jacket 1202 surrounding a plurality of subunits 1212. Other components that do not affect the basic and novel characteristics of the optical fiber cable 1200 that may be included are, for example, a binder 1218 provided between the plurality of subunits 1212 and the cable jacket 1202 (e.g., to maintain a stranding of the subunits 1212, or to provide organization to subgroups of the subunits 1212), water blocking material (e.g., tapes and powders), lubricants, friction-enhancing materials, and access features (e.g., ripcords or preferential tear features, such as a strip of dissimilar polymer in the cable jacket 1202). In one or more embodiments, armor layers and strength elements are excluded from the construction of the optical fiber cable 1200. However, it is to be appreciated that in other embodiments, an armor layer can be included between binder 1218 and the cable jacket 1202 or strength elements such as fiber-reinforced plastic rods (FRPs) or steel wires can be embedded in the cable jacket 1202. In embodiments wherein strength elements are embedded in the jacket, a number of the strength elements can be greater than or equal to 2, greater than or equal to 4, or greater than or equal to 8.

In one or more embodiments, the thickness of the membrane 1216 is 100 μm or less, 90 μm or less, 80 μm or less, 70 μm or less, 60 μm or less, 50 μm or less, or 40 μm or less. In one or more embodiments, the thickness of the membrane 1216 is 10 μm or more, 20 μm or more, 30 μm or more, or 35 μm or more. In one or more embodiments, the thickness of the membrane 1216 is from 10 μm to 100 μm, in particular from 25 μm to 75 μm, and most particularly from 35 μm to 50 μm.

In one or more embodiments, the membrane 1216 groups from two to one hundred forty-four optical fibers 1214 into a subunit 1212. In various embodiments, the optical fibers 1214 in a subunit 1212 can be further organized as optical fiber ribbons, in particular intermittently-bonded or “rollable” optical fiber ribbons. It will be appreciated that the optical fiber cable 1200 described herein can have substantially any number of optical fibers 1214, depending on an inside diameter of the cable 1200.

In one or more embodiments, the subunits 1212 are surrounded by a binder 1218. In one or more embodiments, the binder 1218 is a thin film jacket having a thickness between 40 μm and 150 μm. In one or more embodiments, the binder 1218 is provided to prevent sticking between the subunits 1212 and the cable jacket 1202, and thus, in one or more embodiments, the material of the binder 1218 is selected to prevent sticking to both the subunits 1212 and the cable jacket 1202. Advantageously, using a thin binder 1218 having a thickness in the disclosed thickness range reduces the thermal load of the binder 1218 on the subunits 1212 during extrusion of the binder 1218.

In one or more embodiments, the cable jacket 1202 has a thickness between the inner surface 1204 and the outer surface 1206 in a range from 0.5 mm to 1.5 mm. In one or more embodiments, the cable jacket 1202 is made from a polyethylene material (such as high density polyethylene (HDPE)), a low-smoke zero halogen (LSZH) polymer, a filled polyethylene, a flame retardant (FR) polymer, or a urethane polymer, amongst other possibilities.

In one or more embodiments, the cable jacket 1202 includes tactile locator features 1220. In the embodiment depicted, the tactile locator features 1220 comprise diametrically arranged depressions defined by the outer surface 1206 of the cable jacket 1202. However, in one or more other embodiments, the tactile locator features 1220 comprise diametrically arranged bumps defined by the outer surface 1206 of the cable jacket 1202. The tactile locator features 1220 assist a user in opening the cable 1200 by guiding the user to the location of access features 1222. In the embodiment of the optical fiber cable 1200, the access features 1222 are strips of dissimilar polymer embedded in the polymer of the cable jacket 1202. For example, the cable jacket 1202 may substantially comprise polyethylene, and the dissimilar polymer of the access feature 1222 may be polypropylene. The immiscibility of polyethylene cable jacket 1202 and the polypropylene access features 1222 prevents a strong bond from forming between the cable jacket 1202 and the access features 1222, allowing for a user to tear through the cable jacket 1202 in the region of the access features 1222. Further, once opened at the access features 1222, the cable jacket 1202 can be split along its length along the access features 1222. It is to be appreciated that in some embodiments the access features 1222 and/or tactile locator features 1220 may be omitted, and the cable 1200 can instead include one or more ripcords, either embedded in the cable jacket 1202 or disposed in the central bore 1208.

In one or more embodiments, the optical fiber cable 1200 has a cumulative fiber filling coefficient of at least 50%, at least 60%, at least 65%, or at least 70%. In one or more embodiments, the optical fiber cable 1200 has a cumulative fiber filling coefficient of up to 85%. As used herein, the term “cumulative fiber filling coefficient” of an optical-fiber cable 1200 refers to the ratio of the sum of the cross-sectional areas of all of the optical fibers 1214 within the optical-fiber cable 1200 versus the inner cross-sectional area of the optical-fiber cable 1200 (i.e., defined by the inner surface 1204 of the cable jacket 1202 or inner surface of binder 1218, if included). The cross-sectional area of each optical fiber 1214 is determined based on an outer surface of the optical fiber 1214.

In one or more embodiments, the optical fiber cable 1200 comprises a free space of at most 50%, at most 42.5%, at most 30%, or at most 25%. In one or more embodiments, the free space of the optical fiber cable 1200 is at least 15%. As used herein, the free space is the inverse of cumulative fiber filling coefficient (i.e., 100%-cumulative fiber filling coefficient).

The optical fiber cable 1200 described above, when employing the optical fibers 10 described herein, can be configured to have a higher fiber density than prior art optical fiber cables using single-core or multicore fibers. In exemplary embodiments, the optical fiber ribbon fiber cable 1200 can be constructed to have 2×2-core optical fibers 10 packed with a fiber density of greater than 9.38 fibers/mm², particularly greater than or equal to 10.09 fibers/mm², or more particularly greater than or equal to 11.01 fibers/mm², even more particularly greater than or equal to 12.09 fibers/mm², still more particularly greater than or equal to 13.31 fibers/mm² or yet more particularly greater than or equal to 14.1 fibers/mm². In such embodiments employing 2×2-core optical fibers 10, the optical fiber cable 1200 can be constructed to have a core density of greater than 35 cores/mm², particularly greater than or equal to 40 cores/mm², or more particularly greater than or equal to Δ₄ cores/mm², even more particularly greater than or equal to 48 cores/mm², or still more particularly greater than or equal to 55 cores/mm², or still yet more particularly greater than or equal to 56 cores/mm². In various embodiments, the optical fiber cable 1200 can have a core density of up to 100 cores/mm².

In exemplary embodiments, the optical fiber cable 1200 can be constructed to have 1×2-core optical fibers 10 packed with a fiber density of greater than 11.05 fibers/mm², greater than or equal to 11.79 fibers/mm², greater than or equal to 12.6 fibers/mm², greater than or equal to 13.77 fibers/mm², greater than or equal to 15.02 fibers/mm², or greater than or equal to 15.26 fibers/mm². Furthermore, in embodiments, the optical fiber cable 1200 can be constructed to have 1×2-core optical fibers 10 packed to yield a core density of greater than 22 cores/mm², greater than or equal to 24 cores/mm², greater than or equal to 25 cores/mm², greater than or equal to 28 cores/mm², greater than or equal to 30 cores/mm² or greater than or equal to 31 cores/mm².

In exemplary embodiments, a total number of optical fibers 1214 in the optical fiber cable 1200 can be between 8 and 13824, between 8 and 6912, between 8 and 3456, between 8 and 1728, between 144 and 13824, between 144 and 6912, between 144 and 3456, between 144 and 1728, between 144 and 864, between 288 and 13824, between 288 and 6912, between 288 and 3456, between 288 and 1728, between 288 and 864, between 432 and 13824, between 432 and 6912, between 432 and 3456, between 432 and 1728, or between 432 and 864, all ranges inclusive.

Still further, optical fiber cables described above can be configured to have such fiber and core densities while continuing to meet stringent standards for optical signal attenuation and core-to-core crosstalk. In various embodiments, the optical fiber cable 1200 exhibits an attenuation increase for a transmitted wavelength of 1550 nm of less than 0.15 dB/km when cooled for a second time to a temperature of −20° C. during a temperature cycling test performed according to IEC 60794-1-212:2024. In still further embodiments, the optical fiber cable 1200 exhibits an attenuation increase at 1550 nm of less than 0.15 dB/km when cooled for a second time to a temperature of −30° C., or for a second time to a temperature of −40° C. during such temperature cycling test performed according to IEC 60794-1-212:2024.

The inventors have further observed that optical fiber cables with a high ratio of polymeric elements to strength elements tend to exhibit greater attenuation changes during thermal cycling. Accordingly, the optical fiber cable 1200 can be constructed to have a relatively low fraction of plastic elements relative to strength elements, as measured by cross-sectional area. In embodiments, looking at an end of the cable 1200, the cable 1200 can have a ratio of cross-sectional area of plastic elements to cross-sectional area of strength elements of between 4 and 8, or more particularly between 4 and 6. For the purposes of evaluating a plastic-to-strength ratio of the cable 1200, elements such as the cable jacket 1202 (exclusive of any reinforcement disposed therein) and membranes 1216 are considered “plastic,” whereas FRPs, metal strength elements, tensile yarns (e.g., aramid yarns or fibers), and the optical fibers 1214 themselves are considered “strength,” whether or not they include polymeric elements (e.g., FRPs).

While various embodiments of a high density optical fiber cable having low-MFD optical fibers have been described herein, it is to be appreciated that the optical fibers 10 described herein can be employed in any of various cable designs. By way of example, it may be advantageous to form connections between a high density cable 1200 and other components of an optical system (e.g., in a data center) by way of a jumper cable with fibers that have a matching MFD to the fibers 1214 in the high-density cable 1200. Accordingly, the optical fibers 10 described herein are suitable for use with other cables, such as but not limited to jumper cables, that are not configured as high-density cables.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

It will be apparent to those skilled in the art that various modifications and variations can be made without departing from the spirit or scope of the invention. Since modifications combinations, sub-combinations and variations of the disclosed embodiments incorporating the spirit and substance of the invention may occur to persons skilled in the art, the invention should be construed to include everything within the scope of the appended claims and their equivalents.

What is claimed is:

1. A multicore optical fiber comprising:
a glass fiber, the glass fiber comprising:
a plurality of core elements, each core element comprising:
a core region, the core region having an outer radius r₁ and a relative refractive index Δ₁ with a maximum relative refractive index Δ_{1 max},
a dedicated cladding surrounding and directly adjacent to the core region;
a common cladding surrounding and directly adjacent to the dedicated cladding of each of the core elements of the plurality, the common cladding having an outer radius R₄ and a relative refractive index Δ₄;
a primary coating surrounding and directly adjacent to the common cladding, the primary coating having a radius R₅, a thickness R₅−R₄, and an in situ modulus less than or equal to 0.30 MPa;
a secondary coating surrounding and directly adjacent to the primary coating, the secondary coating having an outer radius R₆ less than or equal to 110 μm, a thickness R₆−R₅, and an in situ modulus greater than or equal to 1400 MPa, and;
wherein each core element of the plurality of core elements has a mode field diameter in the range from 7.3 μm to 8.2 μm at 1310 nm and a macrobend loss at 1550 nm, as determined by a mandrel wrap test using a mandrel with a diameter of 15 mm, of less than or equal to 0.50 dB/turn;
wherein the core element spacing is greater than or equal to 25 μm; and
wherein the co-propagating crosstalk between each pair of adjacent core elements is less than or equal to −35 dB/km at a wavelength of 1310 nm; and
wherein the co-propagating crosstalk between each pair of adjacent core elements is less than or equal to −25 dB/km at a wavelength of 1550 nm.

2. The multicore optical fiber of claim 1, wherein the outer radius r₁ of the core region is in a range from 2.5 μm to 6.0 μm.

3. The multicore optical fiber of claim 1, wherein the core region has a graded-index profile with a value of α in the range from 2.0 to 5.0.

4. The multicore optical fiber of claim 1, wherein the relative refractive index Δ₁ of the core region is a step index profile.

5. The multicore optical fiber of claim 1, wherein the dedicated cladding comprises
a dedicated trench cladding region surrounding the core region, the dedicated trench cladding region having an inner radius r₂, an outer radius r₃, a relative refractive index Δ₃ with a minimum relative refractive index Δ₃ min, and a trench volume greater than or equal to 30% Δ-μm².

6. The multicore optical fiber of claim 5, wherein the inner radius r₂ of the dedicated trench cladding region is in a range from 5.0 μm to 12.0 μm.

7. The multicore optical fiber of claim 5, wherein the outer radius 13 of the dedicated trench cladding region is in a range from 12.0 μm to 20.0 μm.

8. The multicore optical fiber of claim 5, wherein the minimum relative refractive index Δ₃ min of the dedicated trench cladding region is in a range from −0.15% to −0.70%.

9. The multicore optical fiber of claim 5, wherein the relative refractive index Δ₃ decreases continuously between the inner radius r₂ of the dedicated trench cladding region and the outer radius r₃ of the dedicated trench cladding region.

10. The multicore optical fiber of claim 5, wherein the dedicated cladding further comprises:
a dedicated offset cladding region surrounding and directly adjacent to the core region, the dedicated trench cladding region surrounding and directly adjacent to the dedicated offset cladding region, the dedicated offset cladding region having a thickness r₂-r₁ greater than or equal to 0.1 μm and a relative refractive index Δ₂.

11. The multicore optical fiber of claim 10, wherein the inner radius r₂ of the dedicated trench cladding region is in the range from 5.0 μm to 12.0 μm.

12. The multicore optical fiber of claim 10, wherein the relative refractive index Δ₂ is in a range from −0.10% to 0.10%.

13. The multicore optical fiber of claim 1, wherein the relative refractive index Δ₄ is in a range from −0.10% to 0.10%.

14. The multicore optical fiber of claim 1, wherein the thickness R₅−R₄ of the primary coating is less than or equal to 20 μm.

15. The multicore optical fiber of claim 1, wherein the secondary coating has a thickness R₆−R₅ less than or equal to 22.5 μm.

16. The multicore optical fiber of claim 1, wherein the outer radius R₆ is less than or equal to 90.0 μm.

17. The multicore optical fiber of claim 1, wherein the mode field diameter of each core element is in the range from 7.5 μm to 8.0 μm at 1310 nm.

18. The multicore optical fiber of claim 1,
wherein the co-propagating crosstalk between each pair of adjacent core elements is less than or equal to −40 dB/km at a wavelength of 1310 nm; and
wherein the co-propagating crosstalk between each pair of adjacent core elements is less than or equal to −30 dB/km at a wavelength of 1550 nm.

19. The multicore optical fiber of claim 1,
wherein the counterpropagating crosstalk between each pair of adjacent core elements is less than or equal to −50 dB/km at a wavelength of 1310 nm; and
wherein the counterpropagating crosstalk between each pair of adjacent core elements is less than or equal to −40 dB/km at a wavelength of 1550 nm.

20. The multicore optical fiber of claim 1, wherein the number of core elements in the plurality is greater than equal to 4.

21. The multicore optical fiber of claim 1, wherein the number of core elements in the plurality is greater than equal to 7.

22. The multicore optical fiber of claim 1, wherein the number of core elements in the plurality is greater than equal to 12.
